(19) United States
(12) Patent Application Publication
(10) Pub. No.: US 2025/0333641 A1
(43) Pub. Date: Oct. 30, 2025

(54) PYROLYSIS COKE

(71) Applicant: Exxonmobil Technology and Engineering Company, Spring, TX (US)

(72) Inventors: Adam B. BURNS, Maplewood, NJ (US); Steven PYL, Houston, TX (US); William A. Lamberti, Stewartsville, NJ (US); Krishnan Ananth Narayana Iyer, Houston, TX (US); Guang Cao, Ewing, NJ (US); Robert M. Shirley, Spring, TX (US); Peter A. Gordon, Yardley, PA (US)

(21) Appl. No.: 19/192,472

(22) Filed: Apr. 29, 2025

Related U.S. Application Data
(60) Provisional application No. 63/640,411, filed on Apr. 30, 2024.

(51) Int. Cl. C09K 8/80; C01B 32/372

(52) U.S. Cl. CPC C09K 8/805; C01B 32/372; C01P 2004/03; C01P 2004/61; C01P 2004/84; C01P 2004/90; C01P 2006/10; C01P 2006/12; C01P 2006/82; C01P 2006/90

(57) ABSTRACT

Compositions for pyrolysis coke particles are provided. The pyrolysis coke particles can have at least an outer shell of pyrolysis coke. In some aspects, the pyrolysis coke particles can be based on a homogeneous seed, so that the entire particle corresponds to pyrolysis coke and/or the particle consists essentially of pyrolysis coke. In other aspects, the particle can be based on a heterogeneous seed, so that a different type of carbon-containing material serves as the core of a particle. Systems and methods for forming such particles are also provided.

### CROSS-REFERENCE TO RELATED APPLICATIONS AND PRIORITY CLAIM

This Non-Provisional patent application claims priority to U.S. Provisional Patent Application No. 63/640,411, filed Apr. 30, 2024, and titled “Pyrolysis Coke”, the entire contents of which is incorporated herein by reference.

### FIELD OF THE INVENTION

Pyrolysis coke compositions, and methods of making and using such compositions, are provided.

### BACKGROUND OF THE INVENTION

Pyrolysis of hydrocarbons provides a potential pathway for producing large volumes of H₂ while reducing or minimizing the amount of carbon oxides that are generated. Instead of forming substantial amounts of carbon oxides, pyrolysis allows for formation of solid carbon products.

Some uses for the solid carbon generated during hydrocarbon pyrolysis have been described. For example, the use of the solid carbon for formation of carbon nanotubes is described in U.S. Pat. No. 11,629,056.

Other uses that have been described involve forming carbon particles. For example, a variety of prior methods have focused on pyrolysis methods that form carbon black. Carbon black typically corresponds to particles on the order of 1.0 μm or smaller. Carbon black can be used in a variety of applications related to use as a pigment, colorant, or conductive additive, as well as uses as filler material in rubber-based products (such as tires) or plastic products.

As an alternative to carbon black, it has been described that larger particles and/or bulk carbon can be formed. Conventionally, larger particles of pyrolysis coke have been used primarily for fuel value.

U.S. Pat. No. 4,796,701 describes formation of particles corresponding to an outer layer of pyrolysis coke deposited on an inner core. The pyrolysis coke is deposited on the particles using a controlled fluidized bed process that is operated in batch mode. In this batch mode, the initial bed of “core” particles for forming the bed is of a uniform size, and then fluidized bed pyrolysis is performed until a target thickness of pyrolysis coke is deposited on the particles. Thus, the resulting particles are of roughly a uniform size. The particles are described as being roughly spherical. Depending on the conditions selected, the outer layer of pyrolysis coke is described as having a uniform thickness ranging from 5 μm to 200 μm. It is noted that a “thickness” of 5 μm for the deposited carbon layer would correspond to an increase in diameter for a particle of 10 μm, while a thickness of 200 μm would correspond to an increase in diameter of 400 μm for a particle. The examples describe use of an inner core having a size of 30 mesh to 50 mesh, which corresponds to a minimum size for the inner core of roughly 300 μm. U.S. Pat. No. 4,632,876 is described as another example of suitable ceramic particles for the inner core. U.S. Pat. No. 4,632,876 describes formation of ceramic particles having a particle size at the end of particle formation of 180 μm or more.

U.S. Pat. Nos. 11,492,543 and 11,578,262 describe use of particles formed during fluidized coking of a petroleum feed as proppant particles. U.S. Pat. No. 3,664,420 describes use of particles formed from coke generated during coking in fracturing operations as a far-field diverter.

U.S. Patent Application Publication 2002/0037247 describes deposition of pyrolytic carbon on “whiskers” or “fibers” of inorganic material that have a diameter of less than 1 micron and a surface area of 10 m²/g or more.

U.S. Patent Application Publication 2021/0331918 describes pyrolysis of hydrocarbons (such as methane) using stacked fluidized beds to improve conversion during pyrolysis. International Publication WO/2022/081170 describe pyrolysis of hydrocarbons (such as methane) using stacked fluidized beds in combination with using electric heating to provide at least a portion of the heat for the pyrolysis reaction.

U.S. Patent Application Publication 2023/0271899 describes using a mixed bed of electrically conductive particles and catalytic particles as part of a fluidized bed pyrolysis process to assist with heating of the fluidized bed via direct resistance heating of the particles in the fluidized bed by passing a current through at least a portion of the particles. The particles in the fluidized bed are described as being electrically conductive particles and catalytic particles. The fluidized bed contains at least 10 wt % of the electrically conductive particles with a resistivity of 500 Ohm-cm or less at 800° C. At least a portion of the electrically conductive particles are selected from silicon carbide, one or more metallic alloys, non-metallic resistors, metallic carbides, transition metal nitrides, metallic phosphides, graphite, carbon black, superionic conductors, phosphate electrolytes, mixed oxides doped with lower-valent cations. In addition the fluidized bed contains catalytic particles, comprised of metallic compounds.

U.S. Pat. Nos. 11,760,884 and 11,453,784 are related to formation of carbon black during hydrocarbon pyrolysis. The carbon black is described as generally having a particle size of less than 1 μm, with less than 5 wppm of the particles corresponding to a size larger than 44 microns (325 mesh). U.S. Patent Application Publications 2021/0017025, 2021/0017031, and 2021/0020947 describe similar particle distributions.

U.S. Pat. No. 10,519,298 is directed to formation of carbon black particles where the particles are formed by depositing pyrolysis coke on a smaller core particle. The carbon black particles are described as having a particle size of 5 μm or less.

U.S. Pat. No. 9,359,200 describes performing pyrolysis of hydrocarbons in the presence of a fixed bed of carbonaceous particles having a size of 0.5 mm to 100 mm. Heat is transferred into the reaction zone for pyrolysis by using a gas flow as the heat transfer medium.

U.S. Pat. No. 3,409,542 describes a fluidized bed processes for coking at elevated temperatures. In order to achieve an average particle size for the fluidized bed, it is described that roughly 20% to 40% of the particles that are withdrawn from the reactor are ground to make seeds. In an example, roughly a third of the withdrawn particles are ground to form seeds. The seeds have a size that is smaller than 300 mesh (less than roughly 50 microns). It is described that this results in a fluidized bed where 20% to 30% of the particles in the fluidized bed have a particle size of less than 300 mesh (˜50 microns), even though the average particle size for the bed is roughly 200 microns.

U.S. Pat. No. 3,260,664 describes a fluidized bed process for coking at elevated temperatures. An example of a particle size distribution in the fluidized bed is provided. As shown in the example, at least 10% of the particles are greater in size than 30 mesh (˜600 microns), while particles smaller than 300 mesh (˜50 microns) are also present. The seed particles used to generate this particle size distribution include 5%-10% of particles smaller than 300 mesh. The apparent density of the coke particles is 1.80-1.93 g/cm³.

U.S. Pat. No. 3,347,781 describes another type of fluidized bed process for coking at elevated temperatures. Two examples are given for operation of a fluidized bed process with a fluidized bed having an average particle size. The average particle size in the examples is achieved by grinding roughly a third of the particles withdrawn from the reactor to form seeds, similar to U.S. Pat. No. 3,409,542. In the examples, the average particle size in the fluidized bed is 250 microns while the seeds after grinding have a particle 100 microns—150 microns. As still another example, the particle size distribution described in U.S. Pat. No. 3,260,664 is also described.

U.S. Pat. No. 3,254,957 describes a process for producing hydrogen and coke in a fluidized bed environment. The particle size distribution in the fluidized bed is described as having the bulk of the particles between 40 microns and 500 microns.

U.S. Patent Application Publication 2021/0380417 describes a process and device for producing hydrogen, carbon monoxide, and a carbon-containing product. The process generates hydrogen and carbon monoxide using a method that involves cyclic deposition of carbon on particles followed by gasification. Due to the nature of this cyclic process, the particles would be expected to have a high surface and a broad particle size distribution.

A journal article by Oliver et al. describes a technique for determining hardness and elastic-modulus using load and displacement sensing indentation experiments. See Oliver et al., Journal of Materials Research, 7(6):1564-1583, June (1992).

### SUMMARY OF THE INVENTION

In various embodiments, pyrolysis coke particles and compositions comprising pyrolysis coke particles are provided. The pyrolysis coke particles each have at least an outer shell or outer portion comprising pyrolysis coke. In some embodiments, the pyrolysis coke particles are based on homogeneous seeds, so that an entire particle corresponds to pyrolysis coke. In other embodiments, the pyrolysis coke particles are based on heterogeneous seeds, so that a different type of carbon-containing material serves as the core of a particle.

In an embodiment, a composition comprises a plurality of particles comprising pyrolysis coke, the plurality of particles having a BET surface area of 0.01 m²/g to 10.0 m²/g as measured according to ASTM D6556-21, a carbon content of 90.0 wt % or more as measured according to ASTM D5373-21, a sulfur content of 1.0 wt % or less as measured according to ASTM D1552-23, and an average apparent density of 1.85 g/cm³ to 2.26 g/cm³, as measured according to ASTM D2638-21.

In another embodiment, a composition comprises a plurality of particles comprising pyrolysis coke, the plurality of particles having an average apparent density of 1.0 g/cm³ to 2.26 g/cm³, as measured according to ASTM D2638-21, the plurality of particles having a D50 value between 40 μm and 500 μm and a difference between a D10 value and a D90 value of 30 μm to 250 μm, as measured according to ASTM D4464-15(2020).

In still another embodiment, a composition comprises a plurality of particles, 90 wt % or more of the plurality of particles having a core-and-shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 1.9 g/cm³ as measured according to ASTM D2638-21, the average apparent density being lower than an average core apparent density of the core portion of the core and shell structure.

In yet another embodiment, a composition is provided that comprises a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 2.26 g/cm³ as measured according to ASTM D2638-21, the plurality of particles having a D50 value between 40 μm and 500 μm and at least one of a) a difference between a D10 value and a D90 value of 40 μm to 250 μm and b) a difference between a D10 value and the D50 value of 50 μm or less.

In still another embodiment, a composition is provided that comprises a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having a BET surface area of 0.01 m²/g to 10.0 m²/g as measured according to ASTM D6556-21, the plurality of particles having an average apparent density of 1.0 g/cm³ to 2.26 g/cm³ as measured according to ASTM D2638-21.

In yet another embodiment, a composition is provided that comprises a plurality of particles, 90 wt % or more of the plurality of particles having a core and shell structure comprising a shell portion and a core portion, the shell portion of the core-and-shell structure comprising pyrolysis coke, the plurality of particles having an average apparent density of 1.0 g/cm³ to 2.26 g/cm³ as measured according to ASTM D2638-21, the plurality of particles having a D50 value between 40 μm and 500 μm and a difference between a D10 value and a D90 value of 30 μm to 250 μm.

### BRIEF DESCRIPTION OF THE DRAWINGS

FIG. 1 shows an example of a reaction system for performing hydrocarbon pyrolysis.

FIG. 2 shows another example of a reaction system for performing hydrocarbon pyrolysis.

FIG. 3 shows another example of a reaction system for performing hydrocarbon pyrolysis.

FIG. 4 shows a particle size distribution for pyrolysis coke particles.

FIG. 5 shows He pycnometry data for pyrolysis coke particles formed from activated carbon seeds.

FIG. 6 shows N₂ physisorption data for pyrolysis coke particles formed from activated carbon seeds.

FIG. 7 shows Hg porosimetry data of bulk density for pyrolysis coke particles formed from activated carbon seeds.

FIG. 8 shows Hg porosimetry data of pore volume for pyrolysis coke particles formed from activated carbon seeds.

FIG. 9 shows stress-strain curves for various types of particles.

FIG. 10 shows fracture conductivity tests for various types of particles.

FIG. 11 shows stress-strain curves for various types of particles.

FIG. 12 shows a process flow for management of particle sizes after withdrawal of particles from a reaction system.

FIG. 13, FIG. 14, and FIG. 15 show nanoindentation analysis of pyrolysis coke particles having various thicknesses of pyrolysis coke accumulated on activated carbon seeds.

FIG. 16 shows characterization data for various types of particles.

FIG. 17 shows another example of a reaction system for performing hydrocarbon pyrolysis.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various embodiments, pyrolysis coke particles and compositions comprising pyrolysis coke particles are provided, such as compositions corresponding to a plurality of pyrolysis coke particles. Systems and methods are also provided for forming such pyrolysis coke particles during a hydrocarbon pyrolysis process. The pyrolysis coke particles have beneficial characteristics, such as density and purity, particle size and/or particle size distribution, making them suitable for use in various applications. In various embodiments, the characteristics include, but are not limited to, one or more of an apparent density, a bulk density, a high content of carbon and hydrogen and/or a low content of impurities such as sulfur, nitrogen, and metals, and/or a lattice spacing for the particles. In some embodiments, the characteristics include one or more of an apparent density of 1.0 g/cm³ to 2.26 g/cm³; a BET surface area of 0.01 m²/g to 10.0 m²/g; a combined content of carbon and hydrogen of 75 wt % or more; a sulfur content of 5.0 wt % or less; a nitrogen content of 2.0 wt % or less; a combined content of iron, nickel, and vanadium of 2000 wppm or less; a bulk density of 0.1 g/cm³ to 2.05 g/cm³; and/or a lattice spacing (d₀₀₂) of 0.335 nm to 0.385 nm.

In addition to beneficial characteristics or a beneficial combination of characteristics, in some embodiments the particles have a beneficial particle size distribution. In such embodiments, the particle size distribution generally corresponds to having one or more of a D50 value between 40 μm and 500 μm, a D10 value of 20 μm to 350 μm, and/or a D90 value between 100 μm and 700 μm. Additionally or alternately, the particle size distribution can be characterized based on a difference between values, such as a difference between a D10 value and a D50 value, a difference between a D50 value and a D90 value, and/or a difference between a D10 value and a D90 value. Examples of difference values include a difference between a D10 value and a D50 value between 10 μm to 150 μm; a difference between a D50 value and a D90 value between 10 μm to 200 μm; and/or a difference between a D10 value and a D90 value between 20 μm to 350 μm.

Pyrolysis coke particles as described herein can be used in a variety of applications. One application is use of pyrolysis coke particles as proppants in hydraulic fracturing. Another application is incorporation of pyrolysis coke into carbon electrode compositions. For example, pyrolysis coke particles can be incorporated into an anode structure for aluminum manufacture after optionally agglomerating the particles using a suitable binder material. Still another application is incorporation of pyrolysis coke in iron and/or steel production. Still other uses include use of pyrolysis coke particles in energy storage applications, metallurgy applications, and/or use of pyrolysis coke particles as infrastructure materials.

Methane pyrolysis can be used to exemplify a hydrocarbon pyrolysis reaction. Equation (1) shows the stoichiometric formula.

CH₄(g)<=>2H₂(g)+C(s) (1)

As shown in Equation (1), methane pyrolysis results in formation of hydrogen gas and some type of solid form of carbon. The nature of the solid carbon formed can depend on the reaction environment.

One of the difficulties with using hydrocarbon pyrolysis for production of hydrogen is that even for the most favorable hydrocarbon, which is methane, the carbon atoms in the hydrocarbon correspond to at least 75% of the weight in the hydrocarbon. Thus, by weight, the vast majority of the products formed during hydrocarbon pyrolysis correspond to the carbon product(s).

It has been determined that when performing hydrocarbon pyrolysis, one of the difficulties is that the resulting solid carbon formed during pyrolysis will tend to deposit on surfaces based on proximity of the surface to the pyrolysis reaction and the amount of available surface area. This causes difficulties for commercial scale production of hydrogen, as at least a portion of the solid carbon product will be formed on surfaces of the reaction vessel used for performing the hydrocarbon pyrolysis. Such carbon deposited on interior surfaces of the reaction vessel typically corresponds to a waste product and/or a product with low commercial value. Such deposited carbon also presents operability challenges, as sufficient buildup of carbon deposits will alter flow patterns within a reactor and/or cause other changes in reaction system performance. Therefore, it would be beneficial to provide pyrolysis methods and corresponding systems that can incorporate an increased or maximized amount of the carbon generated during pyrolysis into higher value products.

In various embodiments, pyrolysis is performed in a fluidized bed pyrolysis environment. By using a fluidized bed as the pyrolysis environment, the proximity of the particles in the pyrolysis reaction zone can allow the carbon to preferentially be deposited on the particles in the pyrolysis reaction zone, thus reducing or minimizing the amount of carbon deposited at other locations, such as interior surfaces of the reactor(s) of the pyrolysis reaction system. This is in contrast to, for example, pyrolysis methods that involve substantial nucleation of new carbon particles. Nucleation of a new particle is typically a longer time scale process than deposition on an existing surface. Thus, processes involving substantial particle nucleation tend to have larger losses of carbon to deposition of carbon on interior surfaces of a reaction vessel.

An advantage of forming pyrolysis coke particles using a fluidized bed as the pyrolysis environment is that the carbon particles can be formed as part of a continuous process that also generates hydrogen. Thus, commercial scale hydrogen generation is performed while also generating a commercially valuable carbon particle product. This is in contrast to methods where, for example, pyrolysis coke is added in a controlled manner to particles in a fixed or suspended bed. In such fixed or suspended bed systems, extremely narrow particle size distributions can be generated. However, there is little or no ability to operate such processes in a continuous manner, which can severely limit the amount of hydrogen that can be generated on a per volume basis.

It has been discovered that pyrolysis coke particles with improved properties can be formed by controlling various conditions related to the pyrolysis reaction and/or operation of the reaction system. In various embodiments, the conditions used to control the formation of the pyrolysis coke particles include one or more of the composition of the hydrocarbon feed; the rate of hydrocarbon feed introduction and/or conversion; the average residence time of pyrolysis coke particles within the reaction system; the rate of addition of seed particles; the composition and size (or size distribution) of seed particles; the gas residence time in the pyrolysis reaction zone; the temperature and/or pressure in the pyrolysis reaction zone; and/or the rate of withdrawal of pyrolysis coke particles from the reaction system. Control of these one or more factors, and potentially still other factors, can allow for withdrawal of pyrolysis coke particles that have a desirable combination of composition, performance characteristics and/or particle size distribution for various applications. In some embodiments, the particle size distribution is further improved after withdrawal of the pyrolysis coke particles from the system. This can be achieved, for example, using one or more meshes or sieves to substantially remove particles above or below a target size range, by using grinding and/or agglomeration facilities to make smaller or larger particles, or a combination thereof.

### Definitions

In this discussion, the term “proppant particulate” or “proppant particle” refers to a solid material capable of maintaining open an induced fracture during and following a hydraulic fracturing treatment.

As used herein, the term “apparent density” refers to the density of the individual particulates themselves, which may be expressed in grams per cubic centimeter (g/cm³). The apparent density can alternatively be referred to as the skeletal or real density. Unless otherwise specified, apparent density (also referred to as skeletal or real density) is measured using He pycnometry according to ASTM D2638-21. We adopt the preferred term “apparent” throughout, acknowledging that despite the procedures defined in this ASTM method, inaccessible porous domains may remain within the particulates that would result in deviations from the intended definition of real density as defined in ASTM D2638-21.

As used herein, the term “bulk density” refers to the density of a collection, group, or other plurality of particles, which may be expressed in g/cm³. Unless otherwise specified, bulk density is measured according to ASTM D4292-23.

As used herein, D10, D50, and D90 describe particle sizes. As used herein, the term “D10” refers to a diameter at which 10% of the sample (on a volume basis unless otherwise specified) is comprised of particles having a diameter less than said diameter value. As used herein, the term “D50” refers to a diameter at which 50% of the sample (on a volume basis unless otherwise specified) is comprised of particles having a diameter less than said diameter value. As used herein, the term “D90” refers to a diameter at which 90% of the sample (on a volume basis unless otherwise specified) is comprised of particles having a diameter less than said diameter value. Generally, particle size can be determined by light scattering techniques (which uses a model in the data reduction to approximate the object as a sphere, and therefore provides a diameter) or analysis of optical digital micrographs (which uses a circular-equivalent cross-section, and therefore provides a diameter). Unless otherwise specified, light scattering techniques (and/or methods which provide a diameter equivalent to light scattering techniques) are used for analyzing particle size and for determining diameter. Unless otherwise specified, the particle sizes are determined according to ASTM D4464-15(2020)-15. It is noted that ASTM D4464-15(2020) pertains to “catalyst, catalyst carrier, and catalytic raw material particles”; carbon particles are common catalyst carriers and therefore understood by those skilled in the art to fall within the scope of ASTM D4464-15(2020).

As used herein, the term “crush strength,” refers to the stress load that particulates can withstand prior to crushing (such as breaking or cracking). The crush strength values of the present disclosure are based on API RP-19C.

As used herein, the term “fracture conductivity” refers to the permeability of a proppant pack to conduct fluid at various stress (pressure) levels. The fracture conductivity values of the present disclosure are based on the American Petroleum Institute's Recommended Practice 19D (API RP-19D) standard entitled “Measuring the Long-Term Conductivity of Proppants” (First Ed. May 2008, Reaffirmed May 2015).

The Krumbein Chart provides an analytical tool to standardize visual assessment of the sphericity and roundness of particles, including proppant particulates. Each of sphericity and roundness is visually assessed on a scale of 0 to 1, with higher values of sphericity corresponding to a more spherical particle and higher values of roundness corresponding to less angular contours on a particle's surface. According to API RP-19C standards, the shape of a proppant particulate is considered adequate for use in hydraulic fracturing operations if the Krumbein value for both sphericity and roundness is ≥0.6.

In this discussion, particles are described with reference to a “core-shell” structure. The “core” refers to the seed particle used for forming the particle, while the “shell” refers to pyrolysis coke deposited on the particle during the pyrolysis reaction. The pyrolysis coke particles can correspond to particles formed using a homogeneous seed (pyrolysis coke) or a heterogeneous seed (different from pyrolysis coke). In this discussion, a pyrolysis coke particle formed using a homogeneous seed is still defined as a particle having a “core-shell” structure, even if the boundary between the homogeneous seed (pyrolysis coke core) and the subsequently deposited pyrolysis coke shell cannot be readily detected. It is noted that a pyrolysis coke particle that is based on a homogeneous seed corresponds to a pyrolysis coke particle where any impurities in the particle (such as sulfur oxygen, nitrogen, and/or metals) will correspond to impurities that are expected to be found in pyrolysis coke.

Unless otherwise specified, in this discussion, the ash content of particles is determined according to ASTM D4422-19. The moisture content of particles is determined according to ASTM D3173/D3173M-17a. The volatile matter content of particles is determined according to ASTM D6374-22. The results for ash content, moisture content, and volatile matter content can be used to calculate the fixed carbon content of particles.

Unless otherwise specified, in this discussion, the sulfur content of particles is determined according to ASTM D1552-23.

Unless otherwise specified, in this discussion, the carbon, hydrogen, and nitrogen content of particles are determined according to ASTM D5373-21. After characterization of carbon, hydrogen, nitrogen, and sulfur, oxygen content can be calculated as the balance of the composition.

Metals content, such as the content of iron, nickel, and vanadium, is determined according to ASTM D5600-22.

Unless otherwise specified, in this discussion, X-Ray Diffraction (XRD) is used to determine the layer spacing (d₀₀₂) within particles. XRD in combination with Scherrer analysis is used to determine crystallite size (L_{c} and Lₐ, calculated from the widths of the d₀₀₂ and d₁₁₀ peaks, respectively).

In this discussion, BET surface area is specific surface area measured by N₂ adsorption and Brunauer-Emmett-Teller analysis. BET surface area is determined according to ASTM D6556-21. It is noted that this test is traditionally for carbon black, but it is also applicable for the types of particles described herein.

In this discussion, calorific value is determined according to ASTM D5865/D5865M-19.

In this discussion, unless otherwise specified, properties for a plurality of particles are defined as average properties across the plurality of particles. Similarly, unless otherwise specified, properties of the shell portion of a core-and-shell structure correspond to average properties for the shells across a plurality of particles. Also, unless otherwise specified, properties of the core portion of a core-and-shell structure correspond to average properties for the cores across a plurality of particles.

### Particle Size Control

Pyrolysis processes continuously produce pyrolysis coke, which can deposit on surfaces available in the locations where pyrolysis chemistry is occurring. Pyrolysis occurring in locations where circulating solid material is not present can result in deleterious effects, including fouling of vessel walls and internals, and formation of extremely fine “free carbon”. Such “free carbon” can typically have particle sizes of less than 1.0 μm, with the particle size decreasing as the temperature is increased above ˜950° C. When a sufficient amount of fluidized particles is not present within a reactor when hydrocarbons are exposed to pyrolysis conditions (˜950° C. or higher), the “free carbon” yield for gas phase hydrocarbon feeds can be at least 2.0 wt % to 5.0 wt % relative to the weight of the feed, and possibly up to 10 wt % or still higher as the pyrolysis temperature is increased to ˜1200° C. or higher. The yields of “free carbon” can be still higher for liquid phase hydrocarbon feeds introduced into a pyrolysis environment.

In various embodiments, the production of such “free carbon” is reduced or minimized by performing hydrocarbon pyrolysis in a fluidized bed environment. Additionally, in various embodiments, the reaction system and operating conditions for performing hydrocarbon pyrolysis in a fluidized bed environment are controlled to provide pyrolysis coke particles having one or more desirable characteristics related to properties, composition, and/or particle size distribution.

The equilibrated particle size distribution (PSD) for the pyrolysis coke particles circulating in the reactor system can depend on a variety of factors. One factor is the average time the pyrolysis coke particles spend in the circulating inventory. In this discussion, the average residence time is defined as the weight of the solids inventory divided by the withdrawal rate of pyrolysis coke from the reaction system. It is noted that the total weight of pyrolysis coke particles in a reaction system, which corresponds to the inventory of pyrolysis coke particles, may vary during operation. For purposes of determining the residence time, in embodiments where the inventory level varies with time, the inventory level is calculated as the average inventory during one minute of operation. Thus, during any given minute of operation, an average residence time is defined as the average weight of pyrolysis coke inventory within the reaction system during the one minute time period, divided by the pyrolysis coke withdrawal rate during the one minute time period. Based on this definition for the average residence time, the average residence time of pyrolysis coke particles in a reaction system will be on the order of hours. In some embodiments, the average residence time for pyrolysis coke particles is 0.5 hours to 500 hours, or 0.5 hours to 100 hours, or 0.5 hours to 50 hours, or 0.5 hours to 20 hours, or 1.0 hours to 500 hours, or 1.0 hours to 100 hours, or 1.0 hours to 50 hours, or 1.0 hours to 20 hours.

The withdrawal rate of pyrolysis coke is determined in part based on the rate of pyrolysis coke formation, which is in turn determined in part by gas residence time, feed rate, reactor size, pyrolysis temperature, and pyrolysis pressure. Still other factors are the extent of solids attrition in the circulating inventory, the rate of seed addition, and the size of seed particles. Yet another factor is the solids capture efficiency of the gas/solids separation equipment (i. e. cyclones). Still other factors are the reactor operating parameters, such as solids/gas ratio, temperature, pressure, and gas residence time that may impact carbon deposition rate.

Conventionally, the PSD of equilibrated, circulating pyrolysis coke particles in a fluidized bed pyrolysis reactor must meet certain specifications to fluidize easily and prevent operational instability and/or excessive carbon losses. Unfortunately, selection of specifications that improve or maximize hydrogen generation, improve or maximize operational stability, and/or reduce or minimize pyrolysis coke losses do not tend to correspond to conditions that result in a narrow or controlled particle size distribution for the resulting carbon particles. For example, in order to reduce or minimize losses of pyrolysis coke, it would be desirable to retain fines (generated by attrition) within the fluidized environment. Conventionally, such fines will accumulate additional pyrolysis coke and grow into larger particles. However, retention of such fines will expand the range of the particle size distribution. As a result, conventional selection of operating conditions will typically result in a broadened particle size distribution.

In various embodiments, one or more methods of controlling particle size distribution can be used to produce a particle size distribution having a reduced or narrowed width for the pyrolysis coke particles within a fluidized bed pyrolysis reaction system. Such a narrower particle size distribution can be beneficial for providing pyrolysis coke particles with desirable properties for subsequent use while reducing, minimizing, or even eliminating the amount of pyrolysis coke that must be removed from a particle sample prior to subsequent use (for example, reducing or minimizing need for additional sieving and/or other additional particle separation).

One method for particle size control is the use of seed particles. Seed particles can correspond to homogeneous seeds (composed of pyrolysis coke) or heterogeneous seeds. In various embodiments, heterogeneous seeds are composed of any other carbonaceous material, including but not limited to, fluidized coke, flexicoke, delayed coke (such as shot coke, sponge coke, anode-grade coke, and needle coke), coal, coal coke, metallurgical coke, charcoal, biochar, hard carbon, activated carbon, natural or synthetic graphite, amorphous carbon, and glassy/vitreous carbon. It is noted that activated coke and/or calcined coke formed from fluidized coke, flexicoke, delayed coke, coal, coal coke, and metallurgical coke can also be used as a heterogeneous seed. Still other seeds include bio-based seeds, such as particles of lignin and/or other bio-derived carbonaceous particles. In some embodiments, addition of seed particles of controlled size is beneficial for modifying both the low end and the high end of the size distribution. First, by selecting seed particle sizes that are suitably close to a target minimum size value and/or a target D10 value for the particle size distribution, the amount of smaller particles in the tail of the distribution is reduced or minimized. In particular, instead of growing particles by starting with fines, using seed particles can provide a soft lower bound on the particle size. While some fine particles may be created, such fines can be readily removed by one or more mechanisms, so that the number of particles having a size below the seed particle size is reduced or minimized. Additionally, by starting with seed particles of a controlled size, the required average residence time within the reactor to achieve a target particle size and/or target particle size distribution can be controlled. Depending on the embodiment, the target particle size and/or target particle size distribution may correspond to a target D10 value, target D50 value, a target D90 value, a target value for the difference between D10 and D90, a target value for the difference between D10 and D50, and/or a target value for the difference between D50 and D90. This allows for selection of a target average residence time that provides sufficient deposition of pyrolysis coke to form pyrolysis coke particles with desirable structural qualities while also reducing or minimizing the number of substantially larger particles that are formed.

A seed carbon system can also potentially be utilized to control other physical properties of the circulating carbon, for instance to improve reactor performance. These properties include, but are not limited to, particle surface area, density, and pore volume. Increasing particle surface area in particular has been shown to increase conversion both experimentally and through modeling. In some embodiments, adjustment of these physical properties is achieved in part by using a seed carbon source different from the withdrawn carbon (for example activated carbon with higher surface); or by using the withdrawn carbon with physical or chemical processing to modify the properties of the withdrawn carbon prior to use as a seed.

Another mechanism for particle size control is the use of gas/solids separation equipment. During fluidized bed pyrolysis, a portion of the pyrolysis coke particles will typically become entrained in the overhead gas exiting from the reactor vessel where pyrolysis is being performed. These entrained particles need to be separated from the gas phase pyrolysis product, so that the particles can either be returned to the fluidized bed or removed from the system. The separation efficiency of the gas/solids separation equipment can be tailored to preserve in the circulating inventory a desired PSD range. As an example, if a cyclone system is utilized, the system can be designed with only a primary cyclone returning solids to the circulating inventory. If only a primary cyclone is used, then substantially all of the solids captured by the cyclone are returned back to the fluidized bed. Optionally, the primary cyclone efficiency can also be tailored to fine tune the particle grade efficiency curve.

In other embodiments, additional gas/solids separation equipment, such as high efficiency cyclone and/or filtration equipment, is optionally used downstream for additional particle capture, but not returned to the circulating inventory. This can assist with both minimizing contamination of the gaseous products with fine particulates while also reducing or minimizing the presence of particle fines in the circulating inventory. In some embodiments, removing particle fines from the circulating inventory prevents further (and possibly preferential) deposition of pyrolysis coke on the finer pyrolysis coke particles, which otherwise could shift the particle size distribution toward an undesired finer range.

Still another option for particle size control is via attrition. This can be accomplished using attrition nozzles, using a design impact attrition source, or a combination thereof. In this type of embodiment, it is expected that the equilibrated circulating solids will have at least a portion of the PSD that is larger than desired. Thus, attrition of particles within the system can be used to create smaller particles that serve as “seeds” for continued operation. In some embodiments, attrition methods are used in combination with introduction of externally generated seed particles, so that the seeds correspond to both seeds generated in situ and seeds generated ex situ.

One attrition option to reduce the fraction of pyrolysis coke particles with large particle size is to install jet attrition nozzles at one or more points in the reaction system to perform controlled particle attrition. The attrition rate is controlled, for example, by the amount of attrition gas added to the nozzle(s). For design impact attrition, the nature of designed flow within the reactor results in the particles impacting one or more surfaces within the reaction system. As an example, at a location where a fluidizing gas is used to lift particles within the system, the gas flow rate can be selected to be sufficient to cause the lifted particles to impact a termination surface at the end of being lifted. The gas flow rate can be selected to provide sufficient velocity so that at least some particles will break into a plurality (two or more) of particles, thus providing smaller particles to serve as seeds. It is noted, however, that the various attrition methods have low selectivity for performing attrition on larger particles as opposed to smaller particles. Thus, use of attrition nozzles and/or having a design impact attrition source can also potentially create unwanted fines.

Optionally, after removal of pyrolysis coke particles from a reaction system, additional particle size adjustment can be performed. For example, withdrawn carbon can be processed through one or more facilities to adjust particle size distribution to meet end use requirements. Separation of different PSD fractions can be performed using sieving and/or air classification equipment. Grinding and/or milling equipment can be used to reduce the size of larger particle fractions. Combinations of size separation and grinding equipment can be used to maximize the amount of product carbon within a target PSD range.

In addition to size reduction, particles of increased size can potentially also be formed. For example, agglomeration facilities can be utilized to increase the particle size of a fraction or entire production of carbon product by agglomerating with a suitable binder material.

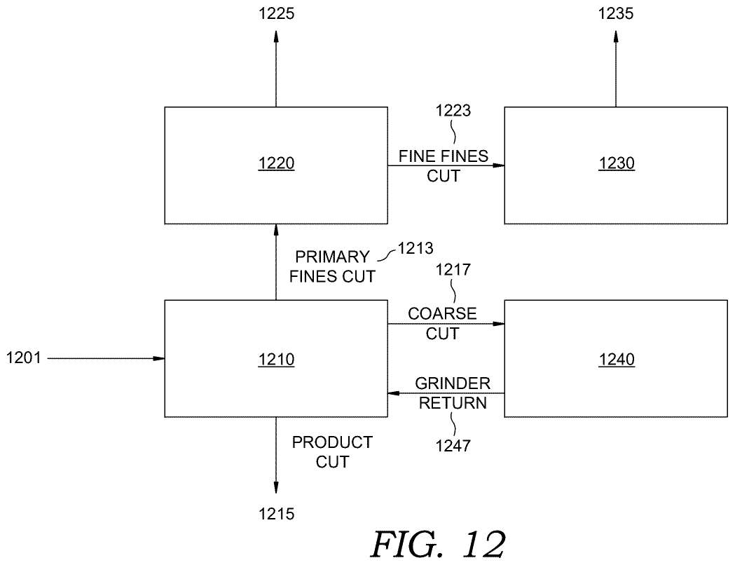

FIG. 12 shows a process flow diagram that provides an example of carbon withdrawal processing facilities incorporating multiple PSD control methods in an integrated system to provide the necessary flexibility to meet PSD specifications for product pyrolysis coke particles and the circulating inventory. In this example, the withdrawn pyrolysis coke particles 1201 undergo an initial sieving operation 1210 to produce 3 PSD fractions: a primary fines cut 1213 that is finer than the target pyrolysis coke particle product PSD, a coarse cut 1217 that is more coarse than the target pyrolysis coke particle product PSD, and a product cut 1215 that meets the pyrolysis coke particle product PSD specifications. The coarse cut 1217 is routed to a grinding facility 1240 where particle size is reduced and recycled back 1247 to the initial sieving operation 1210. The primary fines cut 1213 undergoes additional sieving 1220 to further separate into a “fine fines cut” 1223 and a “coarse fines cut” 1225. The coarse fines cut 1225 is fed back to the circulating inventory to be utilized as a “Seed Carbon” to control the PSD of the circulating inventory. Note that the Seed Carbon addition will increase the amount of pyrolysis coke that has to be withdrawn from the reactor system. The fine fines cut 1223 produced from the Secondary Sieving Facility is routed to an Agglomeration Facility 1230 to build up particle size, and the Agglomerate Product 1235 is exported as a product. In other embodiments, fine fines cut 1223 can be further processed in any other convenient manner.

As an example of controlling particle size, a target particle size characteristic and/or particle size range characteristic can be selected. This can be a D10 value, a D50 value, a D90 value, a difference in D10 and D50 values, D10 and D90 values, or D50 and D90 values, or a combination of two or more of such values. A corresponding seed particle size and/or size distribution is also selected. In some embodiments, the seeds are heterogeneous seeds having the desired size and/or size distribution. In other embodiments, the seeds are homogeneous seeds that are generated from particles withdrawn from the pyrolysis system. The seeds can be formed by a combination of grinding, sieving, and/or any other conventional methods for reducing/modifying the size distribution of particles. It is noted that the size and/or size distribution of the seed particles is related to the particle size characteristic(s) and/or particle size range characteristic(s) by the rate of addition of seed particles and the average residence time of particles in the reaction system prior to withdrawal from the reaction system. Additionally, the number of particles added per unit time (rate of particle addition) is roughly proportional to the rate of removal of particles from the pyrolysis reaction system. The weight of particles removed from the system per unit time will typically be greater than the weight of seeds added per unit time, as the typical particle removed from the system will be heavier than the typical seed particle. But the number of particles added and removed per unit time will be comparable, in order to maintain the fill level in the reaction system.

In such an example, in various embodiments a narrow particle size distribution may be desirable. This can correspond to a narrow distribution based on a target difference in D10 and D90 values, D10 and D50 values, and/or D50 and D90 values. In some embodiments, in order to maintain a narrow particle size distribution, the size of the seed particles is sufficiently large so that an appropriate D10 value is achieved for the overall particle size distribution. For example, in embodiments where pyrolysis is performed in a fluidized bed pyrolysis environment, the particles within a fluidized bed will rapidly mix, so that any seed particles present in a fluidized bed pyrolysis environment will be relatively uniformly distributed within the fluidized bed. In some embodiments, the D50 value for the seed particles added to the reaction system is equal to or greater than the D10 value of the particles in the reaction system. In other aspects, the D50 value for the seed particles is within 20 μm of the D10 value of the particles in the reaction system, or within 10 μm of the D10 value of the particles in the reaction system. In such embodiments, the difference between the D10 and D90 value for the seed particles can be 60 μm or less, or 50 μm or less, or 40 μm or less, or 30 μm or less, or 20 μm or less, such as down to 5.0 μm or possibly still less.

In various embodiments, the seed particles can have a D50 value from 20 μm to 200 μm, or 20 μm to 150 μm, or 20 μm to 120 μm, or 20 μm to 100 μm, or 20 μm to 80 μm, or 20 μm to 60 μm, or 30 μm to 200 μm, or 30 μm to 150 μm, or 30 μm to 120 μm, or 30 μm to 100 μm, or 30 μm to 80 μm, or 30 μm to 60 μm, or 40 μm to 200 μm, or 40 μm to 150 μm, or 40 μm to 120 μm, or 40 μm to 100 μm, or 40 μm to 80 μm, or 50 μm to 200 μm, or 50 μm to 150 μm, or 50 μm to 120 μm, or 50 μm to 100 μm, or 50 μm to 80 μm, or 60 μm to 200 μm, or 60 μm to 150 μm, or 60 μm to 120 μm, or 60 μm to 100 μm, or 80 μm to 200 μm, or 80 μm to 150 μm, or 80 μm to 120 μm, or 100 μm to 200 μm, or 100 μm to 150 μm, or 120 μm to 200 μm, or 120 μm to 150 μm, or 140 μm to 200 μm, or 140 μm to 170 μm, or 160 μm to 200 μm.

### Particle Size Distribution

In various embodiments, pyrolysis coke particles are formed having a targeted size distribution. The pyrolysis coke particles correspond to particles formed using a homogeneous seed or a heterogeneous seed. In aspects where a heterogeneous seed is used, the pyrolysis coke particles can have a “core-and-shell” form, where the “core” material of the heterogeneous seed is surrounded by a pyrolysis coke “shell”. It is noted that when homogeneous seeds are used, depositing pyrolysis coke on homogeneous seeds also results in deposition of a “shell” of pyrolysis coke on a “core” of pyrolysis coke, but it is difficult to identify the boundary between the “core” and the “shell” for homogeneous pyrolysis coke particles.

In various embodiments where heterogeneous seeds are used for forming pyrolysis coke particles, 50 wt % or more of the pyrolysis coke particles can have a core-and-shell structure, or 70 wt % or more, or 80 wt % or more, or 90 wt % or more, or 95 wt % or more, such as up to substantially all of the pyrolysis coke particles having a core-and-shell structure (100 wt %). It is noted that a combination of ex-situ generated seeds and in-situ generated seeds can be used, which would produce a mixture of particles that are readily identified as having a core-and-shell structure with particles that have a homogeneous (in-situ generated) seed where the boundary between a core and a shell may be difficult to identify. It is further noted that in embodiments where in-situ seed formation is reduced or minimized, some amount of pyrolysis coke fines may be retained in the reaction system. Such pyrolysis coke fines can act as homogeneous seeds.

The particle size distribution for a collection of pyrolysis coke particles can be characterized at various points in time. One option is to characterize pyrolysis coke particles after withdrawal from the pyrolysis reaction system, but prior to substantial additional processing and/or separation to modify the distribution of sizes. Another option is to characterize the particles after additional processing. An example of additional processing is performing a separation to remove particles that are too large or too small. Another example of additional processing is grinding of particles to reduce the size of the particles.

There are various ways for characterizing the particles sizes in a particle distribution. One option is to characterize a particle size distribution based on the volume percentage of particles that are below a certain size, such as by using D10, D50, and/or D90 values to characterize particles based on diameter. For example, the D10 and/or D90 values are indicators for the smallest and largest types of particles that are present in significant amounts within a sample of particles. The D50 value for a sample of particles roughly provides an average particle size. Another option is to characterize the difference between the D10 and D50 values, D50 and D90 values, and/or D10 and D90 values. These types of calculated differences can assist with characterizing the width of the particle size distribution.

For particles formed by fluidized bed pyrolysis reaction system in a commercial scale process, one characteristic of the particle sizes is that there will be a distribution. Commercial scale fluidized bed pyrolysis will typically correspond to a continuous process in order to allow for substantially higher volumes of hydrogen production. In such a continuous process, there will be a distribution of particle sizes, as opposed to having substantially uniform particle sizes.

In various embodiments, the D50 value for a plurality of pyrolysis particles can be from 40 μm to 500 μm, or 40 μm to 400 μm, or 40 μm to 300 μm, or 40 μm to 250 μm, or 40 μm to 200 μm, or 40 μm to 150 μm, or 40 μm to 100 μm, or 50 μm to 500 μm, or 50 μm to 400 μm, or 50 μm to 300 μm, or 50 μm to 250 μm, or 50 μm to 200 μm, or 50 μm to 150 μm, or 50 μm to 100 μm, or 75 μm to 500 μm, or 75 μm to 400 μm, or 75 μm to 300 μm, or 75 μm to 250 μm, or 75 μm to 200 μm, or 75 μm to 150 μm, or 100 μm to 500 μm, or 100 μm to 400 μm, or 100 μm to 300 μm, or 100 μm to 250 μm, or 100 μm to 200 μm, or 100 μm to 150 μm, or 150 μm to 500 μm, or 150 μm to 400 μm, or 150 μm to 300 μm, or 150 μm to 250 μm, or 150 μm to 200 μm, or 200 μm to 500 μm, or 200 μm to 400 μm, or 200 μm to 350 μm, or 200 μm to 300 μm, or 200 μm to 250 μm, or 250 μm to 500 μm, or 250 μm to 450 μm, or 250 μm to 400 μm, or 250 μm to 350 μm, or 250 μm to 300 μm, or 300 μm to 500 μm, or 300 μm to 450 μm, or 300 μm to 400 μm, or 300 μm to 350 μm, or 350 μm to 500 μm, or 350 μm to 450 μm, or 350 μm to 400 μm, or 400 μm to 500 μm, or 400 μm to 450 μm, or 450 μm to 500 μm.

Additionally or alternately, in various embodiments, the D10 value for the particle size distribution is 20 μm or more, or 40 μm or more, or 50 μm or more, or 70 μm or more, or 100 μm or more, or 150 μm or more, such as up to 250 μm, or up to 350 μm or possibly still higher. For example, the D10 value can be from 20 μm to 350 μm, or 40 μm to 350 μm, or 70 μm to 350 μm, or 100 μm to 350 μm, or 20 μm to 250 μm, or 40 μm to 250 μm, or 70 μm to 250 μm, or 100 μm to 250 μm, or 20 μm to 150 μm, or 40 μm to 150 μm, or 20 μm to 100 μm, or 40 μm to 100 μm. Further additionally or alternately, 5.0 wt % or less of the particles can have a size of 60 μm or less, or 50 μm or less, or 40 μm or less, or 30 μm or less.

Further additionally or alternately, in various embodiments, the D90 value for the particle size distribution is 700 μm or less, or 600 μm or less, or 500 μm or less, or 400 μm or less, or 350 μm or less, or 300 μm or less, such as down to 250 μm, or down to 200 μm, or down to 150 μm, or possibly still lower. For example, the D90 value can be from 150 μm to 700 μm, or 250 μm to 700 μm, or 350 μm to 700 μm, or 150 μm to 600 μm, or 250 μm to 600 μm, or 350 μm to 600 μm, or 150 μm to 500 μm, or 250 μm to 500 μm, or 350 μm to 500 μm, or 150 μm to 400 μm, or 250 μm to 400 μm, or 150 μm to 300 μm.

In some embodiments, control over the particle size distribution allows for formation of a plurality of pyrolysis coke particles having a relatively narrow distribution of particle sizes. Generally, the ability to form a relatively narrow distribution of particle sizes can be beneficial. In some embodiments, the difference between the D10 and D50 diameter values for a plurality of carbon particles is from 10 μm to 150 μm, or 10 μm to 120 μm, or 10 μm to 90 μm, or 10 μm to 70 μm, or 10 μm to 50 μm, or 10 μm to 30 μm, or 20 μm to 150 μm, or 20 μm to 120 μm, or 20 μm to 90 μm, or 20 μm to 70 μm, or 20 μm to 50 μm, or 30 μm to 150 μm, or 30 μm to 120 μm, or 30 μm to 90 μm, or 30 μm to 70 μm, or 30 μm to 50 μm, or 40 μm to 150 μm, or 40 μm to 120 μm, or 40 μm to 90 μm, or 40 μm to 70 μm. Additionally or alternately, the difference between the D50 and D90 diameter values for a plurality of carbon particles can be from 10 μm to 200 μm, or 10 μm to 160 μm, or 10 μm to 120 μm, or 10 μm to 90 μm, or 10 μm to 70 μm, or 10 μm to 50 μm, or 10 μm to 30 μm, or 20 μm to 160 μm, or 20 μm to 120 μm, or 20 μm to 90 μm, or 20 μm to 70 μm, or 20 μm to 50 μm, or 30 μm to 160 μm, or 30 μm to 120 μm, or 30 μm to 90 μm, or 30 μm to 70 μm, or 40 μm to 200 μm, or 40 μm to 160 μm, or 40 μm to 120 μm, or 40 μm to 90 μm, or 40 μm to 70 μm, or 60 μm to 200 μm, or 60 μm to 160 μm, or 60 μm to 120 μm, or 60 μm to 90 μm, or 80 μm to 160 μm, or 80 μm to 120 μm, or 100 μm to 200 μm, or 100 μm to 160 μm, or 100 μm to 120 μm, or 120 μm to 160 μm, or 140 μm to 160 μm.

A particle distribution can also be characterized based on the difference between the D10 and D90 diameter values. In some embodiments, the difference between the D10 and D90 diameter values for a plurality of carbon particles is from 20 μm to 150 μm, or 20 μm to 120 μm, or 20 μm to 100 μm, or 30 μm to 150 μm, or 30 μm to 120 μm, or 30 μm to 100 μm, or 50 μm to 150 μm, or 50 μm to 120 μm, or 50 μm to 100 μm, or 70 μm to 150 μm, or 70 μm to 120 μm, or 90 μm to 150 μm. In other embodiments, a broader distribution of particles of pyrolysis coke can be formed. In such embodiments, the difference between the D10 and D90 values for a plurality of pyrolysis coke particles can be from 20 μm to 350 μm, or 20 μm to 250 μm, or 20 μm to 200 μm, or 20 μm to 170 μm, or 30 μm to 350 μm, or 30 μm to 250 μm, or 30 μm to 200 μm, or 30 μm to 170 μm, or 50 μm to 350 μm, or 50 μm to 250 μm, or 50 μm to 200 μm, or 50 μm to 170 μm, or 100 μm to 350 μm, or 100 μm to 250 μm, or 100 μm to 200 μm, or 150 μm to 350 μm, or 150 μm to 250 μm.

As an example, one type of application for pyrolysis coke particles is use as a proppant for hydraulic fracturing. Depending on the embodiment, a plurality of pyrolysis coke particles for use as a proppant can have a D10 value from 60 μm to 90 μm, or 90 μm to 120 μm, or 120 μm to 160 μm. In such embodiments, the difference between the D10 and the D90 diameter values is from 30 μm to 100 μm, or 30 μm to 140 μm, or 50 μm to 100 μm, or 50 μm to 140 μm, or 50 μm to 200 μm, or 50 μm to 250 μm.

In some embodiments, such as embodiments where a combination of grinding and/or sieving is used to modify the size of pyrolysis coke particles withdrawn from the pyrolysis reaction system, 2.0 wt % or more of the particles in a distribution can have a diameter value of 10 μm or less, or 0.5 wt % or less, such as down to 0.01 wt % or possibly still less. Additionally or alternately, in some aspects, 2.0 wt % or less of the particles in a distribution can have a size that is at least 10 μm lower than the D10 diameter value for the distribution, or 0.5 wt % or less, such as down to 0.1 wt % or possibly still less.

In some optional embodiments, such as optional embodiments where a particle size distribution is characterized after removing the particles from the reactor but prior to sizing the particles using mesh sieves or another equivalent technique, 0.1 wt % or more of the particles in a distribution have a diameter value of 10 μm or less, or 0.5 wt % or more, such as up to 2.0 wt % or possibly still more. Additionally or alternately, in some embodiments, 0.1 wt % or more of the particles in a distribution have a size that is at least 10 μm lower than the D10 diameter value for the distribution, or 0.5 wt % or more, such as up to 2.0 wt % or possibly still more. It is noted that if mesh sieves are used to size a plurality of particles, the resulting particle size distribution can tend to have a reduced or minimized content of particles that are substantially smaller than or larger than the mesh sizes used for sieving the plurality of particles.

### Particle Composition

In addition to producing particles with a controlled size distribution, pyrolysis coke particles can have a favorable composition for use in a variety of applications. Depending on the nature of the feed for the pyrolysis reaction, the pyrolysis coke portion of a pyrolysis coke particle can contain a relatively low content of atoms different from carbon and hydrogen. Thus, the content of sulfur and/or nitrogen in the pyrolysis coke can be relatively low. Additionally or alternately, the content of various types of transition metals (such as iron, nickel, and/or vanadium) can be relatively low.

In some embodiments, the seed particle introduced into the fluidized bed corresponds to seed particles composed of pyrolysis coke. In such aspects, the composition of the pyrolysis coke particles can be relatively uniform throughout the particles, as both the seed and the outer shell of pyrolysis coke correspond to substantially the same material.

It is noted that for seeds composed of pyrolysis coke, the seeds can correspond to seeds that are generated “ex situ” or “in situ”. Ex-situ generated seeds represent seeds that are formed outside of the pyrolysis system environment. In-situ generated seeds correspond to seeds that are formed within the pyrolysis system, such as by performing forced attrition on a portion of the particles within the system.

In other embodiments, a heterogeneous seed is used to form the pyrolysis coke particles. In other words, the seed used for forming the particle is a carbonaceous material different from pyrolysis coke. Examples of potential heterogeneous seed materials include, but are not limited to, fluidized coke, flexicoke, delayed coke (such as shot coke, sponge coke, anode-grade coke, and needle coke), coal, coal coke, metallurgical coke, charcoal, biochar, hard carbon, activated carbon, natural or synthetic graphite, amorphous carbon, and glassy/vitreous carbon. It is noted that activated coke and/or calcined coke formed from fluidized coke, flexicoke, delayed coke, coal, coal coke, and metallurgical coke can also be used as a heterogeneous seed. Still other seeds include bio-based seeds, such as particles of lignin and/or other bio-derived carbonaceous particles. In this discussion, a carbonaceous particle or material (for example, a carbonaceous seed particle, a carbonaceous core in a core-and-shell structure, a pyrolysis coke particle with a homogeneous core) is defined as a particle or material that contains at least 50 wt % of carbon. Thus, particles or materials containing 50 wt % or more of carbon, or 70 wt % or more of carbon, or 90 wt % or more of carbon, such as up to 100 wt % carbon, all qualify as carbonaceous particles or materials. Because the seed materials may have higher concentrations of atoms different from carbon atoms and hydrogen atoms, the use of heterogeneous seeds can reduce the purity of the resulting pyrolysis coke particles.

When a heterogeneous seed is used, in some embodiments, the average thickness of the pyrolysis coke shell around the heterogeneous seed can be relatively thin. The average thickness is defined as the average distance from the interface of the heterogeneous seed and the pyrolysis coke shell to the closest location on the exterior of the pyrolysis coke shell. Such a distance can be determined, for example, by visual inspection of SEM images of sectioned samples. In such embodiments, the average thickness of the pyrolysis coke shell is 100 μm or less, or 50 μm or less, or 30 μm or less, or 20 μm or less, or 16 μm or less, or 12 μm or less, such as down to 4.0 μm, or down to 2.0 μm, or possibly still lower. Additionally or alternately, in some embodiments, the average thickness of the pyrolysis coke shells is less than the average diameter of the heterogeneous seeds, or less than 0.5 times the average diameter of the heterogeneous seeds (in other words, less than half the diameter), or less than 0.25 times the average diameter of the heterogeneous seeds (in other words, less than a quarter of the diameter). In this discussion, the average diameter of the heterogeneous seeds is determined based on the volume average of the diameters in the distribution of seeds. For seeds that are not spherical, the diameter is defined as the spherical equivalent diameter that is determined by light scattering.

In various embodiments, pyrolysis coke corresponds to a relatively pure phase of carbon and hydrogen, although the amount of impurities can be higher if the hydrocarbon feed contains impurities different from carbon atoms and hydrogen atoms. In some embodiments, a plurality of pyrolysis coke particles can have a carbon content of 85 wt % to 99.99 wt %, or possibly still higher. Additionally or alternately, a plurality of pyrolysis coke particles can have a weight ratio of carbon to hydrogen of 80:1 or more, or 90:1 or more, or 95:1 or more, or 99:1 or more, such as up to being substantially composed of carbon. The range of values for carbon content and carbon to hydrogen weight ratio is broad in part due to differences in whether a homogeneous seed or a heterogeneous seed is used for forming the particles. For a plurality of pyrolysis coke particles having homogeneous seeds, the particles can have a carbon content of 90 wt % to 99.99 wt %, or 92 wt % to 99.99 wt %, or 95 wt % to 99.99 wt %, or 90 wt % to 99.5 wt %, or 92 wt % to 99.5 wt %, or 95 wt % to 99.5 wt %, or 90 wt % to 99.0 wt %, or 92 wt % to 99.0 wt %, or 95 wt % to 99.0 wt %. The weight ratio of carbon to hydrogen for such particles can be roughly 90:1 or more, or 95:1 or more, or 99:1 or more, such as up to being substantially composed of carbon. For a plurality of pyrolysis coke particles having heterogenerous seeds, there can be more variation. For example, a heterogeneous seed can include atoms different than carbon and hydrogen. Thus, for a plurality of pyrolysis coke particles having heterogeneous seeds, the particles can have a carbon content of 75 wt % to 99 wt %, or 80 wt % to 99 wt %, or 85 wt % to 99 wt %, or 90 wt % to 99 wt %, 75 wt % to 98 wt %, or 80 wt % to 98 wt %, or 85 wt % to 98 wt %, or 90 wt % to 98 wt %, or 75 wt % to 95 wt %, or 80 wt % to 95 wt %, or 85 wt % to 95 wt %. The weight ratio of carbon to hydrogen for such particles can be roughly 80:1 or more, or 85:1 or more, or 90:1 or more, or 95:1 or more, or 99:1 or more, such as up to being substantially composed of carbon.

Other properties of pyrolysis coke particles include bulk density and apparent density. The apparent density of pyrolysis coke particles is controlled by several factors. One factor is that higher pyrolysis temperatures tend to result in higher apparent density values for the particles. Another factor is the nature of the seed or “core” of the particle. When homogeneous seeds are used, so that pyrolysis coke is the “core” of the particle, the particle density can tend to be higher as pyrolysis coke is a relatively high density type of seed particle. Some other types of seed particles, such as activated carbon, can have substantially lower densities, so that even after addition of a pyrolysis coke “shell”, the total apparent density for the particle is lower than the density of a particle with a homogeneous core. The apparent density provides a limit on what the bulk density of the particles can be, as the bulk density is typically between 0.1 times and 0.9 times the apparent density.

In some embodiments, for a plurality of pyrolysis coke particles formed using a homogeneous seed, the plurality of particles can have one or more of the following properties: a bulk density of 0.1 g/cm³ to 2.05 g/cm³, or 0.1 g/cm³ to 1.7 g/cm³, or 0.1 g/cm³ to 1.4 g/cm³, or 0.1 g/cm³ to 1.26 g/cm³, or 0.1 g/cm³ to 1.0 g/cm³, or 0.5 g/cm³ to 2.05 g/cm³, or 0.5 g/cm³ to 1.7 g/cm³, or 0.5 g/cm³ to 1.4 g/cm³, or 0.5 g/cm³ to 1.26 g/cm³, or 0.5 g/cm³ to 1.0 g/cm³, or 1.0 g/cm³ to 2.05 g/cm³, or 1.0 g/cm³ to 1.7 g/cm³, or 1.0 g/cm³ to 1.4 g/cm³, or 1.00 g/cm³ to 1.26 g/cm³, or 1.5 g/cm³ to 2.05 g/cm³; an apparent density of 1.00 g/cm³ to 2.26 g/cm³, or 1.00 g/cm³ to 2.05 g/cm³, or 1.00 g/cm³ to 1.70 g/cm³, or 1.00 g/cm³ to 1.50 g/cm³, or 1.00 g/cm³ to 1.45 g/cm³, or 1.20 g/cm³ to 2.26 g/cm³, or 1.20 g/cm³ to 2.05 g/cm³, or 1.20 g/cm³ to 1.70 g/cm³, or 1.20 g/cm³ to 1.50 g/cm³, or 1.20 g/cm³ to 1.45 g/cm³, or 1.50 g/cm³ to 2.26 g/cm³ or 1.50 g/cm³ to 2.05 g/cm³, or 1.50 g/cm³ to 1.90 g/cm³, or 1.7 g/cm³ to 2.26 g/cm³, or 1.70 g/cm³ to 2.05 g/cm³, or 1.90 g/cm³ to 2.20 g/cm³, or 1.90 g/cm³ to 2.05 g/cm³, or 1.92 g/cm³ to 2.26 g/cm³, or 1.95 g/cm³ to 2.26 g/cm³, or 2.00 g/cm³ to 2.26 g/cm³; a carbon content of 90 wt % to 99.99 wt %; and/or a weight ratio of carbon to hydrogen of 90:1 or more, or 95:1 or more, or 99:1 or more, such as up to being substantially composed of carbon.

The BET surface area of pyrolysis coke particles can also be characterized. In some embodiments, the BET surface area of a plurality of carbon particles is from 0.01 m²/g to 50.0 m²/g, or 0.01 m²/g to 10.0 m²/g, or 0.01 m²/g to 2.0 m²/g, or 0.01 m²/g to 1.0 m²/g, or 0.1 m²/g to 50.0 m²/g, or 0.1 m²/g to 10.0 m²/g, or 0.1 m²/g to 2.0 m²/g, or 0.1 m²/g to 1.0 m²/g, or 1.0 m²/g to 50.0 m²/g, or 1.0 m²/g to 10.0 m²/g, or 1.0 m²/g to 2.0 m²/g.

Still other properties of pyrolysis coke particles can include impurities content in the particles, such as the content of sulfur, nitrogen, oxygen, and/or metals. The primary sources of sulfur and/or nitrogen in pyrolysis coke particles are sulfur and/or nitrogen incorporated from the hydrocarbon feed to the pyrolysis process. Oxygen impurities could be derived from the feed, or oxygen impurities could be incorporated based on oxygen used within the heating portions of the system. For heavier feeds, metals from the feed can be incorporated into the pyrolysis particles. For pyrolysis of feeds such as methane and/or natural gas, however, the metals content of the feed is relatively low, so that incorporation of metals from the walls of the reaction system can become a primary source of metal contaminants in the particles.

For pyrolysis coke particles formed based on homogeneous seeds, a plurality of pyrolysis coke particles can have a total impurities content (in other words, total content of atoms different from carbon and hydrogen) of 2.0 wt % or less, or 1.0 wt % or less, or 0.1 wt % or less, such as down to being substantially free of impurities (total content of atoms different from carbon or hydrogen of 0.01 wt % or less). Additionally or alternately, a plurality of pyrolysis coke particles can have a sulfur content of 1.0 wt % or less (10,000 wppm or less), or 0.5 wt % or less (5000 wppm or less), or 0.2 wt % or less (5000 wppm or less), or 0.1 wt % or less (1000 wppm or less), or 0.05 wt % or less (500 wppm or less), or 0.03 wt % or less (300 wppm or less), or 0.02 wt % or less (200 wppm), or 0.01 wt % or less (100 wppm or less), such as down to being substantially free of sulfur (sulfur content of 0.001 wt % or less (10 wppm or less)). Further additionally or alternately, a plurality of pyrolysis coke particles can have a nitrogen content of 1.0 wt % or less, or 0.6 wt % or less, or 0.2 wt % or less, or 0.1 wt % or less, such as down to being substantially free of nitrogen (nitrogen content of 0.01 wt % or less).

With respect to metals content, a plurality of pyrolysis coke particles formed based on homogeneous seeds can have a combined iron, vanadium, and nickel content of 1000 wppm or less, or 500 wppm or less, or 300 wppm or less, or 200 wppm or less, or 100 wppm or less, or 50 wppm or less, or 10 wppm or less, such as down to substantially no iron, vanadium, and/or nickel content. Additionally or alternately, a plurality of pyrolysis coke particles can have an iron content of 500 wppm or less, or 300 wppm or less, or 200 wppm or less, or 100 wppm or less, or 50 wppm or less, or 10 wppm or less, such as down to substantially no iron content. Further additionally or alternately, a plurality of pyrolysis coke particles can have a nickel content of 500 wppm or less, or 300 wppm or less, or 200 wppm or less, or 100 wppm or less, or 50 wppm or less, or 10 wppm or less, such as down to substantially no nickel content. Still further additionally or alternately, a plurality of pyrolysis coke particles can have a vanadium content of 500 wppm or less, or 300 wppm or less, or 200 wppm or less, or 100 wppm or less, or 50 wppm or less, or 10 wppm or less, such as down to substantially no vanadium content. It is noted that the relative purity of the hydrocarbon feed used for pyrolysis can impact the impurities content of the resulting pyrolysis coke particles.

For pyrolysis coke particles formed based on heterogeneous seeds, the impurities content can vary depending on the nature of the seed. Seeds such as fluidized coke seeds can contribute impurities, even though the majority of the seed corresponds to carbon and/or hydrogen. By contrast, use of activated carbon as a seed can potentially result in a relatively low level of total impurities, depending on the nature of the activated carbon. In some aspects, a plurality of pyrolysis coke particles containing heterogeneous seeds can have a total impurities content of 15.0 wt % or less, or 5.0 wt % or less, or 1.5 wt % or less, or 1.0 wt % or less, or 0.5 wt % or less, or 0.1 wt % or less, or 0.01 wt % or less, such as down to being substantially free of impurities (total content of atoms different from carbon or hydrogen of 0.001 wt % or less). Additionally or alternately, a plurality of pyrolysis coke particles based on heterogeneous seeds can have a sulfur content of 5.0 wt % or less, or 1.0 wt % or less, or 0.5 wt % or less, or 0.1 wt % or less, or 0.05 wt % or less, or 0.03 wt % or less, or 0.01 wt % or less, such as down to being substantially free of sulfur (sulfur content of 0.001 wt % or less). Further additionally or alternately, a plurality of pyrolysis coke particles can have a nitrogen content of 2.0 wt % or less, or 1.0 wt % or less, or 0.6 wt % or less, such as down to 0.1 wt %, or down to being substantially free of nitrogen (0.01 wt % or less).

With respect to metals content, a plurality of pyrolysis coke particles (such as particles formed using heterogeneous seeds) can have a combined iron, vanadium, and nickel content of 2000 wppm or less, or 1500 wppm or less, 1000 wppm or less, or 500 wppm or less, or 300 wppm or less, or 200 wppm or less, or 100 wppm or less, or 50 wppm or less, or 10 wppm or less, such as down to substantially no iron, vanadium, and/or nickel content. Additionally or alternately, a plurality of pyrolysis coke particles can have an iron content of 1000 wppm or less, or 500 wppm or less, or 300 wppm or less, or 200 wppm or less, or 100 wppm or less, or 50 wppm or less, or 10 wppm or less, such as down to substantially no iron content. Further additionally or alternately, a plurality of pyrolysis coke particles can have a nickel content of 1000 wppm or less, or 500 wppm or less, or 300 wppm or less, or 200 wppm or less, or 100 wppm or less, or 50 wppm or less, or 10 wppm or less, such as down to substantially no nickel content. Still further additionally or alternately, a plurality of pyrolysis coke particles can have a vanadium content of 1000 wppm or less, or 500 wppm or less, or 300 wppm or less, or 200 wppm or less, or 100 wppm or less, or 50 wppm or less, or 10 wppm or less, such as down to substantially no vanadium content. It is noted that the relative purity of the hydrocarbon feed used for pyrolysis can impact the impurities content of the resulting pyrolysis coke particles.

Yet other properties of pyrolysis coke particles can be related the crush strength and shape of the particles. In some aspects, a plurality of pyrolysis coke particles can have a crush strength of 3000 psi to 30,000 psi (˜20 MPa-a to 200 MPa-a), or 3000 psi to 15,000 psi (˜20 MPa-a to ˜100 MPa-a), or 3000 psi to 12,000 psi (˜20 MPa-a to ˜83 MPa-a). Additionally or alternately, a plurality of pyrolysis coke particles can have a Krumbein roundness value of ≥0.6. Further additionally or alternately, a plurality of pyrolysis coke particles can have a Krumbein sphericity of ≥0.6.

Still another property for pyrolysis coke particles can be fracture conductivity. Fracture conductivity is a property related to use of the pyrolysis coke particles as a proppant. In some aspects, pyrolysis coke particles used as proppant particles can have a fracture conductivity of 10 mD-ft or more at a closure stress of 6000 psia, or 20 mD-ft or more, or 30 mD-ft or more, or 40 mD-ft or more, or 50 mD-ft or more, or 75 mD-ft or more, or 100 mD-ft or more, or 150 mD-ft or more, such as up to 400 mD-ft or possibly still higher. Fracture conductivity values are measured according to API RP-19D at standard conditions of 150° F. and 2 lb/ft² proppant loading.

Yet other properties for pyrolysis coke particles correspond to lattice spacing (d₀₀₂) and crystallite size (L_{c}). In various embodiments, a plurality of pyrolysis coke particles can have a d₀₀₂ of 0.335 to 0.385 nm, or 0.335 nm to 0.365 nm, or 0.335 nm to 0.355 nm. Additionally or alternately, a plurality of pyrolysis coke particles can have a L_{c} of 1.0 nm to 10 nm, or 1.0 nm to 3.5 nm, or 1.0 nm to 2.5 nm, or 1.0 nm to 2.3 nm, or 1.4 nm to 10 nm, or 1.4 nm to 3.5 nm, or 1.4 nm to 2.5 nm, or 1.4 nm to 2.3 nm, or 1.8 nm to 10 nm, or 1.8 nm to 3.5 nm, or 1.8 nm to 2.5 nm, or 1.8 nm to 2.3 nm.

In some embodiments, substantially all of the seeds introduced into the pyrolysis reaction system can have the same type of composition, so that substantially all of the particles (after deposition of pyrolysis coke) have the substantially the same type of composition (for example, pyrolysis coke in the shell, substantially the same type of core composition). This is in contrast to a situation where two different types of particles are present in substantial amounts within the fluidized bed, such as having substantial amounts of both pyrolysis coke particles and catalyst particles. For example, in some embodiments, more than 90 wt % of the seeds can have substantially the same composition, or more than 95 wt %, such as up to 100 wt %. Pyrolysis coke can then be deposited on these seeds, so that more than 90 wt % of the particles in the pyrolysis system have the same type of composition (for example, core-and-shell with same type of core and same type of shell), or 95 wt % or more, such as up to 100 wt %. In some embodiments, more than 90 wt % of the particles correspond to particles having carbon-containing seeds (such as pyrolysis coke or activated carbon), or 95 wt % or more, such as up to 100 wt %. Optionally, the carbon-containing seeds in such embodiments correspond to carbon-containing seeds that do not include graphite or carbon black.

When seeds are used to form a plurality of pyrolysis coke particles, the seeds correspond to the “core” of a particle having a core-shell structure. The properties of the cores of a plurality of particles can be referred to separately from the properties of the pyrolysis coke particles. For example, with regard to apparent density, the apparent density of a plurality of carbon particles can be characterized. The apparent density of the cores (seeds) for the plurality of carbon particles can also be characterized, such as by characterizing the apparent density of the seeds prior to introduction into the reaction system for performing pyrolysis. Thus, both the apparent density and the core apparent density for the plurality of carbon particles can be specified.

It is noted that when heterogeneous seeds are used for forming a plurality of pyrolysis coke particles, the properties of the seeds may differ from the corresponding values for the overall pyrolysis coke particle. Additionally, seeds formed from materials such as activated carbon and/or fluidized coke may not have been previously exposed to temperatures as high as the temperatures present during pyrolysis. As a result, upon exposure to the elevated temperatures that are present in a pyrolysis environment, the properties of seeds may change relative to the values that would be measured prior to introducing the seeds into the pyrolysis reaction environment. As an example, the moisture and/or volatiles content for seeds can vary substantially when measured prior to introduction of the seeds into the pyrolysis environment versus the value that would be obtained after exposure to pyrolysis temperatures. Values for properties like apparent density or nitrogen content may have smaller variation or even no variation at all, depending on the prior history of the seed material. In order to account for this, properties for seed particles as described herein correspond to “initial” values of properties for the seed particles. The initial value of a property for a seed particle is defined as the value of the property prior to introducing the seed particle into the pyrolysis reaction system. This allows for characterization of the seed particles prior to deposition of pyrolysis coke on the seed particles, so that characterization of the seeds is performed without the presence of deposited pyrolysis carbon.

In various embodiments, the seeds for forming a plurality of pyrolysis coke particles can have an initial carbon content of 75 wt % to 99.99 wt %, or 75 wt % to 99 wt %, or 75 wt % to 97 wt %, or 75 wt % to 95 wt %, or 80 wt % to 99.99 wt %, or 80 wt % to 99 wt %, or 80 wt % to 97 wt %, or 80 wt % to 95 wt %, or 85 wt % to 99.99 wt %, or 85 wt % to 99 wt %, or 85 wt % to 97 wt %, or 85 wt % to 95 wt %, or 90 wt % to 99.99 wt %, or 90 wt % to 99 wt %, or 90 wt % to 95 wt %. Additionally or alternately, the seeds for forming a plurality of pyrolysis coke particles can have an initial weight ratio of carbon to hydrogen of 75:1 or more, or 80:1 or more, or 90:1 or more, or 95:1 or more, or 99:1 or more, such as up to being substantially composed of carbon.

In various embodiments, the seeds for forming a plurality of pyrolysis coke particles generally have an initial apparent density of 1.00 g/cm³ to 2.26 g/cm³, or 1.00 g/cm³ to 2.05 g/cm³, or 1.00 g/cm³ to 1.70 g/cm³, or 1.00 g/cm³ to 1.50 g/cm³, or 1.00 g/cm³ to 1.45 g/cm³, or 1.20 g/cm³ to 2.26 g/cm³, or 1.20 g/cm³ to 2.05 g/cm³, or 1.20 g/cm³ to 1.70 g/cm³, or 1.20 g/cm³ to 1.50 g/cm³, or 1.20 g/cm³ to 1.45 g/cm³, or 1.40 g/cm³ to 2.26 g/cm³ or 1.40 g/cm³ to 2.05 g/cm³, or 1.40 g/cm³ to 1.90 g/cm³, or 1.40 g/cm³ to 1.70 g/cm³, or 1.50 g/cm³ to 2.26 g/cm³, or 1.50 g/cm³ to 2.05 g/cm³, or 1.50 g/cm³ to 1.90 g/cm³, or 1.7 g/cm³ to 2.26 g/cm³, or 1.70 g/cm³ to 2.05 g/cm³, or 1.90 g/cm³ to 2.26 g/cm³, or 1.90 g/cm³ to 2.05 g/cm³, or 1.92 g/cm³ to 2.26 g/cm³, or 1.95 g/cm³ to 2.26 g/cm³, or 2.00 g/cm³ to 2.26 g/cm³. After incorporation of seeds into a plurality of pyrolysis coke particles, the above apparent density values can also be referred to as core apparent density values for the plurality of particles.

For some types of heterogeneous seeds with higher porosity, such as activated carbon seeds or some types of fluidized coke seeds, the seeds for forming a plurality of pyrolysis coke particles have an initial apparent density of 1.40 g/cm³ to 2.05 g/cm³, or 1.40 g/cm³ to 1.90 g/cm³, or 1.40 g/cm³ to 1.70 g/cm³, or 1.50 g/cm³ to 2.05 g/cm³, or 1.50 g/cm³ to 1.90 g/cm³. In such embodiments where the seeds also have sufficiently high porosity, the resulting pyrolysis coke particles can have an apparent density that is lower than the core apparent density for the seeds used to form the pyrolysis coke particles. This is unexpected, as the apparent density of pyrolysis coke alone is typically relatively high in comparison to other types of carbonaceous particles, and therefore addition of pyrolysis coke would be expected to result in pyrolysis coke particles with a higher apparent density than the apparent density of the cores or seeds.

Still other properties of seeds for forming a plurality of pyrolysis coke particles can include impurities content in the seeds, such as the content of sulfur, nitrogen, oxygen, and/or metals. For heterogeneous seed particles, the impurities will be dependent on the nature of the process that is used to form the heterogeneous seeds. For example, particles generated in a fluidized coker are a potential source of seed particles. The nitrogen and sulfur content of fluidized coke particles can vary widely, depending on the quality of the feed that is introduced into the fluidized coking process. Fluidized coke will typically also contain some oxygen, due in part to the presence of oxygen in the regenerator where a portion of the fluidized coke is combusted to provide heat for the fluidized coking process.

In some embodiments, seeds for forming a plurality of pyrolysis coke particles have an initial total impurities content of 25.0 wt % or less, or 20.0 wt % or less, or 15.0 wt % or less, or 10 wt % or less, or 5.0 wt % or less, or 1.5 wt % or less, or 1.0 wt % or less, or 0.5 wt % or less, or 0.1 wt % or less, such as down to being substantially free of impurities (total content of atoms different from carbon or hydrogen of 0.01 wt % or less). Additionally or alternately, such seeds can have an initial sulfur content of 10 wt % or less, or 5.0 wt % or less, or 1.0 wt % or less, or 0.5 wt % or less, or 0.1 wt % or less, or 0.05 wt % or less, or 0.03 wt % or less, or 0.01 wt % or less, such as down to being substantially free of sulfur (sulfur content of 0.001 wt % or less). For example, the seeds can have an initial sulfur content of 0.01 wt % to 10 wt %, or 0.01 wt % to 5.0 wt %, or 0.01 wt % to 1.0 wt %, or 0.1 wt % to 10 wt %, or 0.1 wt % to 5.0 wt %, or 0.1 wt % to 1.0 wt %, or 1.0 wt % to 10 wt %, or 1.0 wt % to 5.0 wt %. Further additionally or alternately, such seeds can have an initial nitrogen content of 3.0 wt % or less, or 2.0 wt % or less, or 1.0 wt % or less, or 0.6 wt % or less, or 0.1 wt % or less, such as down to being substantially free of nitrogen (nitrogen content of 0.01 wt % or less). For example, the seeds can have an initial nitrogen content of 0.01 wt % to 3.0 wt %, or 0.01 wt % to 1.0 wt %, or 0.01 wt % to 0.1 wt %, or 0.1 wt % to 3.0 wt %, or 0.1 wt % to 1.0 wt %, or 0.6 wt % to 3.0 wt %. Still further additionally or alternately, such seeds can have an initial oxygen content of 10 wt % or less, or 5.0 wt % or less, or 2.0 wt % or less, or 1.0 wt % or less, such as down to being substantially free of oxygen (oxygen content of 0.01 wt % or less). For example, the seeds can have an initial oxygen content of 0.1 wt % to 10 wt %, or 0.1 wt % to 5.0 wt %, or 1.0 wt % to 10 wt %, or 1.0 wt % to 5.0 wt %.

With respect to metals content, seeds for forming a plurality of pyrolysis coke particles can have an initial combined iron, vanadium, and nickel content of 4000 wppm or less, or 2000 wppm or less, or 1500 wppm or less, 1000 wppm or less, or 500 wppm or less, or 300 wppm or less, or 200 wppm or less, or 100 wppm or less, or 50 wppm or less, or 10 wppm or less, such as down to substantially no iron, vanadium, and/or nickel content. Additionally or alternately, the seeds for forming a plurality of pyrolysis coke particles can have an initial iron content of 2000 wppm or less, or 1000 wppm or less, or 500 wppm or less, or 300 wppm or less, or 200 wppm or less, or 100 wppm or less, or 50 wppm or less, or 10 wppm or less, such as down to substantially no iron content. Further additionally or alternately, the seeds for forming a plurality of pyrolysis coke particles can have an initial nickel content of 2000 wppm or less, or 1000 wppm or less, or 500 wppm or less, or 300 wppm or less, or 200 wppm or less, or 100 wppm or less, or 50 wppm or less, or 10 wppm or less, such as down to substantially no nickel content. Still further additionally or alternately, the seeds for forming a plurality of pyrolysis coke particles can have an initial vanadium content of 2000 wppm or less, or 1000 wppm or less, or 500 wppm or less, or 300 wppm or less, or 200 wppm or less, or 100 wppm or less, or 50 wppm or less, or 10 wppm or less, such as down to substantially no vanadium content.

In some embodiments, the seeds for forming a plurality of pyrolysis coke particles have an initial moisture content of 0.01 wt % to 15 wt %, or 0.01 wt % to 5.0 wt %, or 0.01 wt % to 1.0 wt %, or 0.1 wt % to 15 wt %, or 0.1 wt % to 5.0 wt %, or 0.1 wt % to 1.0 wt %, or 1.0 wt % to 15 wt %, or 1.0 wt % to 5.0 wt %. Additionally or alternately, the seeds for forming a plurality of pyrolysis coke particles can have an initial volatiles content of 0.1 wt % to 15 wt %, or 0.1 wt % to 10 wt %, or 0.1 wt % to 5.0 wt %, or 0.1 wt % to 1.0 wt %, or 1.0 wt % to 15 wt %, or 1.0 wt % to 10 wt %, or 1.0 wt % to 5.0 wt %. Further additionally or alternately, the seeds for forming a plurality of pyrolysis coke particles can have an initial ash content of 0.1 wt % to 15 wt %, or 0.1 wt % to 10 wt %, or 0.1 wt % to 5.0 wt %, or 0.1 wt % to 2.5 wt %, or 0.1 wt % to 1.0 wt %, or 0.3 wt % to 15 wt %, or 0.3 wt % to 10 wt %, or 0.3 wt % to 5.0 wt %, or 0.3 wt % to 2.5 wt % or 0.3 wt % to 1.0 wt %, or 1.0 wt % to 15 wt %, or 1.0 wt % to 10 wt %, or 1.0 wt % to 5.0 wt %.

Still another property of seeds for forming a plurality of pyrolysis coke particles is the crush strength of the seeds. In some embodiments, the seeds can have an initial crush strength of 300 psi to 12,000 psi (˜2.0 MPa-a to ˜83 MPa-a), or 1500 psi to 12,000 psi (˜10 MPa-a to ˜83 MPa-a), or 300 psi to 9000 psi (˜2.0 MPa-a to ˜63 MPa-a), or 1500 psi to 9000 psi (˜10 MPa-a to ˜63 MPa-a), or 300 psi to 6000 psi (˜2.0 MPa-a to ˜42 MPa-a), or 1500 psi to 6000 psi (˜2.0 MPa-a to ˜42 MPa-a).

Yet another property of seeds for forming a plurality of pyrolysis coke particles is the specific surface area measured by N₂ adsorption and Brunauer-Emmett-Teller analysis, referred to as the BET surface area. Some types of seeds have an initial BET surface areas of 0.1 m²/g to 100 m²/g. Other types of seeds can have a higher surface area, optionally in combination with a high pore volume. Activated carbon is an example of a material with high surface area and high pore volume. Some types of fluidized coke can also have high surface area and optionally high pore volume. In such embodiments, the seeds can have an initial BET surface area of greater than 100 m²/g, such as 100 m²/g to 1500 m²/g, or possibly still higher.

### Hydrocarbon Feedstock

A variety of hydrocarbon feedstocks can be used as the input feed for pyrolysis. Generally, any convenient type of hydrocarbon that corresponds to a gas at the input temperature for the hydrocarbon feed into the pyrolysis reactor could be used as part of the hydrocarbon feedstock. In some aspects, the hydrocarbon feedstock can contain 50 mol % or more of C₁-C₄ hydrocarbons, or 60 mol % or more, or 70 mol % or more, or 80 mol % or more, or 90 mol % or more, or 95 mol % or more, or 99 mol % or more, such as up to being substantially composed of C₁-C₄ hydrocarbons (99.9 mol % or more). In some aspects, the hydrocarbon feedstock can contain 50 mol % or more of methane (C₁ hydrocarbon), or 60 mol % or more, or 70 mol % or more, or 80 mol % or more, or 90 mol % or more, or 95 mol % or more, or 99 mol % or more, such as up to being substantially composed of methane (99.9 mol % or more). In some aspects, the hydrocarbon feedstock can include 10 mol % or less of C₅₊ hydrocarbons, or 5.0 mol % or less, or 1.0 mol % or less, such as down to having substantially no content of C₅₊ hydrocarbons (0.1 mol % or less). In addition to hydrocarbons, a hydrocarbon feed can also include diluent components that do not substantially impact the pyrolysis process, such as N₂.

Such a hydrocarbon feedstock can be derived from a variety of sources, depending on the embodiment. One option is to use a mineral hydrocarbon feed, such as natural gas. Optionally, methane could be separated from a mineral hydrocarbon feed in order to provide a feed having higher methane content and/or reduced contaminant content into the pyrolysis process. Additionally or alternately, other sources of methane, such as by-product streams from refinery processing that include a substantial portion of methane, can also be used.

Other sources of methane can be derived from biological and/or renewable sources. Various options are available for conversion of biomass and/or municipal solid waste into smaller hydrocarbons. Examples of biomass sources include, but are not limited to, crop residues; crops such as Jatropha that are grown specifically for use as biomass; processing residues, such as sawdust or fermentation residues; other food and/or green waste; and wastewater sludge. For example, gasification can be used to convert solid biomass and/or municipal solid waste into gaseous hydrocarbons. Another option is to use bacteria that can perform aerobic and/or anaerobic digestion of biomass to produce smaller hydrocarbons such as methane. Optionally, such bio-derived sources of hydrocarbons can undergo further separations to remove non-hydrocarbon contaminants and/or to increase the concentration of selected hydrocarbons, such as methane.

### Fluidized Bed Pyrolysis

A variety of options are available for performing fluidized bed pyrolysis. One option is to use stacked fluidized beds. Optionally, when using stacked fluidized beds, one or more of the fluidized beds can be used as heat transfer beds, while one or more additional fluidized beds are used to substantially perform the pyrolysis reaction. Another group of options corresponds to configurations where pyrolysis is performed in fluidized beds in one or more pyrolysis vessels, while one or more additional vessels are used to add heat to the particles in the reaction system. The particles can then be moved back and forth between the vessels to allow the heat added in the one or more additional vessels to be balanced against the heat consumed by the endothermic pyrolysis reaction. More generally, any convenient fluidized bed pyrolysis configuration can be used, so long as the configuration allows for introduction of seed particles into the configuration, and provides at least some control over the pyrolysis conditions and the average residence time for particles under pyrolysis conditions.

Generally, the temperature in the pyrolysis reaction zone of the reaction system, in the heating portion of the reaction system, or in both the pyrolysis reaction zone and the heating portion can be between 800° C. to 1600° C., or 800° C. to 1400° C., or 800° C. to 1300° C., or 1000° C. to 1600° C., or 1000° C. to 1400° C., or 1000° C. to 1300° C., or 1200° C. to 1600° C., or 1200° C. to 1300° C. The pressure in the pyrolysis reaction zone and/or heating portion of the reaction system can be 1.0-10 bar (˜100 kPa-a to ˜1000 kPa-a), or 1.0-5.0 bar (100 kPa-a to 500 kPa-a), or 2.0-10 bar (200 kPa-a to 1000 kPa-a), or 2.0-5.0 bar (200 kPa-a to 500 kPa-a). The gas velocity in the heating portion of the reaction system can vary depending on the type of heating and the type of reaction system. If the same vessel includes both the pyrolysis reaction zone and the heating portion of the reaction system, then the gas velocity in the heating portion can be similar to the gas velocity for the pyrolysis reaction zone. When the heating portion is in a separate vessel from the pyrolysis reaction zone, if electric heating is used, the gas velocity can be 1.0 ft/s—10 ft/s (˜0.3 m/s to ˜3.3 m/s), or 2.0 ft/s to 5.0 ft/s (˜0.6 m/s to ˜1.7 m/s). For combustion heating in a separate vessel, the gas velocity can be 20 ft/s to 100 ft/s (˜6.5 m/s to 33 m/s), or 50 ft/s to 80 ft/s (˜17 m/s to ˜26 m/s). It is noted that in this discussion, electric heating of a fluidized bed using radiative resistance heating is distinct from electric heating using direct resistance heating. In this discussion, radiative resistance heating of a fluidized bed corresponds to using an electric heater that transfers heat to particles in the fluidized bed, either directly or indirectly. This is in contrast to direct resistive heating of particles, which corresponds to including particles in the fluidized bed that have sufficient electrical conductivity that the particles can be heated by passing an electric current through the particles. It is noted that induction heating of a fluidized bed corresponds to still another type of heating that can be used.

One type of fluidized bed reactor that can be used for hydrocarbon pyrolysis is bubbling bed (or turbulent bed) with a disengaging zone. In this type of configuration, the reactor can include one or more fluidized beds, with each bed having a relatively dilute phase in terms of particle density above the dense phase fluidized bed. In this type of configuration, the gas velocity in the fluidized bed region can be roughly 1.0 ft/s to 5.0 ft/s (˜0.3 m/s to ˜1.7 m/s). Typically, a bubbling bed reactor has a similar cross-section for most of the height of the reactor, so the velocity is similar throughout the reactor.

Another type of fluidized bed reactor is a turbulent bed reactor with a top riser. This type of reactor can also have a denser region and a dilute region, but with less difference in particle density between the regions. In this type of configuration, the gas velocity in the dense portion of the fluidized bed can be roughly 1.0 ft/s to 15.0 ft/s (˜0.3 m/s to ˜5.0 m/s). In the top riser section, the gas velocity can increase to roughly 20 ft/s to 100 ft/s (˜6.5 m/s to 33 m/s).

Still another option can be to use a riser reactor configuration. In this type of configuration, the gas velocity can be roughly 20 ft/s to 100 ft/s (˜6.5 m/s to 33 m/s) in the reactor.

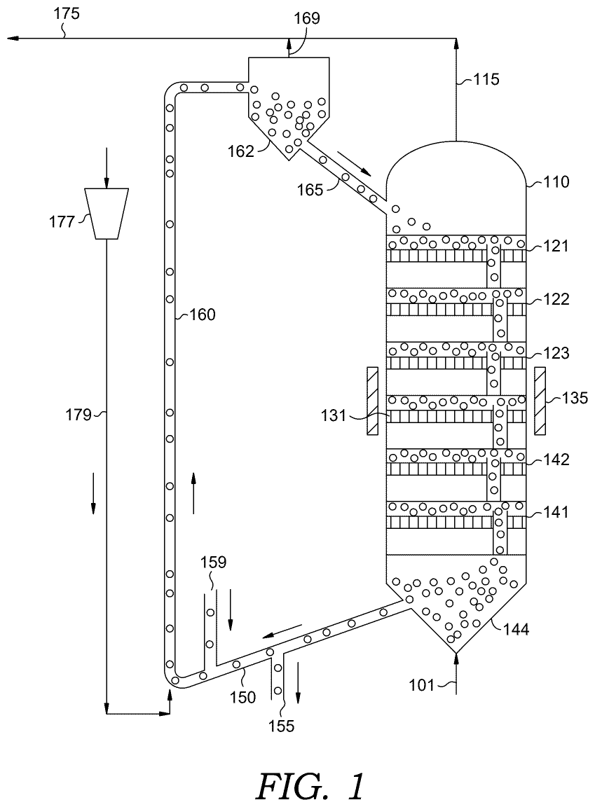

As an example of a reaction system, FIG. 1 shows a system for performing fluidized bed pyrolysis of a hydrocarbon stream using a plurality of fluidized beds. Some examples of this type of system are illustrated in the various configurations shown in U.S. Patent Application Publication 2021/0331918 and/or International Publication WO/2022/081170. The example configuration shown in FIG. 1 includes a particle reservoir that assists with managing the flow of particles within the system. In the example configuration depicted in FIG. 1, a reactor 110 is shown that contains a sequential plurality of fluidized beds. Reactor 110 is shown as a single reactor, but any convenient number of reactors could be used to house the fluidized beds. Reactor 110 is shown as a single reactor, but any convenient number of reactors could be used to house the fluidized beds. Reactor 1110 includes upstream heat transfer fluidized beds 141 and 142, a fluidized bed 131 corresponding to the pyrolysis reaction zone, and downstream heat transfer fluidized beds 121, 122, and 123. Thus, fluidized beds 141 and 142 correspond to a first group of upstream fluidized beds, fluidized bed 131 corresponds to a second group of fluidized beds operating under pyrolysis conditions, and fluidized beds 121, 122, and 123 correspond to a third group of downstream fluidized beds. The number of fluidized beds shown in FIG. 1 is an example, and any convenient number of fluidized beds can be used in each group. It is noted that in some aspects, the temperature may be high enough in fluidized bed 123 and/or fluidized bed 142 for some pyrolysis to also occur, even though those beds are described as heat transfer beds.

In FIG. 1, external heater 135 is used to heat fluidized bed 131 to a desired pyrolysis temperature. Although only a single fluidized bed is shown in FIG. 1, in other embodiments a plurality of fluidized beds 131 operated under pyrolysis conditions can be used. This allows for improved net reaction rate for the fluidized beds 131 relative to a single fluidized bed of similar size. An example of external heating is electrical heating, optionally including using heating elements that extend into the volume of the fluidized bed 131.

During operation, input gas flow 101, such as a methane or natural gas flow, enters the reactor 110 from the bottom. The input gas flow 101 serves as a fluidizing gas for the various fluidized beds as the gas flow moves up through the various fluidized beds. As the input gas flow 101 moves through fluidized beds 141 and 142, the input gas flow is heated by the successive fluidized beds. The input gas flow then passes into fluidized bed(s) that are externally heated 135. This results in pyrolysis of at least a portion of the input gas flow to H₂, so that hydrogen-containing product gas flow 115 is formed. The pyrolysis also produces solid carbon that is deposited on carbon particles. The hydrogen-containing product gas flow 115 continues to pass through fluidized beds 123, 122, and 121. This cools the hydrogen-containing product gas flow prior to product gas flow 115 exiting from the top of reactor 110. It is noted that if multiple fluidized beds 131 are present, the composition of the product gas flow 115 can change as additional hydrogen is formed in each successive fluidized bed that is operated under pyrolysis conditions. Additionally, to the degree that some pyrolysis may occur in a heat transfer bed, such as fluidized bed 142 or fluidized bed 123, the composition of the input gas flow 101 could change prior to reaching fluidized bed(s) 131 and/or the composition of the hydrogen-containing product gas flow 115 could change after leaving fluidized bed(s) 131.

During operation, the pyrolysis coke particles in the reactor can flow in a counter-current manner relative to the input flow gas 101 and the hydrogen-containing product gas flow 115. In the example shown in FIG. 1, pyrolysis coke particle stream 165 is introduced into the top of fluidized bed 121. The pyrolysis coke particles are heated in fluidized bed 121 by hydrogen-containing product gas flow 115, and are heated further as the pyrolysis coke particles pass down into fluidized bed 122 and fluidized bed 123. The heated pyrolysis coke particles are then passed into the pyrolysis zone in fluidized bed(s) 131, which are externally heated. The pyrolysis reaction adds carbon to the pyrolysis coke particles. The hot pyrolysis coke particles then continue into fluidized bed 142 and 141, being cooled by heat exchange with input gas flow 101.

After exiting from fluidized bed 141, the cooled pyrolysis coke particles pass into reservoir 144. A portion of the pyrolysis coke particles exit from reservoir 144 to form pyrolysis coke particle flow 150. A portion of pyrolysis coke particle flow 150 can be withdrawn from the system as pyrolysis coke product 155. The remainder of pyrolysis coke particle flow 150 is then recycled back to the top of the reactor. In FIG. 1, this is accomplished using pneumatic transport conduit 160, with a portion 179 of the hydrogen-containing product gas flow 115 being used as the pneumatic transport gas. A compressor or blower 177 can be used to provide sufficient pressure for the portion 179 to act as the pneumatic transport gas. At the top of the conduit 160, the pyrolysis coke particles are separated from the portion 169 of hydrogen-containing product gas flow in cyclone separator 162. This forms pyrolysis coke particle stream 165. In the example shown in FIG. 1, the portion 169 of the hydrogen-containing product gas flow is combined with the hydrogen-containing product gas flow 115. The hydrogen-containing product gas flow 115 is then used to form product hydrogen 175 and pneumatic transport gas flow 179.

In a configuration such as FIG. 1, seed particles can be added at any convenient location. As an example, seed particles could be added 159 to pyrolysis coke particle flow 150 at a convenient location.

The configuration in FIG. 1 corresponds to a single reactor configuration, where both pyrolysis and heating occur within the same vessel. Other configurations can use multiple vessels, so that the pyrolysis reaction occurs in a separate vessel from the vessel where heating occurs. In such configurations, particles can be heated in the heating vessel and then transferred to the pyrolysis vessel to provide heat for the endothermic pyrolysis reaction. Particles can then be transferred back to the heating vessel for another cycle of heating.

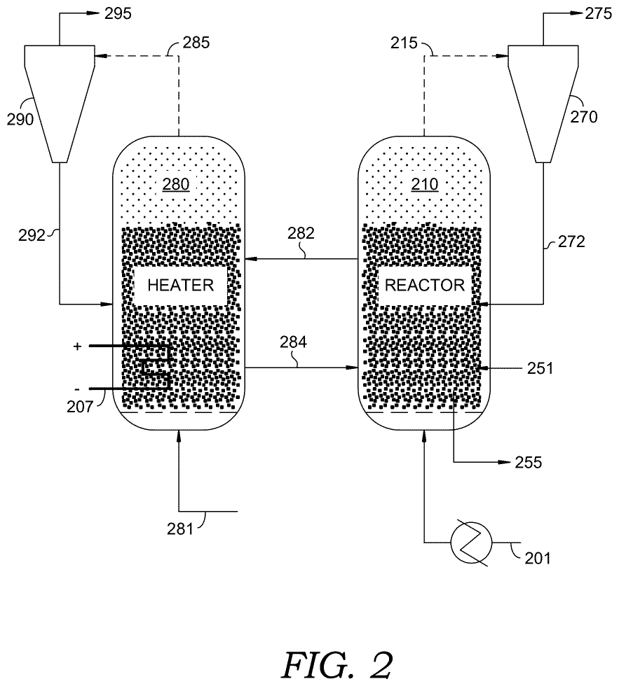

FIG. 2 shows an example of a configuration where pyrolysis is performed in a first (pyrolysis) vessel, while electric heating (or other external heating) is performed in a second reactor or vessel. In FIG. 2, pyrolysis is performed in reactor 210, but heat is added to the system in separate heater vessel 280.

In the example configuration shown in FIG. 2, the inputs into reactor 210 are hydrocarbon feed 201, seed particles 251, heated particles 284, and particle stream 272 (provided from separator 270). In the example shown in FIG. 2, the hydrocarbon feed 201 also acts as the fluidizing gas for the fluidized bed(s) in reactor 210. The pyrolysis process generates an overhead gas 215 that contains hydrogen. The overhead gas 215 can be separated in separator 270 to remove entrained solids from the remaining hydrogen-containing gas stream 275. The solids 272 from separator 270 are then returned to reactor 210. In the configuration shown in FIG. 2, the product pyrolysis coke particles 255 are withdrawn from a fluidized bed in reactor 210, but it is understood that the product pyrolysis coke particles 255 could be withdrawn from any other convenient location in the reaction system.

A portion of the particles from reactor 210 are also passed 282 into heater vessel 280. After heating of particles in heater vessel 280, heated particles 284 are returned to vessel 210 to provide heat for the pyrolysis reaction. In the example configuration shown in FIG. 2, electric heating 207 is used to heat the particles in heater vessel 280. In order to provide a fluidized bed, a fluidizing gas 281 is introduced into heater vessel 280. The overhead gas 285 from heater vessel 280 is separated in a second separator 290 to separate entrained particles 292 from the remaining gas flow 295.

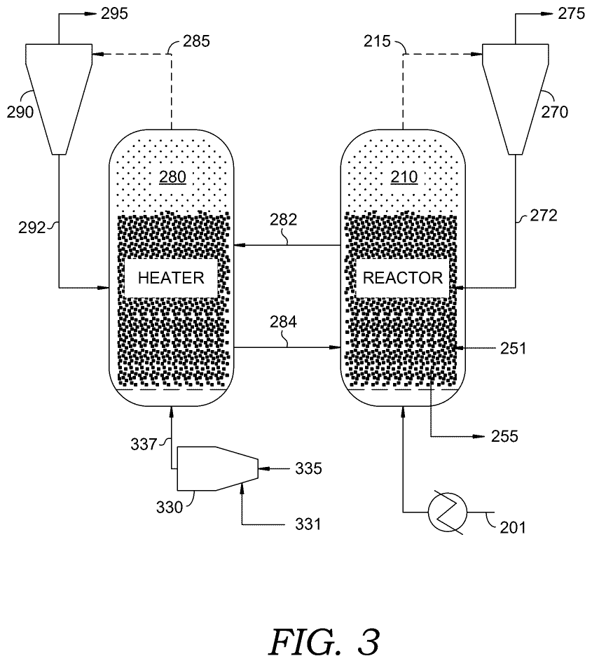

FIG. 3 shows another example of a configuration for performing pyrolysis. In the configuration shown in FIG. 3, instead of using electric heating, the particles are heated by combusting a fuel 335. As shown in FIG. 3, fuel 335 and oxygen-containing gas 331 (such as air) are mixed 330 prior to introducing the combined fuel and oxidant flow 337 into the heater vessel 280. It is noted that a portion of the pyrolysis coke on the particles in heater vessel 280 can also be combusted to generate heat. Optionally, fuel 335 could be reduced, minimized, or even omitted, so that up to substantially all of the heat generated in heater vessel 280 is generated based on combustion of pyrolysis coke within heater vessel 280.

It is noted that heater vessel 280 can have other configurations than a fluidized bed environment. More generally, heater vessel 280 can provide a fluidized heating environment that operates in a dense or a dilute phase. For example, another option for heater vessel 280 is to have a fired heater system with a dilute transport system to heat the circulating pyrolysis coke particles.

As a general example of operation, the process of performing pyrolysis and forming pyrolysis coke particles can be described with respect to how particles move within a reaction system. In an embodiment, the pyrolysis of a hydrocarbon-containing feedstock is performed in one or more fluidized beds where pyrolysis conditions are present. These one or more fluidized beds include both seed particles, which have not yet received any deposited pyrolysis coke, and pyrolysis coke particles, which have already been exposed to the pyrolysis conditions for a sufficient amount of time to have at least some pyrolysis coke deposited on the surface. If desired, the particles in these one or fluidized beds could be referred to as “working” particles, as the fluidized bed provides the reaction environment for performing pyrolysis.

After a period of time that depends on the configuration of the reaction system, at least a portion of the particles in the fluidized bed will leave the fluidized bed to move to other parts of the reaction system. This portion of particles can be referred to as a first fluidized plurality of particles. In some embodiments, substantially all of the first fluidized plurality of pyrolysis particles will correspond to pyrolysis coke particles, as at least some pyrolysis coke will be deposited on the particles. In other embodiments, depending on the system configuration, it is possible that seed particles that do not have pyrolysis coke deposited on the particle could be included as part of the first fluidized plurality of particles.

Optionally, a portion of the particles removed from the first fluidized bed (a portion of the first fluidized plurality of particles) are incorporated into a product particle fraction. Other portion(s) of the first fluidized plurality of particles can correspond to a transfer portion of particles that is eventually passed into a heating zone or stage, where the transfer portion of particles are added to a second fluidized plurality of particles. The second fluidized plurality of particles in the heating zone or stage may correspond to one or more second fluidized beds, or may correspond to another type of fluidized particle environment. Optionally, some of the particles from the second fluidized plurality of particles may be incorporated into a product portion of particles. The heating zone or stage is used to form heated particles, in order to provide heat for performing the pyrolysis reaction. A heated portion of the heated particles is passed back into the first fluidized bed in order to provide this heat for the pyrolysis reaction. Optionally, some of the heated particles can be incorporated into a product particle fraction.

In addition to passing the heated portion of heated particles into the one or more fluidized beds for performing pyrolysis, seed particles can also be passed into the one or more fluidized beds for performing pyrolysis. Optionally, the seeds can be heated prior to being passed into the one or more fluidized beds for performing pyrolysis.

### Forced Circulation Pyrolysis

An alternative to a bubbling bed reactor for fluidized bed pyrolysis is a forced circulation reactor. In a forced circulation reaction system, a solids circulation stream is propelled through the entire vertical height of the fluid bed vessel, into an overhead gas/solids separation device, such as a cyclone. Accordingly, in the context of a forced circulation pyrolysis system, pyrolysis coke particles will be present at a relatively high density in substantially all portions of the reaction system where the temperature is sufficiently high to facilitate a pyrolysis reaction. In contrast, a bubbling bed vessel in a circulating fluid bed system will typically feed a solids stream into the dense bubbling bed zone of the vessel, and withdraw solids from the dense bubbling bed zone. The vapor space above the dense bubbling bed zone will not have a forced circulation flow, but will only have a reduced or minimized amount of solids entrainment depending on the gas velocity, gas properties and solid properties of the bubbling bed system. This entrainment in many systems will typically provide a low solids fraction in the overhead vapor space above the fluidized bed. In systems where a bubbling bed vessel also includes sufficiently high temperatures for pyrolysis, the low density of pyrolysis coke particles in the vapor space above the bubbling bed can allow for increased particle nucleation and/or deposition of carbon on walls and other interior surfaces. In such a conventional bubbling bed version of a fluidized bed, this low solids entrainment in the vapor above the bubbling bed can correspond to a solids density in the dilute zone of less than 0.1 lb/ft³. Conventional riser reactors are similarly operated at densities below 0.1 lb/ft³.

A forced circulation reactor will have a zone at the top of the reactor to provide solids lift to the reactor overhead equipment, such as a cyclone. The lift may be achieved with a lift velocity between 20 and 80 ft/s and sufficient solids circulation to produce above a minimum solids density in the upper lift zone. In various embodiments, the minimum solids density may be from 0.1 to 10 lb/ft³, or 0.2 to 10 lb/ft³, or 0.5 to 10 lb/ft³, or 0.7 to 10 lb/ft³, or 1.0 to 10 lb/ft³, or 2.0 to 10 lb/ft³, or 2.0 to 5.0 lb/ft³, or 1.0 to 5.0 lb/ft³, or 0.7 to 5.0 lb/ft³, or 0.5 to 5.0 lb/ft³, or 0.2 to 5.0 lb/ft³, or 0.1 to 5.0 lb/ft³, or 0.1 to 2.0 lb/ft³, or 0.2 to 2.0 lb/ft³, or 0.5 to 2.0 lb/ft³, or 1.0 to 2.0 lb/ft³. In various embodiments, the lift velocity may be 20 to 80 ft/s, or 25 to 80 ft/s, or 30 to 80 ft/s, or 35 to 80 ft/s, or 40 to 80 ft/s, or 45 to 80 ft/s, or 50 to 80 ft/s, or 55 to 80 ft/s, or 60 to 80 ft/s, or 65 to 80 ft/s, or 70 to 80 ft/s, or 20 to 75 ft/s, or 20 to 65 ft/s, or 20 to 55 ft/s, or 20 to 45 ft/s, or 20 to 35 ft/s, or 20 to 30 ft/s, or 30 to 70 ft/s, or 40 to 60 ft/s, or 45 to 55 ft/s.

In some embodiments where the pyrolysis reactor corresponds to a forced circulation reactor, the lift riser zone of the reactor vessel will constitute the entire reactor vessel. In such embodiments, the reactor vessel can potentially have a constant diameter, or the diameter can vary to allow for roughly constant velocity in the reactor vessel as the molar volumetric flow and/or temperature changes as the pyrolysis reaction occurs. In other embodiments, a lower velocity section could be installed below the riser lift zone to provide additional vapor and/or solids contact time to achieve a higher level of reaction conversion. This zone would be designed for a bubbling, turbulent, or fast fluidized operating regime, in a velocity range from 0.5 and 15 ft/s, producing a solids density from 25% and 100% of minimum fluidization density. The bottom, lower velocity reactor section then transitions to the upper, higher velocity riser through a transition zone. In this type of configuration, the riser portion of the vessel will have a solids density of 0.1 lb/ft³ or more, or 0.2 lb/ft³ or more, such as up to 5.0 lb/ft³ or possibly still higher, while the lower portion of the reactor vessel will have a still higher solids density.

During operation of a pyrolysis reaction system based on a forced circulation reactor, pyrolysis of the hydrocarbon feedstock is performed in a reactor vessel as described above. This results in formation of a gas/solids mixture containing a pyrolysis effluent and pyrolysis coke particles that include at least a portion of pyrolysis coke that was deposited on the particles during transit through the reactor. The gas/solids mixture exiting the reactor is then routed to a series of additional equipment stages to perform various tasks in order to facilitate continuous operation.

One task is to separate the pyrolysis gas phase effluent, containing the hydrogen product, from the solids in the gas/solids mixture. To achieve this, the gas/solids mixture is passed into one or more separation stages, such as cyclone stages and/or filtration stages, to separate pyrolysis effluent vapors from the circulating solids stream.

Another task is to modify the temperature(s) of the various portions of the gas/solids flow exiting from the pyrolysis vessel. The gas phase portion of the pyrolysis effluent is cooled or quenched to terminate pyrolysis chemistry, so that nucleation of additional particles and/or coking of downstream equipment is reduced or minimized. The circulating solids are heated in order to provide heat to the pyrolysis reactor vessel. This heating can be performed in any convenient manner, such as electric heating, heating by direct contact with a heated fluid (such as a combustion effluent), and/or by indirect heating.

Still another task is management of the solids within the overall reaction system, which includes withdrawing a solids product from the reaction system, and introduction of seed particles in embodiments where ex-situ seeds are used. Although withdrawal of product solids could be performed from the pyrolysis reactor vessel, more typically the solids product withdrawal will be performed at other location(s) in the reaction system in order to avoid loss of hydrogen due to entrainment with the solids product. Seed introduction can typically be performed at a location other than the pyrolysis reactor vessel.

Optionally, management of the solids inventory can be facilitated by having at least one vessel that allows for a variable level of solid inventory. In other words, the reaction system can include at least one vessel that is not operated using forced circulation. This at least one vessel can be a separate “surge” vessel, or the vessel used for heating the solids inventory can be operated to allow for variable inventory. Such a vessel can be operated, for example, as a bubbling bed style of fluidized bed.

Other optional tasks that may also be desirable include, but are not limited to, stripping entrained hydrocarbon gas from the circulating solids, and stripping fine particulates from circulating solids to facilitate control of particle size.

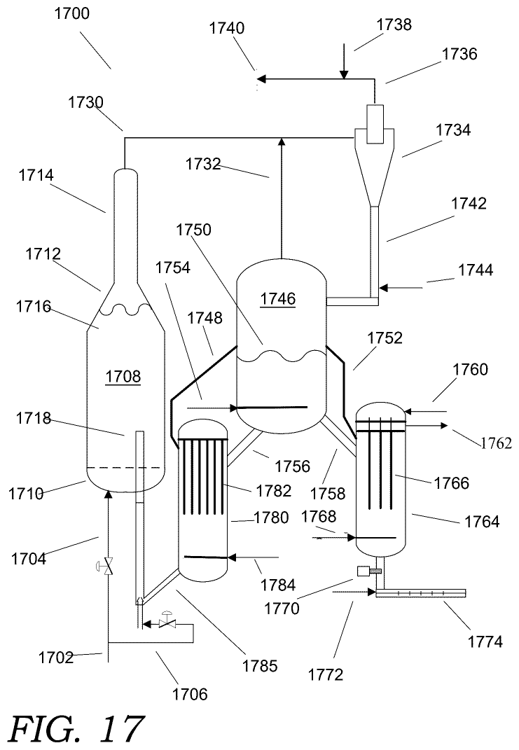

FIG. 17 shows an example of a forced recirculation system 1700 for performing fluidized bed pyrolysis of a hydrocarbon stream, is shown according to aspects of the technology described herein. At a high level, the system 1700 includes a reactor 1708, a cyclone 1734, a surge vessel 1746, a heater 1780, a withdrawal cooler 1764, and a pyrolysis coke withdrawal conduit 1774. A reactor product line 1730 connects the outlet of the reactor 1708 to an inlet of the cyclone 1734. A cyclone gas outlet line 1736 is connected to a quenching system 1738.

An upper particle recirculation line 1742 connects an outlet of the cyclone 1734 to an upper inlet in the surge vessel 1746. A middle particle recirculation line 1756 connects a recirculation outlet in the bottom of the surge vessel 1746 to a particle inlet in the heater 1780. A particle outlet line 1758 connects a cooler outlet in the surge vessel 1746 to an inlet in the withdrawal cooler 1764. A gas recirculation line 1732 connects an outlet in the surge vessel 1746 to the reactor product line 1730.

Returning to the heater 1780, a lower particle recirculation line 1785 connects a recirculation outlet in the heater 1780 to a particle inlet riser 1718 in the reactor 1708. In the example shown in FIG. 17, the heater includes an electrical heating element 1782. A gas recirculation line 1748 connects the heater 1708 to an inlet in the surge vessel 1748. The inlet to the surge vessel 1748 may be located above a surface 1750 of a fluidized bed present during operation. A preheated inlet line 1702 connects to a lower end of the reactor 1708 and also connects with the particle inlet riser 1718. The withdrawal cooler 1764 includes a heat exchanger 1766 in fluid communication with a cooling fluid inlet 1760 and in fluid communication with a cooling fluid outlet 1762. A pyrolysis coke outlet in the lower end of the withdrawal cooler 1766 is connected to a pyrolysis coke withdrawal conduit 1774. A gas return line 1752 connects the withdrawal cooler 1764 to the surge vessel 1750. The inlet to the surge vessel 1748 may be located above a surface 1750 of a fluidized bed present during operation.

The system 1700 includes multiple lines providing fluidizing gas. The upper particle recirculation line 1742 includes an inlet connected to a fluidizing gas line 1744. The surge vessel 1746 includes an inlet connected to a surge-vessel fluidizing gas line 1754. The heater 1780 includes an inlet connected to a heater fluidizing gas line 1784. The cooler includes an inlet connected to a cooler fluidizing gas line 1768. The withdrawal conduit 1774 includes an inlet connected to withdrawal fluidizing gas line 1772.

### EXAMPLES

A pilot scale fluidized bed methane pyrolysis reactor was used to form pyrolysis coke particles based on heterogeneous seeds. In Example 2, activated carbon particles were used as the heterogeneous seeds. In Examples 1 and 3, fluidized coke particles were used as the heterogeneous seeds. The pilot scale reactor was operated in a batch mode, so that once the fluidized bed was set up, particles were not added to or subtracted from the fluidized bed during the course of a run.

### Example 1—Fluidized Coke Seeds

During a first period of operation, fluidized coke particles were used as seeds to start the fluidized bed reaction process. The fluidized coke particles corresponded fluidized coke formed in a commercial scale fluidized coking system. The fluidized coke particles were ground and then sieved. The resulting fluidized coke seeds had an average size of roughly 103 μm.

The fluidized seeds were used as the starting material for performing fluidized bed pyrolysis. Table 1 provides additional details regarding the pyrolysis conditions.

TABLE 1
Pyrolysis Conditions

| | |
|---|---|
| Feed rate, scfh | 10 (~280 L/hr) |
| Temperature, C. | 1000° C. |
| Pressure, psig | 6 psig (~40 kPa-g) |
| Gas velocity, ft/s | 1.0 ft/s (~0.3 m/s) |
| Gas residence Time, s | 8 s |
| Seed carbon | Fluidized coke, ~103 μm |

Table 2 shows the composition of the feed, as well as the composition of the resulting gas phase pyrolysis product.

TABLE 2
Pyrolysis Gas Phase Feed and Product

| | Feed (mol %) | Product (mol %) |
|---|---|---|
| N₂ | 1.5 | 1.1 |
| H₂ | — | 56.6 |
| CH₄ | 96.1 | 41.3 |
| C₂ | 2.25 | 0.6 |
| C₃₊ | 0.15 | 0.4 |

As shown in Table 2, the feed was primarily composed of methane, with small amounts of ethane and other hydrocarbons. Under the pyrolysis conditions in Table 4, roughly half of the methane was converted, while forming primarily H₂ as the gas phase pyrolysis product. Although the methane conversion could be increased, the gas phase product is representative of the product distribution at higher levels of methane conversion. Additionally, the methane in the product can be separated out and recycled to further increase overall yield relative to the feed.

During the course of the pyrolysis run, pyrolysis coke is accumulated on the seeds resulting in pyrolysis coke particles. After the pyrolysis reaction was run for 146 hours, the reaction was stopped and samples of the pyrolysis coke particles were characterized. Table 3 shows the characterization results. Table 3 also provides a comparison of the pyrolysis coke particles with sand particles that are representative of the sand particles typically used as a proppant in hydraulic fracturing. It is noted that “100 mesh” corresponds to roughly 150 μm.

TABLE 3
Pyrolysis Coke Properties

| | Pyrolysis Coke - as | Traditional “100 mesh” |
|---|---|---|
| | produced | Frac Sand |
| D50, um | 152 | 150 |
| Average apparent particle | 1.9 | 2.65 |
| density, g/cm³ | | |
| Crush strength, psi | 12000 | 8000-10000 |
| Krumbein roundness | 0.8 | 0.8 |
| Krumbein sphericity | 0.8 | 0.7 |

As shown in Table 3, the pyrolysis reaction was able to form pyrolysis coke particles with properties that were comparable to traditional sand particles used in hydraulic fracturing, with respect to D50, Krumbein roundness, and Krumbein sphericity. Additionally, the pyrolysis coke particles had a higher crush strength, while also having a lower apparent or skeletal density.

The results in Table 3 indicate that pyrolysis coke particles are potentially suitable for use as proppants in hydraulic fracturing. Hydraulic fracturing operations require effective proppant particulates to maintain the permeability and conductivity of a production well, such as for effective hydrocarbon recovery. Effective proppant particulates are typically associated with a variety of particular characteristics or properties, including efficient proppant particulate transport within a carrier fluid (determined by particle size, shape and density), sufficient crush strength to maintain fractures propped upon the removal of hydraulic pressure, and efficient conductivity once the wellbore is brought on production.

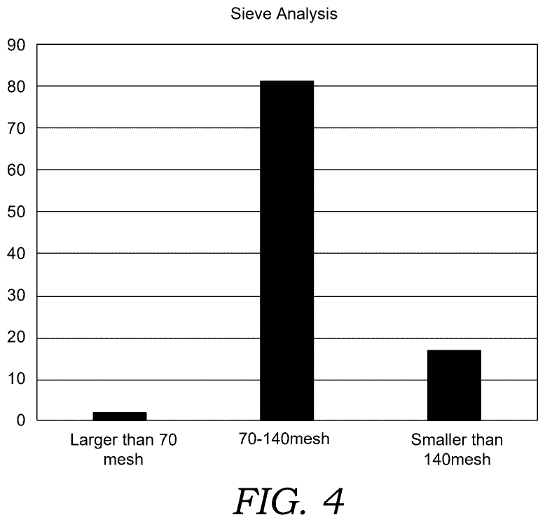

The particle size distribution for the particles was also characterized. As shown in FIG. 4, more than 80% of the produced pyrolysis coke particulates are within the 70-140 mesh size range, comparable to “100 mesh” sand proppant particles. This shows that by controlling initial particle seed size and/or other pyrolysis conditions, pyrolysis coke particles can be formed with a controlled size distribution.

In addition to the above, additional characterization was performed to determine the composition of the shell for pyrolysis coke particles having fluidized coke core using wavelength-dispersive X-ray Diffraction (WDS). The particles were stabilized in a matrix, and then locations in the pyrolysis coke shell of several particles were characterized. Based on the WDS analysis, average impurity contents were determined for sulfur, vanadium, nickel, iron, and silicon. The measured values were: 0.011+/−0.003 wt % sulfur, 84+/−20 wppm vanadium, 64+/−47 wppm nickel, <20 wppm iron, and <25 wppm silicon by wavelength dispersive x-ray spectroscopy.

### Example 2—Activated Carbon Seeds

During a second period of operation, activated carbon particles were used as seeds to start a fluidized bed reaction process. The activated carbon particles corresponded to a commercially available activated carbon that was ground and then sieved. The resulting activated carbon seeds had an average size of roughly 109 μm.

The activated carbon seeds were used as the starting material for performing fluidized bed pyrolysis. Table 4 shows the feed for the pyrolysis process.

TABLE 4
Hydrocarbon Feed

| | Feed (mol %) |
|---|---|
| N₂ | 1.5 |
| H₂ | — |
| CH₄ | 96.1 |
| C₂ | 2.25 |
| C₃₊ | 0.15 |

Table 5 provides additional details regarding the pyrolysis conditions.

TABLE 5
Pyrolysis Conditions (Activated Carbon Seed)

| | |
|---|---|
| Feed rate, scfh | 17 (~480 L/hr) |
| Temperature, C. | 1000° C. |
| Pressure, psig | 1 psig (~7 kPa-g) |
| Gas velocity, ft/s | 0.5 ft/s (~0.15 m/s) |
| Gas residence Time, s | 5 s |
| Seed carbon | Activated Carbon |

The fluidized bed pyrolysis process was periodically stopped to allow for characterization of the particles. Unexpectedly, it was discovered that when starting with a high porosity seed such as activated carbon, it was possible to form pyrolysis coke particles that have a lower apparent density than either the seed particle alone or the pyrolysis coke alone. Additionally, it was discovered that addition of a thin layer of pyrolysis coke to a heterogeneous seed provided an unexpectedly large increase in crush strength for the resulting particles.

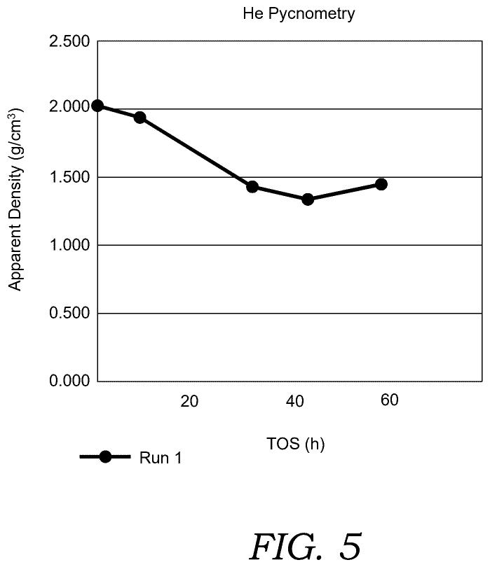

The early-time evolution of the porosity characteristics of the resulting particles was evaluated through sample collection as a function of the time on stream (TOS) in the reactor. The skeletal density (or apparent density), measured through He pycnometry, is shown in FIG. 5. In FIG. 5, time 0 corresponds to the activated carbon particles prior to any deposition of pyrolysis coke. The particles start with an apparent density of roughly 2.0 g/cm³. It is noted that pyrolysis coke alone would typically be expected to have an apparent density that is comparable to the density for activated carbon. However, as shown in FIG. 5, as pyrolysis coke deposits on the particles with activated carbon seeds, the apparent density unexpectedly drops. At roughly 15 hours, the apparent density is reduced to a value below the starting density of the activated carbon. A larger drop in apparent density then occurs between 15 hours and roughly 43 hours, so that the apparent density is reduced to a value of 1.5 g/cm³ or less. Without being bound by any particular theory, it is believed that internal pore volume that was initially accessible to He gets sealed off and becomes inaccessible as the pyrolysis reaction continues, resulting in a drop in measured apparent density. This results in a particle having a core-shell structure, where both the individual apparent density of the core and the individual apparent density of the shell are higher than apparent density of the particle having the core-shell structure. This allows particles to be formed using highly porous heterogeneous seeds that have an unexpectedly low density for pyrolysis coke particles.

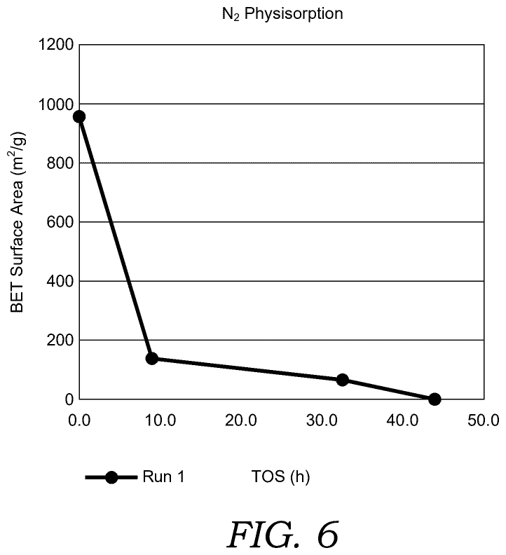

FIG. 6 shows the BET surface area for the particles at various points in time during the pyrolysis reaction. FIG. 6 shows a rapid drop in the BET surface area early in the reaction. It is noted that a substantial portion of the high surface area associated with activated carbon corresponds to surface area associated with small (nm-sized) pores. Without being bound by any particular theory, the rapid drop in surface area implies that methane pyrolysis coke blocks access to or fills the smallest pores early in the reaction. Later in the reaction, the microporosity gets sealed off without filling the mesoporous volume, resulting in the drop in apparent density shown in FIG. 5.

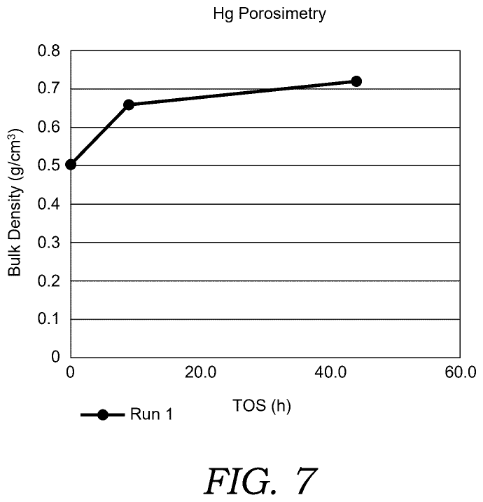

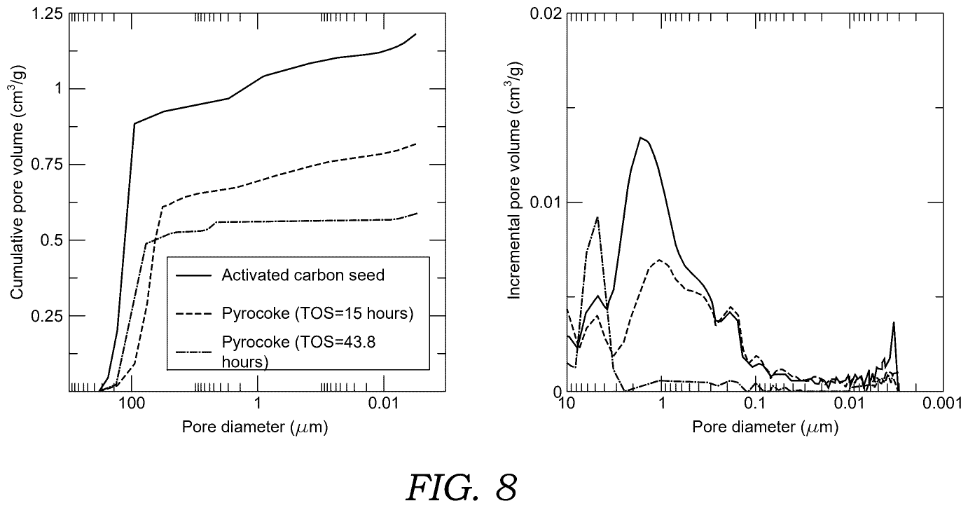

FIG. 7 shows bulk density for the particles as determined by mercury intrusion porosimetry. It is believed that the bulk density determined by mercury intrusion porosimetry is higher than the bulk density result that would be obtained under ASTM D4292-23, but is suitable for demonstrating the trend of how bulk density changes as pyrolysis coke is added to the pyrolysis coke particles. As shown in FIG. 7, although the apparent density decreases over time, the bulk density for the particles increases over time.

FIG. 8 shows additional mercury intrusion porosimetry data (according to ASTM D4284-12(2017)e1) for the particles at various points in time during the pyrolysis reaction. The data in FIG. 8 shows cumulative and incremental pore volume accessed in mercury intrusion porosimetry. The left plot shows a drop in the overall accessible mesoporous volume as a function of time on stream. The incremental pore volume directly shows that at early time, the smallest pore volumes accessible via mercury intrusion, 5-10 nm in diameter, rapidly get closed off, while significant mesoporosity remains. At later times, much of the remaining mesoporosity (<10 μm in effective diameter) is inaccessible. The drop in apparent density between the samples collected at 15 and 43.8 hours further indicates that inaccessible mesoporous volume is still present as trapped porosity in the sample.

The results shown in FIGS. 5-8 show that using activated carbon as a seed (and/or another type of highly porous heterogeneous seed) allows pyrolysis coke particles to be formed that have the external properties of pyrolysis coke while having a lower density, due to the trapped porosity within the activated carbon (or other seed) core. This can allow the resulting particles to have unexpectedly beneficial properties relative to the density of the particles. The improved structural properties of the pyrolysis coke shell relative to the activated carbon core were further investigated using nanoindentation and stress-strain characterization. The fracture conductivity of the resulting particles was also characterized, to investigate potential use of the particles as a proppant.

Nanoindentation—The intragranular mechanical behavior of the methane pyrolysis coke particles was investigated through the use of nanoindentation. Samples were cast in epoxy in the form of 1 inch (˜2.5 cm) diameter billets, and polished smooth to expose flat grain surfaces for indentation. The analysis utilized a Hysitron Premier T1 instrument (Bruker) and follows the Oliver-Pharr analysis technique to extract local mechanical properties within the grain. The Oliver-Pharr analysis technique is described in Oliver et al., Journal of Materials Research, 7(6):1564-1583, June (1992).

At each indentation site, the load and displacement profile was measured as the tip is driven into the surface to a maximum specified load, held fixed for a period of time, and retracted. The effective modulus is deduced from the slope of the unloading curve upon retraction. This process is repeated over a grid of closely spaced points to investigate the local mechanical properties near the edge of the interior of the grain. For the particles based on an activated carbon seed. The nanoindentation analysis was performed on samples collected after 8.8 hours on stream and 165 hours on stream.

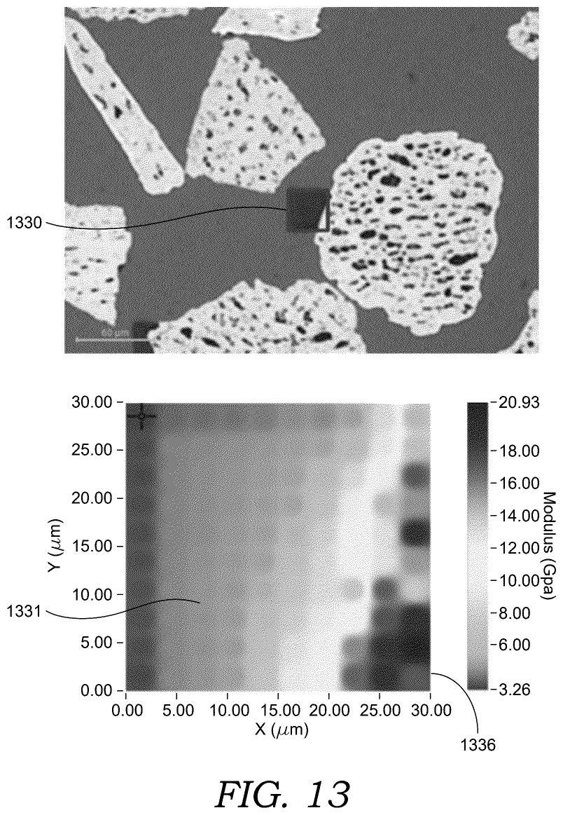

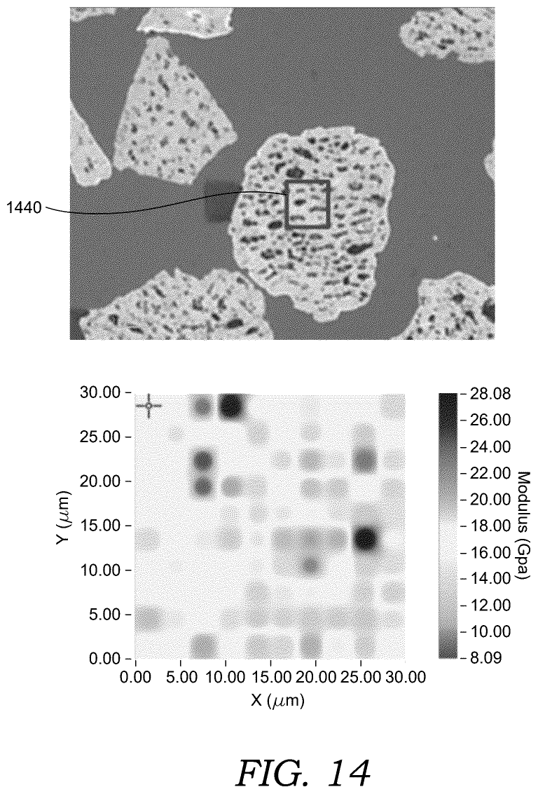

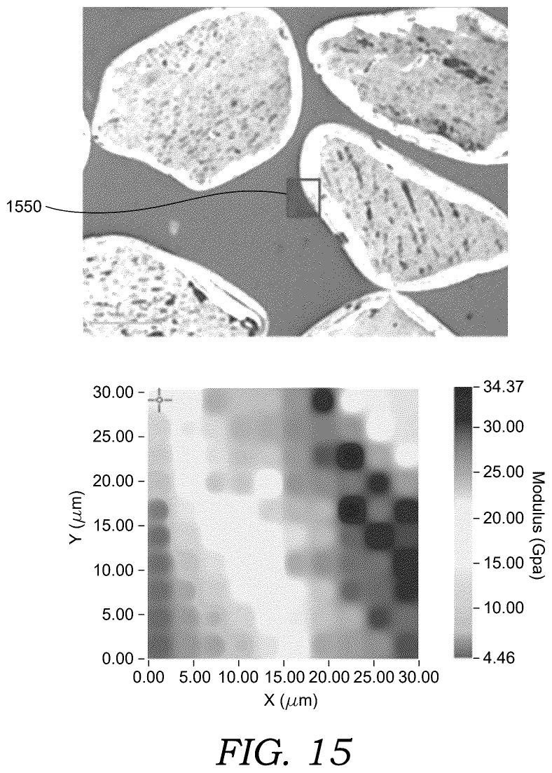

FIG. 13, FIG. 14, and FIG. 15 show images from the nanoindentation analysis. In each of FIG. 13, FIG. 14, and FIG. 15, the top image illustrates where the nanoindentation analysis was performed relative to the location of a pyrolysis coke particle in the epoxy matrix. The bottom image corresponds to a “color” map for the resulting modulus value. The color map is shown in grayscale in FIG. 13, FIG. 14, and FIG. 15, but the meaning of the color map is explained for each image.

For the sample collected after 8.8 hours on stream, the particles had a barely visible border of deposited pyrolysis coke. This can be seen, for example, by comparing region 1330 in FIG. 13 with region 1550 in FIG. 15. In region 1330 in FIG. 13, there is almost no visible boundary layer between the particle and the epoxy. By contrast, for region 1550 in FIG. 15, there is a clear boundary layer of pyrolysis coke between the interior of the particle (activated carbon) and the epoxy.

For the nanoindentation analysis of region 1330 in FIG. 13, the majority of the nanoindentation region corresponds to the soft epoxy, which had an effective modulus of 3-4 GPa. This corresponds to the left portion 1331 of the color map. The lower right corner 1336 of the color map corresponds to the region probed near the boundary between the pyrolysis coke shell and the activated carbon core. This region revealed a much higher modulus of 19-21 GPa.

For the nanoindentation analysis of region 1440 of FIG. 14, all of the region corresponds to an interior region of a particle, and therefore corresponds to the activated carbon interior of the particle. It is noted that region 1440 in FIG. 14 corresponds to an interior portion of the same particle that was sampled in region 1330 of FIG. 13. The modulus of the interior of the particle in region 1440 averaged between 14-18 GPa, suggesting that even at early reaction times, the pyrolysis coke deposited on the seed is a stiffer material than the activated carbon seed particle.

For the particles collected after 165 hours on stream in the reactor (FIG. 15), a thick boundary layer coating (of pyrolysis coke) was evident in the cross-section of the particles. Region 1550 includes this boundary layer for one of the particles. The effective modulus of this boundary layer in region 1550 of FIG. 15 was much stiffer than the boundary layer sampled in region 1330 of FIG. 13, with values in excess of 30 GPa.

Stress-Strain behavior—Still another type of characterization was evaluation of the intergranular behavior of the pyrolysis coke materials in a simple uniaxial compression test using a pellet die. This test allowed for the mechanical response of a small ensemble of grains to be examined, where macroscopic strain is generated through grain rotation and sliding during the compression process, in addition to intraparticle deformation and grain cleavage. The test involved loading approximately 1 gram of material into a 0.5 inch (˜1.3 cm) diameter pellet die and tamping the material down lightly prior to compression in an Instron load frame. The grain packs were compressed at a rate of 0.15 mm/min to a maximum load of 7500N (approximately 8600 psi). The compression tests were performed on particle samples obtained after 43.8 hours, 62.9 hours, and 165 hours of time on stream in the pyrolysis reactor.

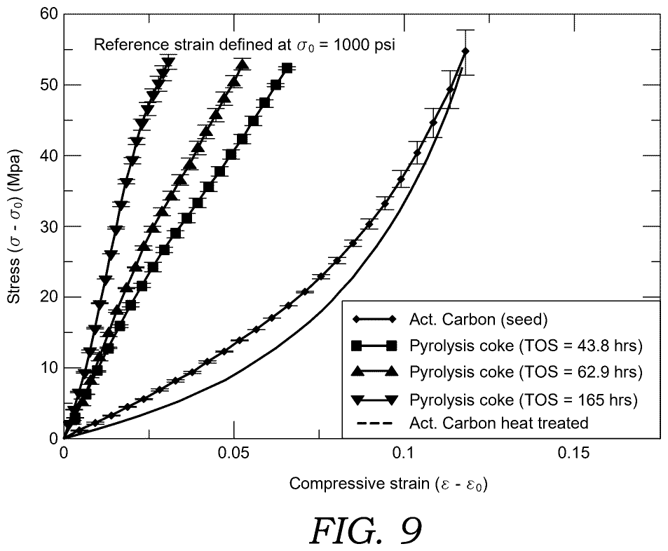

The stress-strain curves are depicted in FIG. 9, where the curves have been shifted to a reference strain ε₀ at which the applied stress σ₀ was 1000 psi. As shown in FIG. 9, the first pyrolysis coke sample (with time on stream, TOS, of 43.8 hours) exhibits a much stiffer overall compaction response than the activated carbon seed material used in the beginning of the pyrolysis process. It is noted that the thickness of the pyrolysis coke shell after only 43.8 hours was estimated (by interpolation between measured values) to be only ˜3.7 μm. Thus, relative to the thickness of pyrolysis coke added to the activated carbon core, an unexpected increase in stiffness was achieved, as the bulk of the particle still corresponds to the activated carbon. The pyrolysis product was subsequently sieved and re-injected into the pyrolysis unit, allowing further build up of the pyrolysis material. Samples collected after longer times (TOS of 62.9 and 165 hours, respectively) exhibit even greater granular stiffness, while still having only modest thicknesses for the pyrolysis coke shell (˜5.3 μm at 62.9 hours, 14 μm at 165 hours). To further demonstrate the unexpected nature of these results, the activated carbon seed material was separately heat treated at 1100° C. for 1 hour in nitrogen in a tube furnace, but in the absence of methane pyrolysis. The response of this material is similar to the relatively compliant response of the uncalcined material, demonstrating the impact of the methane pyrolysis process on the properties of the material.

Fracture Conductivity—The fracture conductivity of the resulting pyrolysis coke particles was also characterized. Fracture conductivity of proppants can be measured via the specification and procedure outlined in API RP 19C, “Measuring the Long-term Conductivity of Proppants”. Briefly, the test places a fixed quantity of proppant particulates between two Ohio sandstone cores, imposes a fixed confining stress, allows the system time to equilibrate, and then measures the steady state permeability of fluid flowing through pack, in a direction orthogonal to the imposed stress. The confining stress is increased in fixed increments, and the measurements are repeated after suitable equilibration. The conductivity is the product of the measured permeability and the proppant pack thickness.

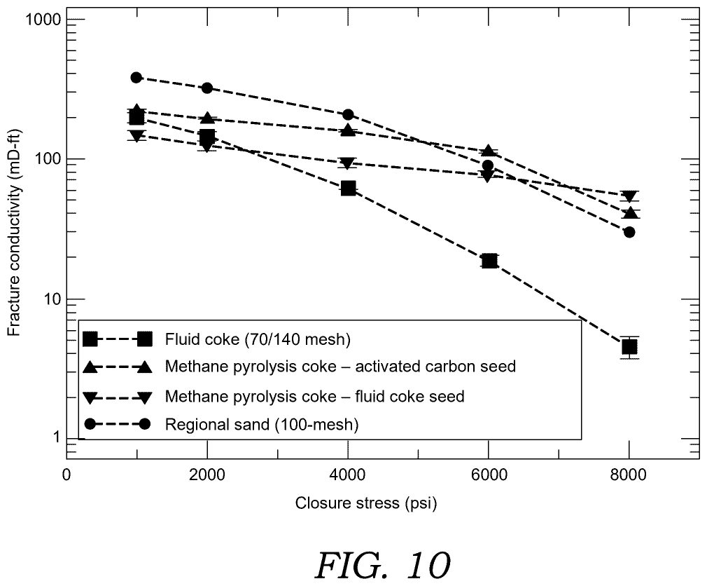

FIG. 10 shows the results from fracture conductivity testing. Four types of particles were tested under the fracture conductivity test conditions. One type of particle regional sand of roughly 100 mesh size (˜150 μm). Regional sand of this size is a conventional proppant for hydraulic fracking. A second type of particle was fluidized coke that was sieved to form a 70-140 mesh sample (105 μm to 210 μm). A third type of particles were pyrolysis coke particles formed with an activated carbon seed, as described in this Example. The fourth type of particle was pyrolysis coke with a fluidized coke seed. Prior to characterization for fracture conductivity, both types of pyrolysis coke particles were sieved to form a 70-140 mesh sample (105 μm to 210 μm).

As shown in FIG. 10, the pyrolysis coke derived from the activated carbon seed exhibited less degradation in conductivity relative to the fluidized coke particles. Additionally, at higher closure stresses, the conductivity for the pyrolysis coke particles exceeded that of the regional sand particles. It is noted that the pyrolysis coke particles with the activated carbon cores had similar properties to the pyrolysis coke particles with fluidized coke cores.

### Example 3—Fluidized Coke Seeds—Additional Characterization

Additional characterization was performed on the particles generated during the experimental runs described in Example 1. The fluidized bed pyrolysis process was periodically stopped to allow for characterization of the particles. The pyrolysis coke particles with the fluidized coke seed/core were also characterized using nanoindentation, stress-strain characterization, and fracture conductivity testing (as shown in FIG. 10).

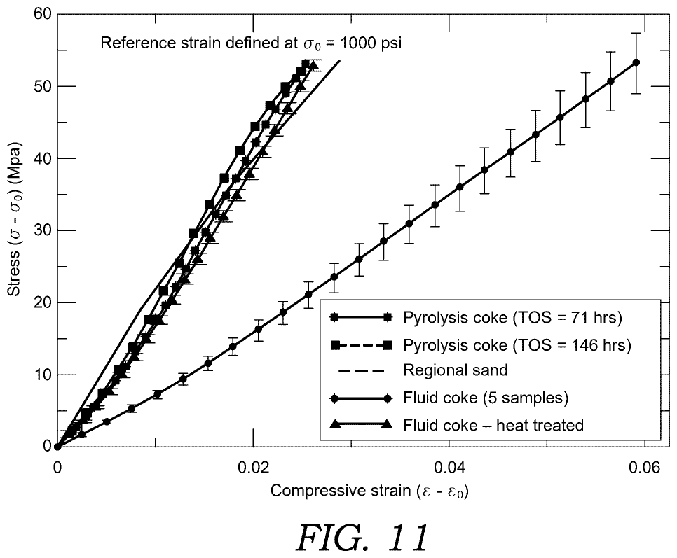

Stress-Strain Characterization—Similar to FIG. 9, stress-strain curves are plotted for pellet die compression tests of the fluidized coke-seeded pyrolysis products in FIG. 11. Two different samples of pyrolysis coke were analyzed after 71 and 146 hours on stream. It is noted that the latter sample was reintroduced into the reactor several times over the course of the methane pyrolysis unit operation. It can be seen from FIG. 11 that the stiffness of the grain pack for the two pyrolysis products are nearly identical, suggesting that a mechanical property “steady-state” was achieved in the reactor product. It is further noted that the stress-strain response of the pyrolysis coke particles was comparable to the tested regional sand proppants used in typical hydraulic fracturing operations. Finally, the granular response was substantially stiffer than that of so-called “green” (as-received) fluidized coke, but similar to fluidized coke calcined to 1200° C. in nitrogen, in the absence of methane pyrolysis reactions. This suggests that the pyrolysis coke is of similar mechanical property to that of calcined fluidized coke.

The potential similarity of the structural properties of pyrolysis coke to fluidized coke is also supported by nanoindentation analysis. Analysis of samples collected at 71 hours showed roughly comparable moduli at the edge of the sample and in the interior, suggesting that the deposited pyrolysis coke is of similar mechanical stiffness as the calcined interior of the fluidized coke. Samples drawn later in the process exhibited an even higher modulus for the outer region (shell), but still roughly consistent with a fully calcined fluidized coke sample. The effective modulus obtained by nanoindentation analysis of green fluidized coke and fluidized coke calcined to 800° C. for 1 hour (in the absence of methane pyrolysis reactions) was 20.2 GPa+/−0.8 and 23.8+/−1.4, respectively.

It is worth noting that the density of both of these samples is approximately 1.90 g/cm³, similar to that of calcined fluidized coke. This is appreciably higher than the starting apparent density of the green fluidized coke (1.46 g/cm³), and is consistent with the understanding that fluidized coke has relatively little micro/mesoporosity that could be encapsulated by the methane pyrolysis process. The net effect is that the material's density rises in a similar manner to calcining conventional cokes in the absence of the pyrolysis reactions. Nonetheless, the final product shows considerable mechanical strength, and is significantly lower in density than sand-based proppants.

Referring back to FIG. 10, the measured fracture conductivity of the fluidized-coke-seeded methane pyrolysis product is comparable to that of regional sands used as proppants across the entire range of closure stresses and is even higher than that of sand at 8000 psi, the highest closure stress measured. The activated-carbon-seeded shows a similar trend. The conductivity of the fluidized-coke-seeded methane pyrolysis product is higher than that of the fluidized coke seed above a closure stress of 2000 psi.

### Example 4—Pyrolysis at Higher Gas Velocities

Additional pyrolysis runs were performed using fluidized coke seeds at higher gas velocities in the pyrolysis reactor. These additional pyrolysis runs were performed in a reactor configuration that corresponded to a turbulent bed reactor with a top riser. Table 6 shows the pyrolysis conditions used in Example 4.

TABLE 6
Higher Gas Velocity Pyrolysis Conditions

| | |
|---|---|
| Feed rate, scfh | 145 (~4105 L/hr) |
| Temperature, C. | 1025° C. |
| Pressure, psig | 6 psig (~40 kPa-g) |
| Turbulent bed | |
| Gas velocity, ft/s | 5.0 ft/s (~1.5 m/s) |
| Gas residence Time, s | 3 s |
| Top riser | |
| Gas velocity, ft/s | 40.0 ft/s (~12 m/s) |
| Gas residence Time, s | 0.25 s |
| Seed carbon | Fluidized coke, ~150 μm |

Table 7 shows the composition of the feed, as well as the composition of the resulting gas phase pyrolysis product.

TABLE 7
Pyrolysis Gas Phase Product

| | Feed (mol %) | Product (mol %) |
|---|---|---|
| N₂ | 1.5 | 1.15 |
| H₂ | — | 46.1 |
| CH₄ | 96.1 | 50.54 |
| C₂ | 2.25 | 1.44 |
| C₃₊ | 0.15 | 0.77 |

As shown in Table 7, the feed was primarily composed of methane, with small amounts of ethane and other hydrocarbons. Under the pyrolysis conditions in Table 6, roughly half of the methane was converted, while forming primarily H₂ as the gas phase pyrolysis product. Although the methane conversion could be increased, the gas phase product is representative of the product distribution at higher levels of methane conversion. Additionally, the methane in the product can be separated out and recycled to further increase overall yield relative to the feed.

### Example 5—Example of Ex-Situ Seed Generation

A configuration similar to FIG. 12 can be used to form both a product fraction of particles and a seed fraction of particles. In this example, a particle fraction 1201 introduced into separation stage 1210 can be separated into three particle size groups. In this example, a first group or portion of particles can correspond to a “product” cut 1215 that contains particles between a size of 105 μm (140 mesh) and 250 μm (60 mesh). A second portion of particles 1213 can correspond to particles with a size less than 105 μm. A third portion of the particles 1217 can have a size greater than 250 μm.

In this example, the third portion of particles 1217 can be passed into one or more stages 1240 for reducing particle size, such as grinding, milling, and/or attrition stages. This can allow the particles having a size of greater than 250 μm to be reduced in size. This will form some particles with sizes between 105 μm and 250 μm as well as particles smaller than 105 μm. The reduced-size particles can be returned 1247 to the initial separation stage 1210.

The second portion of particles 1213 can be further separated 1220 to remove fines from the remaining seed particles. In this example, separation stage 1220 can separate particles 1223 that are smaller than 44 μm (325 mesh) from the seed particles 1225 that have a size of 44 μm to 105 μm. The seeds 1225 can then be returned to the pyrolysis reaction system. The fines 1223 can be handled in any convenient manner. In this example, the fines 1223 are agglomerated 1230 to form larger particles.

It is noted that the above size/mesh values represent one example of the sizes that can be used in a configuration similar to FIG. 12. In other aspects, any convenient combination of size values can be used for the relationship between the product particles, seed particles, and fines.

In some embodiments where fines are removed from seed particles, such as removing fines 1223 from seed particles 1225 in the example shown in FIG. 12, the removal of fines can provide one or more advantages. These advantages include, but are not limited to, reducing the rate of production of fines, increasing the amount of pyrolysis coke produced within a target particle size distribution range, and/or reducing the amount of fines that are not captured/removed by separation devices such as cyclone separators.

In some embodiments, removal of fines from seed particles prior to re-introduction of seeds into the pyrolysis reaction system reduces the weight of fines in the product pyrolysis coke to 50 wt % or less (or 25 wt % or less, or 10 wt % or less, such as down to 1.0 wt %) of the weight of fines that are present when operating the pyrolysis reaction system without the removal of fines from the seeds. In some embodiments, the fraction of pyrolysis coke generated that is within a target particle size distribution range can be increased by 1.0 wt % or more, or 3.0 wt % or more, or 5.0 wt % or more, such as up to 15 wt % or possibly still higher, relative to the weight of pyrolysis coke within the target particle size range when removal of fines from seed particles is not performed. Further additionally or alternately, the weight of coke fines that are not captured and/or removed prior to passing particles into the heating system can be reduced by 10 wt % or more, or 20 wt % or more, such as up to 50 wt % or possibly still more.

### Example 6—Compositional Analysis of Pyrolysis Coke Particles

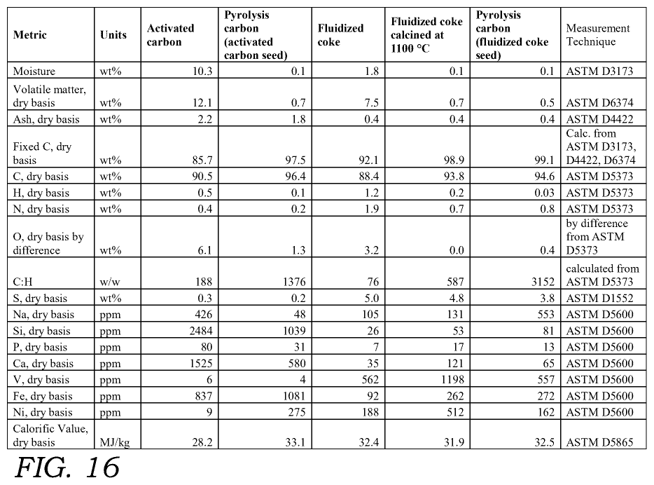

Pyrolysis coke particles based on both activated carbon seeds (Example 2) and fluidized coke seeds (Examples 1 and 3) were analyzed to determine composition. FIG. 16 shows the compositional analysis results. In FIG. 16, the third column corresponds to composition for the activated carbon seeds. The fourth column is pyrolysis coke particles formed with activated carbon seeds. The fifth and sixth columns correspond to fluidized coke seeds (fifth column) and the fluidized coke seeds after calcination (sixth column). The seventh column is pyrolysis coke particles formed with fluidized coke seeds. It is noted that compositional details for just the pyrolysis coke shell are provided above in Example 1.

As shown in FIG. 16, the activated carbon seed particles have a higher water content than the other seeds or the pyrolysis coke particles. The reflects the fact that moisture content is roughly a proxy for the amount of available surface area, which is substantially higher for the activated carbon seeds than the other materials in FIG. 16.

The activated carbon seeds also have a higher ash content, which is mitigated but still noticeable in the ash content of the pyrolysis coke particles containing the activated carbon seeds. The ash content of the fluidized coke seeds is comparable to the ash content of the pyrolysis coke particles formed with the fluidized coke seeds.

Both the activated carbon seeds and the fluidized coke seeds (prior to calcination) have a higher volatile matter content than the corresponding pyrolysis coke particles. The volatile matter content of the calcined fluidized coke seeds is similar to the volatile matter content of the pyrolysis coke particles. The higher temperatures involved in either calcination or forming pyrolysis coke result in removal of the substantial majority of volatile matter. The amount of “fixed carbon” is correspondingly lower for the activated carbon and fluidized coke seeds. The two types of seed particles have lower carbon contents than pyrolysis coke. Activated carbon has a relatively low content of sulfur (less than 0.3 wt %). The fluidized coke seeds have a relatively high sulfur content (˜5 wt %, slightly lower after calcination). The addition of pyrolysis coke can mitigate the sulfur content of the final pyrolysis coke particles that contain the fluidized coke seeds, but the elevated sulfur content is still noticeable (˜3.8 wt %).

With regard to other impurities, the activated carbon seeds contain higher levels of Ca, Fe, and Si, with corresponding higher levels in the resulting pyrolysis coke particles. The fluidized coke seeds contain higher levels of metals such as Ni, Fe, and V, although there is some variability in the amount of these metals in the seeds versus the resulting pyrolysis coke particles.

Table 8 shows additional characterization of the properties of the seeds and corresponding pyrolysis coke particles. In Table 8, “AC” refers to Activated Carbon, while “FC” refers to Fluidized Coke. The “calcined” material in Column 5 of Table 8 was calcined at 1100° C. for 20 hours, in contrast to the calcined material discussed in the context of proppant performance elsewhere.

As shown in Table 8, the density of pyrolysis coke particles can be impacted by the type of seed used, with a high porosity seed such as activated carbon resulting in a lower particle density. The higher surface area of activated carbon may have some modest impact on the surface area of the resulting pyrolysis coke particles, as the particles based on activated carbon seeds have a surface area of roughly 1 m²/g instead of the roughly 0.1 m²/g for the particles based on fluidized coke seeds.

TABLE 8
Properties of Seed Particles and Pyrolysis Coke Particles

| | Activated | Pyrolysis | Fluidized | Fluidized | Pyrolysis |
|---|---|---|---|---|---|
| | Carbon | Coke (AC | Coke | Coke Seeds | Coke (FC |
| | Seeds | seeds) | Seeds | (Calcined) | Seeds) |
| Apparent Density | | 1.57 | 1.58 | 1.97 | 1.89 |
| (g/cm³) | | | | | |
| Bulk Density (g/cm³) | | 0.97 | 0.84 | 1.19 | 1.26 |
| Specific Surface Area | 950 | 1.4 | 19 | 0.7 | 0.1 |
| (m²/g) | | | | | |
| d₀₀₂ (nm) | 0.3747 | 0.3495 | 0.3496 | 0.3489 | 0.3498 |
| L_{c} (nm) | 1.1 | 2.2 | 1.4 | 2.2 | 2.3 |
| Bulk Crush Strength | | | 7,000 | | 12,000 |
| (psi) | | | | | |

### Example 7—Additional Example of Pyrolysis Coke Particles—Carbon Product which is Compositionally 95 wt % Pyrolysis Coke

During a further period of operation, activated carbon particles were used as seeds to start a fluidized bed reaction process. The activated carbon particles corresponded to a commercially available activated carbon that was ground and then sieved. The resulting activated carbon seeds had the distribution in Table 9. It is noted that a portion of the activated carbon seeds exited from the reactor prior to the start of the pyrolysis conditions.

TABLE 9
Size Distribution of Activated Carbon Seed

| Size | Weight loaded* (kg) |
|---|---|
| 50 mesh | 0 |
| 70 mesh | 0.5 |
| 200 mesh | 4.7 |
| Smaller than 200 mesh | 5.1 |

The fluidized seeds were used as the starting material for performing fluidized bed pyrolysis. The pyrolysis runs were performed in a reactor configuration that corresponded to a turbulent bed reactor with a top riser. Fluid bed pyrolysis was repeated for a total of nine cycles in order to produce a material which was compositionally 95%+ pyrolysis coke, as calculated by heteroatom content found only in the activated carbon seed. In each cycle, the material from the prior cycle was reloaded for additional pyrolysis carbon growth. Thus, for Cycle 1, the seeds corresponded to activated carbon particles as described in Table 9. For Cycle 2, the “seeds” corresponded to the resulting particles generated in Cycle 1. This was repeated until Cycle 9, where the “seeds” corresponded to the particles generated during Cycle 8. The particles generated during Cycle 9 corresponded to the product particles containing 95 wt % or more of pyrolysis coke. Table 10 provides additional details regarding the pyrolysis conditions for each of the cycles.

TABLE 10
Representative Pyrolysis Conditions for Synthesis of Particles Containing 95 wt % + Pyrolysis Coke

| | Cycle | Cycle | Cycle | Cycle | Cycle | Cycle | Cycle | Cycle | Cycle |
|---|---|---|---|---|---|---|---|---|---|
| | 1 | 2 | 3 | 4 | 5 | 6 | 7 | 8 | 9 |
| NG Feed rate, kg/h | 0.43 | 0.43 | | 0.46 | | 0.28 | 0.47 | 0.46 | 0.70 |
| N2 purges, kg/h | 0.80 | 0.63 | | 0.61 | | 1.46 | 0.93 | 0.87 | 0.99 |
| Temperature, C. | 1034 | 1047 | | 1018 | | 1056 | 1045 | 1051 | 1021 |
| Pressure, psig | 5.8 | 6.0 | | 6.0 | | 5.7 | 5.6 | 5.7 | 5.8 |
| Bed | | | | | | | | | |
| Superficial Gas | 0.47 | 0.40 | | 0.42 | | 0.45 | 0.53 | 0.53 | 0.73 |
| velocity, ft/s (m/s) | (0.14) | (0.12) | | (0.13) | | (0.14) | (0.16) | (0.16) | (0.22) |
| Gas residence Time, s | 17.8 | 12.8 | | 18.8 | | 13.3 | 10.6 | 8.7 | 5.1 |
| Riser | | | | | | | | | |
| Superficial Gas | 3.74 | 3.55 | | 3.35 | | 4.15 | 4.48 | 4.48 | 5.92 |
| velocity, ft/s (m/s) | (1.14) | (1.08) | | (1.02) | | (1.26) | (1.37) | (1.37) | (1.80) |
| Gas residence Time, s | 2.9 | 3.1 | | 3.2 | | 2.6 | 2.4 | 2.4 | 1.8 |
| Seed carbon | AC | Cycle 1 | Cycle 2 | Cycle 3 | Cycle 4 | Cycle 5 | Cycle 6 | Cycle 7 | Cycle 8 |

Table 11 shows characterization of the feed and resulting gas phase pyrolysis products from the pyrolysis for each of the cycles

TABLE 11
Representative Pyrolysis Gas Phase Feed and Product
for synthesis of 95 wt % + Pyrolysis Coke Particles

| | Cycle 1 | Cycle 2 | Cycle 3 | Cycle 4 | Cycle 5 | Cycle 6 | Cycle 7 | Cycle 8 | Cycle 9 |
|---|---|---|---|---|---|---|---|---|---|
| NG Feed, | | | | | | | | | |
| excluding N2 | | | | | | | | | |
| purges (mol %) | | | | | | | | | |
| N₂ | 1.50 | 1.50 | 1.50 | 1.50 | 1.50 | 1.50 | 1.50 | 1.50 | 1.50 |
| H₂ | 0.00 | 0.00 | 0.00 | 0.00 | 0.00 | 0.00 | 0.00 | 0.00 | 0.00 |
| CH₄ | 96.10 | 96.10 | 96.10 | 96.10 | 96.10 | 96.10 | 96.10 | 96.10 | 96.10 |
| C₂ | 2.25 | 2.25 | 2.25 | 2.25 | 2.25 | 2.25 | 2.25 | 2.25 | 2.25 |
| C₃₊ | 0.15 | 0.15 | 0.15 | 0.15 | 0.15 | 0.15 | 0.15 | 0.15 | 0.15 |
| Product (mol %) | | | | | | | | | |
| N₂ | 40.2 | 37.5 | | 34.9 | | 60.1 | 42.3 | 41.0 | 35.4 |
| H₂ | 39.4 | 41.1 | | 46.3 | | 29.7 | 40.3 | 41.4 | 44.6 |
| CH₄ | 19.9 | 21.1 | | 18.6 | | 9.8 | 17.0 | 17.2 | 19.4 |
| C₂ | 0.1 | 0.1 | | 0.0 | | 0.0 | 0.0 | 0.0 | 0.0 |
| C₃₊ | 0.1 | 0.1 | | 0.1 | | 0.2 | 0.3 | 0.3 | 0.3 |

In addition to the gas phase products shown in Table 11, the nine cycles of pyrolysis resulted in formation of particles containing a substantial amount of pyrolysis coke, so that 95 wt % or more of the particle corresponded to pyrolysis carbon. The resulting particles had a mean particle diameter of 538 microns. Characterization of the resulting particles that contain 95 wt % or more of pyrolysis coke are shown in Table 12, along with the other pyrolysis coke particles that were shown in Table 8. As shown in Table 12, the particles containing 95 wt % or more of pyrolysis coke had higher apparent density and higher bulk density.

TABLE 12
Particle Characterization

| | | | 95 wt % + |
|---|---|---|---|
| | Pyrolysis | Pyrolysis | Pyrolysis |
| | Coke (AC | Coke (FC | Coke (AC |
| | seeds) | Seeds) | Seeds) |
| Apparent Density (g/cm³) | 1.57 | 1.89 | 2.02 |
| Bulk Density (g/cm³) | 0.97 | 1.26 | 1.36 |
| Specific Surface Area | 1.4 | 0.1 | 0.1 |
| (m²/g) | | | |
| d₀₀₂ (nm) | 0.3495 | 0.3498 | 0.3442 |
| L_{c} (nm) | 2.2 | 2.3 | 2.9 |
| Bulk Crush Strength (psi) | | 12,000 | |

### Additional Embodiments

Embodiment 1. A composition comprising: a plurality of particles comprising pyrolysis coke, the plurality of particles having a BET surface area of 0.01 m²/g to 10.0 m²/g as measured according to ASTM D6556-21, a carbon content of 90.0 wt % or more as measured according to ASTM D5373-21, a sulfur content of 1.0 wt % or less as measured according to ASTM D1552-23, and an average apparent density of 1.85 g/cm³ to 2.26 g/cm³, as measured according to ASTM D2638-21.

Embodiment 2. A composition comprising: a plurality of particles comprising pyrolysis coke, the plurality of particles having an average apparent density of 1.0 g/cm³ to 2.26 g/cm³, as measured according to ASTM D2638-21, the plurality of particles having a D50 value between 40 μm and 500 μm and a difference between a D10 value and a D90 value of 30 μm to 250 μm, as measured according to ASTM D4464-15(2020).

Embodiment 3. The composition of any of Embodiments 1 or 2, wherein the plurality of particles has an average apparent density of 1.95 g/cm³ to 2.26 g/cm³ as measured according to ASTM D2638-21.

Embodiment 4. The composition of any of the above Embodiments, wherein the plurality of particles has a L_{c} value of 1.0 nm to 10 nm.

Embodiment 5. The composition of any of the above Embodiments, wherein the plurality of particles has a d₀₀₂ value of 0.335 nm to 0.385 nm.

Embodiment 6. The composition of any of the above Embodiments, wherein the plurality of particles has a BET surface area of 0.01 m²/g to 10.0 m²/g, or 0.01 m²/g to 2.0 m²/g, as measured according to ASTM D6556-21.

Embodiment 7. The composition of any of the above Embodiments, wherein the plurality of particles have a BET surface area of 0.01 m²/g to 1.0 m²/g as measured according to ASTM D6556-21, and an average apparent density of 1.95 g/cm³ to 2.26 g/cm³ as measured according to ASTM D2638-21.

Embodiment 8. The composition of any of the above Embodiments, wherein the plurality of particles has a BET surface area of 0.01 m²/g to 2.0 m²/g as measured according to ASTM D6556-21, a carbon content of 95.0 wt % or more as measured according to ASTM D5373-21, a sulfur content of 0.2 wt % or less as measured according to ASTM D1552-23, and an average apparent density of 1.92 g/cm³ to 2.26 g/cm³, as measured according to ASTM D2638-21.

Embodiment 9. The composition of any of the above Embodiments, wherein the plurality of particles has 1.0 wt % or less of sulfur as measured according to ASTM D1552-23, 0.6 wt % or less of nitrogen as measured according to ASTM D5373-21, and 4000 wppm or less of combined iron, nickel, and vanadium as measured according to ASTM D5600-22.

Embodiment 10. The composition of any of the above Embodiments, wherein the plurality of particles has 0.1 wt % or less (or 300 wppm or less) of sulfur as measured according to ASTM D1552-23.

Embodiment 11. The composition of any of the above Embodiments, wherein the plurality of particles has 1000 wppm or less (or 300 wppm or less) of iron as measured according to ASTM D5600-22, or wherein the plurality of particles comprise 1000 wppm or less (or 300 wppm or less) of nickel as measured according to ASTM D5600-22, or wherein the plurality of particles comprise 1000 wppm or less (or 300 wppm or less) of vanadium as measured according to ASTM D5600-22, or a combination thereof.

Embodiment 12. The composition of any of the above Embodiments, wherein the plurality of particles has 1000 wppm or less (or 300 wppm or less) of combined iron, nickel, and vanadium as measured according to ASTM D5600-22.

Embodiment 13. The composition of any of the above Embodiments, wherein the plurality of particles has a combined weight of carbon and hydrogen of 95.0 wt % or more, or 97.0 wt % or more, or 99.0 wt % or more, as measured according to ASTM D5373-21.

Embodiment 14. The composition of any of the above Embodiments, wherein the plurality of particles comprise a difference between a D10 value and a D90 value of 40 μm to 200 μm.

Embodiment 15. The composition of any of Embodiments 1 to 14, wherein the plurality of particles comprise a difference between a D10 value and a D90 value of 40 μm to 100 μm.

Embodiment 16. The composition of any of Embodiments 1 to 14 wherein the plurality of particles comprise a difference between a D10 value and a D90 value of 100 μm to 200 μm.

Embodiment 17. The composition of any of Embodiments 1 to 14, wherein the plurality of particles comprise a difference between a D10 value and a D90 value of 70 μm to 140 μm.

Embodiment 18. The composition of any of the above Embodiments, wherein the plurality of particles comprise a difference between a D10 value and the D50 value of 10 μm to 120 μm.

Embodiment 19. The composition of any of the above Embodiments, wherein the plurality of particles comprise a difference between a D10 value and the D50 value of 10 μm to 50 μm.

Embodiment 20. The composition of any of the above Embodiments, wherein the plurality of particles has a D10 value of 40 μm or higher.

Embodiment 21. The composition of any of the above Embodiments, wherein the plurality of particles has a D10 value of 100 μm or higher.

Embodiment 22. The composition of any of the above Embodiments, wherein the plurality of particles comprises less than 5 wt % of particles having a particle size of less than 50 μm.

Embodiment 23. The composition of any of the above Embodiments, wherein the plurality of particles has a D90 value of 500 μm or less.

Embodiment 24. The composition of any of the above Embodiments, wherein the plurality of particles comprise a difference between a D50 value and a D90 value of 40 μm to 200 μm.

Embodiment 25. The composition of any of Embodiments 1 to 24, wherein the plurality of particles comprise a difference between a D50 value and a D90 value of 40 μm to 100 μm.

Embodiment 26. The composition of any of Embodiments 1 to 24, wherein the plurality of particles comprise a difference between a D50 value and a D90 value of 60 μm to 160 μm.

Embodiment 27. The composition of any of the above Embodiments, wherein the plurality of particles has a D50 value of 100 μm to 500 μm.

Embodiment 28. The composition of any of the above Embodiments, wherein the plurality of particles has a D50 value of 250 μm to 500 μm.

Embodiment 29. The composition of any of Embodiments 1 to 27, wherein the plurality of particles has a D50 value of 40 μm to 400 μm, or wherein the plurality of particles has a D50 value of 150 μm to 400 μm, or wherein the plurality of particles has a D50 value of 100 μm to 300 μm.

Embodiment 30. The composition of any of the above Embodiments, wherein the plurality of particles has a D10 value of 20 μm to 350 μm, a D50 value of 40 μm to 500 μm, and a D90 value of 150 μm to 700 μm.

Embodiment 31. The composition of Embodiment 30, wherein the plurality of particles has a D10 value of 20 μm to 100 μm, a D50 value of 40 μm to 200 μm, and a D90 value of 150 μm to 350 μm.

Embodiment 32. The composition of Embodiment 30, wherein the plurality of particles has a D10 value of 70 μm to 250 μm, a D50 value of 100 μm to 400 μm, and a D90 value of 250 μm to 500 μm.

Embodiment 33. The composition of Embodiment 30, wherein the plurality of particles has a D10 value of 100 μm to 350 μm, a D50 value of 150 μm to 500 μm, and a D90 value of 350 μm to 700 μm.

Embodiment 34. The composition of Embodiment 30, wherein the plurality of particles has a D10 value of 20 μm to 100 μm, a D50 value of 40 μm to 200 μm, and a D90 value of 150 μm to 350 μm, and an average apparent density of 1.92 g/cm³ to 2.26 g/cm³.

Embodiment 35. The composition of Embodiment 30, wherein the plurality of particles has a D10 value of 70 μm to 250 μm, a D50 value of 100 μm to 400 μm, and a D90 value of 250 μm to 500 μm, and an average apparent density of 1.92 g/cm³ to 2.26 g/cm³.

Embodiment 36. The composition of Embodiment 30, wherein the plurality of particles has a D10 value of 100 μm to 350 μm, a D50 value of 150 μm to 500 μm, and a D90 value of 350 μm to 700 μm, and an average apparent density of 1.92 g/cm³ to 2.26 g/cm³.

Embodiment 37. The composition of any of the above Embodiments, wherein the plurality of particles comprise an ash content of 1.0 wt % or less, a moisture content of 0.5 wt % or less, or a combination thereof.

Embodiment 38. A composition comprising: a plurality of particles, 90 wt % or more of the plurality of particles having a core-and-shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 1.9 g/cm³ as measured according to ASTM D2638-21, the average apparent density being lower than an average core apparent density of the core portion of the core and shell structure.

Embodiment 39. A composition comprising: a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 2.26 g/cm³ as measured according to ASTM D2638-21, the plurality of particles having a D50 value between 40 μm and 500 μm and at least one of a) a difference between a D10 value and a D90 value of 40 μm to 250 μm and b) a difference between a D10 value and the D50 value of 50 μm or less.

Embodiment 40. A composition comprising: a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having a BET surface area of 0.01 m²/g to 10.0 m²/g as measured according to ASTM D6556-21, the plurality of particles having an average apparent density of 1.0 g/cm³ to 2.26 g/cm³ as measured according to ASTM D2638-21.

Embodiment 41. A composition comprising: a plurality of particles, 90 wt % or more of the plurality of particles having a core and shell structure comprising a shell portion and a core portion, the shell portion of the core-and-shell structure comprising pyrolysis coke, the plurality of particles having an average apparent density of 1.0 g/cm³ to 2.26 g/cm³ as measured according to ASTM D2638-21, the plurality of particles having a D50 value between 40 μm and 500 μm and a difference between a D10 value and a D90 value of 30 μm to 250 μm.

Embodiment 42. The composition of Embodiment 41, wherein the core portion of the core-and-shell structure comprises pyrolysis coke.

Embodiment 43. The composition of Embodiment 41 or 42, wherein the core portion of the core-and-shell structure comprises a carbonaceous material different from pyrolysis coke.

Embodiment 44. The composition of any of Embodiments 38-43, wherein an average thickness of the shell portion of the core-and-shell structure is less than an average diameter of the core portion of the core-and-shell structure for the plurality of particles.

Embodiment 45. The composition of any of Embodiments 38-43, wherein an average thickness of the shell portion of the core-and-shell structure is less than half of an average diameter of the core portion of the core-and-shell structure for the plurality of particles.

Embodiment 46. The composition of any of Embodiments 38-45, wherein an average thickness of the shell portion of the core-and-shell structure for the plurality of particles is 50 μm or less, as measured by sampling of particles using scanning electron microscopy.

Embodiment 47. The composition of any of Embodiments 38-41 or 43-46, wherein the plurality of particles has combined weight of carbon and hydrogen of 85.0 wt % to 95.0 wt % as determined according to ASTM D5373-21.

Embodiment 48. The composition of any of Embodiments 38-46, wherein the plurality of particles has a combined weight of carbon and hydrogen of 95.0 wt % or more as determined according to ASTM D5373-21.

Embodiment 49. The composition of any of Embodiments 38-46 or 48, wherein the plurality of particles has 95.0 wt % or more of carbon as determined according to ASTM D5373-21.

Embodiment 50. The composition of any of Embodiments 38-49, wherein the core portion of the core-and-shell structure has an initial average apparent density of 1.0 g/cm³ to 2.26 g/cm³ as measured according to ASTM D2638-21.

Embodiment 51. The composition of any of Embodiments 38-50, wherein the core portion of the core-and-shell structure has an initial BET surface area of greater than 100 m²/g as measured according to ASTM D6556-21.

Embodiment 52. The composition of any of Embodiments 38-51, wherein the core portion of the core-and-shell structure has an initial carbon content of 85 wt % or more as measured according to ASTM D5373-21.

Embodiment 53. The composition of any of Embodiments 38-52, wherein the core portion of the core-and-shell structure has an initial sulfur content of 1.0 wt % to 10 wt % as measured according to ASTM D1552-23.

Embodiment 54. The composition of any of Embodiments 38-53, wherein the plurality of particles has 1.0 wt % or less of sulfur as measured according to ASTM D1552-23, 0.6 wt % or less of nitrogen as measured according to ASTM D5373-21, and 4000 wppm or less of combined iron, nickel, and vanadium as measured according to ASTM D5600-22.

Embodiment 55. The composition of any of Embodiments 38-53, wherein the plurality of particles has 0.2 wt % or less of sulfur as measured according to ASTM D1552-23, 0.1 wt % or less of nitrogen as measured according to ASTM D5373-21, and 2000 wppm or less of combined iron, nickel, and vanadium as measured according to ASTM D5600-22.

Embodiment 56. The composition of any of Embodiments 38-53, wherein the shell portion of the core and shell structure comprises 0.2 wt % or less of sulfur as measured according to ASTM D1552-23; or wherein the shell portion of the core and shell structure comprises 2000 wppm or less of combined iron, nickel, and vanadium as measured according to ASTM D5600-22; or a combination thereof.

Embodiment 57. The composition of any of Embodiments 38-56, wherein the plurality of particles comprise 0.1 wt % or more of sulfur as measured according to ASTM D1552-23.

Embodiment 58. The composition of any of Embodiments 38-57, wherein the plurality of particles has an average apparent density of 1.0 g/cm³ to 1.7 g/cm³, or 1.0 g/cm³ to 1.5 g/cm³, as measured according to ASTM D2638-21.

Embodiment 59. The composition of any of Embodiments 38-57, wherein the plurality of particles has an average apparent density of 1.4 g/cm³ to 1.9 g/cm³, or 1.4 g/cm³ to 1.7 g/cm³, as measured according to ASTM D2638-21.

Embodiment 60. The composition of any of Embodiments 38-59, wherein the plurality of particles have an average BET surface area of 0.01 m²/g to 10.0 m²/g, or 0.01 m²/g to 2.0 m²/g, as measured according to ASTM D6556-21.

Embodiment 61. The composition of any of Embodiments 38-60, wherein the plurality of particles have a L_{c} value of 1.0 nm to 10 nm, or wherein the plurality of particles has a d₀₀₂ value of 0.335 nm to 0.385 nm, or a combination thereof.

Embodiment 62. The composition of any of Embodiments 38-60, wherein the plurality of particles comprise a D10 value of 20 μm to 100 μm, a D50 value of 40 μm to 200 μm, and a D90 value of 150 μm to 350 μm, and an average apparent density of 1.0 g/cm³ to 1.9 g/cm³ as measured according to ASTM D2638-21.

Embodiment 63. The composition of any of Embodiments 38-60, wherein the plurality of particles comprise a D10 value of 70 μm to 250 μm, a D50 value of 100 μm to 400 μm, and a D90 value of 250 μm to 500 μm, and an average apparent density of 1.0 g/cm³ to 1.9 g/cm³ as measured according to ASTM D2638-21.

Embodiment 64. The composition of any of Embodiments 38-60, wherein the plurality of particles comprise a D10 value of 100 μm to 350 μm, a D50 value of 150 μm to 500 μm, and a D90 value of 350 μm to 700 μm, and an average apparent density of 1.0 g/cm³ to 1.9 g/cm³ as measured according to ASTM D2638-21.

Embodiment 65. The composition of any of Embodiments 38-64, wherein the plurality of particles has an ash content of 1.0 wt % or less, a moisture content of 0.5 wt % or less, or a combination thereof.

Embodiment 66. The composition of any of Embodiments 38-41 or 43-65, wherein the core portion of the core-and-shell structure comprises activated carbon.

Embodiment 67. The composition of any of Embodiments 38-41 or 43-65, wherein the core portion of the core-and-shell structure comprises fluidized coke.

Embodiment 68. The composition of any of the above Embodiments, wherein the product portion of particles has an average crush strength of 20 MPa-a to 200 MPa-a, as determined according to API RP-19C.

### PCT/EP Clauses

Clause 1. A composition comprising: a plurality of particles comprising pyrolysis coke, the plurality of particles having a BET surface area of 0.01 m²/g to 10.0 m²/g as measured according to ASTM D6556-21, a carbon content of 90.0 wt % or more as measured according to ASTM D5373-21, a sulfur content of 1.0 wt % or less as measured according to ASTM D1552-23, and an average apparent density of 1.85 g/cm³ to 2.26 g/cm³, as measured according to ASTM D2638-21.

Clause 2. A composition comprising: a plurality of particles comprising pyrolysis coke, the plurality of particles having an average apparent density of 1.0 g/cm³ to 2.26 g/cm³, as measured according to ASTM D2638-21, the plurality of particles having a D50 value between 40 μm and 500 μm and a difference between a D10 value and a D90 value of 30 μm to 250 μm, as measured according to ASTM D4464-15(2020).

Clause 3. The composition of any of Clauses 1 or 2, wherein the plurality of particles has an average apparent density of 1.92 g/cm³ to 2.26 g/cm³ as measured according to ASTM D2638-21.

Clause 4. The composition of any of the above Clauses, wherein the plurality of particles has a L_{c} value of 1.0 nm to 10 nm.

Clause 5. The composition of any of the above Clauses, wherein the plurality of particles has a d₀₀₂ value of 0.335 nm to 0.385 nm.

Clause 6. The composition of any of the above Clauses, wherein the plurality of particles has a BET surface area of 0.01 m²/g to 10.0 m²/g as measured according to ASTM D6556-21.

Clause 7. The composition of any of the above Clauses, wherein the plurality of particles have a BET surface area of 0.01 m²/g to 1.0 m²/g as measured according to ASTM D6556-21, and an average apparent density of 1.95 g/cm³ to 2.26 g/cm³ as measured according to ASTM D2638-21.

Clause 8. The composition of any of the above Clauses, wherein the plurality of particles has a BET surface area of 0.01 m²/g to 2.0 m²/g as measured according to ASTM D6556-21, a carbon content of 95.0 wt % or more as measured according to ASTM D5373-21, a sulfur content of 0.2 wt % or less as measured according to ASTM D1552-23, and an average apparent density of 1.92 g/cm³ to 2.26 g/cm³, as measured according to ASTM D2638-21.

Clause 9. The composition of any of the above Clauses, wherein the plurality of particles has 1.0 wt % or less of sulfur as measured according to ASTM D1552-23, 0.6 wt % or less of nitrogen as measured according to ASTM D5373-21, and 4000 wppm or less of combined iron, nickel, and vanadium as measured according to ASTM D5600-22.

Clause 10. The composition of any of the above Clauses, wherein the plurality of particles has 0.1 wt % or less of sulfur as measured according to ASTM D1552-23.

Clause 11. The composition of any of the above Clauses, wherein the plurality of particles has 1000 wppm or less of iron as measured according to ASTM D5600-22, or wherein the plurality of particles comprise 1000 wppm or less of nickel as measured according to ASTM D5600-22, or wherein the plurality of particles comprise 1000 wppm or less of vanadium as measured according to ASTM D5600-22, or a combination thereof.

Clause 12. The composition of any of the above Clauses, wherein the plurality of particles has 1000 wppm or less of combined iron, nickel, and vanadium as measured according to ASTM D5600-22.

Clause 13. The composition of any of the above Clauses, wherein the plurality of particles has a combined weight of carbon and hydrogen of 95.0 wt % or more as measured according to ASTM D5373-21.

Clause 14. The composition of any of the above Clauses, wherein the plurality of particles comprise a difference between a D10 value and a D90 value of 40 μm to 200 μm, or 40 μm to 100 μm, or 100 μm to 200 μm, or 70 μm to 140 μm.

Clause 15. The composition of any of the above Clauses, wherein the plurality of particles comprise a difference between a D10 value and the D50 value of 10 μm to 120 μm.

Clause 16. The composition of any of the above Clauses, wherein the plurality of particles has a D10 value of 40 μm or higher.

Clause 17. The composition of any of the above Clauses, wherein the plurality of particles comprises less than 5 wt % of particles having a particle size of less than 50 μm.

Clause 18. The composition of any of the above Clauses, wherein the plurality of particles has a D90 value of 500 μm or less.

Clause 19. The composition of any of the above Clauses, wherein the plurality of particles comprise a difference between a D50 value and a D90 value of 40 μm to 200 μm, or 40 μm to 100 μm, or 60 μm to 160 μm.

Clause 20. The composition of any of the above Clauses, wherein the plurality of particles has a D50 value of 100 μm to 500 μm.

Clause 21. The composition of any of the above Clauses, wherein the plurality of particles has a D50 value of 40 μm to 400 μm, or wherein the plurality of particles has a D50 value of 150 μm to 400 μm, or wherein the plurality of particles has a D50 value of 100 μm to 300 μm.

Clause 22. The composition of any of the above Clauses, wherein the plurality of particles has a D10 value of 20 μm to 350 μm, a D50 value of 40 μm to 500 μm, and a D90 value of 150 μm to 700 μm.

Clause 23. The composition of Clause 22, wherein the plurality of particles has a D10 value of 20 μm to 100 μm, a D50 value of 40 μm to 200 μm, and a D90 value of 150 μm to 350 μm; or wherein the plurality of particles has a D10 value of 70 μm to 250 μm, a D50 value of 100 μm to 400 μm, and a D90 value of 250 μm to 500 μm; or wherein the plurality of particles has a D10 value of 100 μm to 350 μm, a D50 value of 150 μm to 500 μm, and a D90 value of 350 μm to 700 μm.

Clause 24. The composition of Clause 22, wherein the plurality of particles has a D10 value of 20 μm to 100 μm, a D50 value of 40 μm to 200 μm, and a D90 value of 150 μm to 350 μm, and an average apparent density of 2.0 g/cm³ to 2.26 g/cm³; or wherein the plurality of particles has a D10 value of 70 μm to 250 μm, a D50 value of 100 μm to 400 μm, and a D90 value of 250 μm to 500 μm, and an average apparent density of 2.0 g/cm³ to 2.26 g/cm³; or wherein the plurality of particles has a D10 value of 100 μm to 350 μm, a D50 value of 150 μm to 500 μm, and a D90 value of 350 μm to 700 μm, and an average apparent density of 2.0 g/cm³ to 2.26 g/cm³.

Clause 25. The composition of any of the above Clauses, wherein the plurality of particles comprise an ash content of 1.0 wt % or less, a moisture content of 0.5 wt % or less, or a combination thereof.

Clause 26. A composition comprising: a plurality of particles, 90 wt % or more of the plurality of particles having a core-and-shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 1.9 g/cm³ as measured according to ASTM D2638-21, the average apparent density being lower than an average core apparent density of the core portion of the core and shell structure.

Clause 27. A composition comprising: a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 2.26 g/cm³ as measured according to ASTM D2638-21, the plurality of particles having a D50 value between 40 μm and 500 μm and at least one of a) a difference between a D10 value and a D90 value of 40 μm to 250 μm and b) a difference between a D10 value and the D50 value of 50 μm or less.

Clause 28. A composition comprising: a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having a BET surface area of 0.01 m²/g to 10.0 m²/g as measured according to ASTM D6556-21, the plurality of particles having an average apparent density of 1.0 g/cm³ to 2.26 g/cm³ as measured according to ASTM D2638-21.

Clause 29. A composition comprising: a plurality of particles, 90 wt % or more of the plurality of particles having a core and shell structure comprising a shell portion and a core portion, the shell portion of the core-and-shell structure comprising pyrolysis coke, the plurality of particles having an average apparent density of 1.0 g/cm³ to 2.26 g/cm³ as measured according to ASTM D2638-21, the plurality of particles having a D50 value between 40 μm and 500 μm and a difference between a D10 value and a D90 value of 30 μm to 250 μm.

Clause 30. The composition of any of Clauses 26 to 29, wherein the core portion of the core-and-shell structure comprises pyrolysis coke, or wherein the core portion of the core-and-shell structure comprises a carbonaceous material different from pyrolysis coke.

Clause 31. The composition of any of Clauses 26 to 30, wherein the core portion of the core-and-shell structure comprises activated carbon.

Clause 32. The composition of any of Clauses 26 to 31, wherein an average thickness of the shell portion of the core-and-shell structure is less than an average diameter of the core portion of the core-and-shell structure for the plurality of particles.

Clause 33. The composition of any of Clauses 26 to 31, wherein an average thickness of the shell portion of the core-and-shell structure is less than half of an average diameter of the core portion of the core-and-shell structure for the plurality of particles.

Clause 34. The composition of any of Clauses 26 to 33, wherein an average thickness of the shell portion of the core-and-shell structure for the plurality of particles is 50 μm or less, as measured by sampling of cross-sectioned particles using scanning electron microscopy.

Clause 35. The composition of any of Clauses 26 to 34, wherein the plurality of particles has combined weight of carbon and hydrogen of 85.0 wt % to 95.0 wt % as determined according to ASTM D5373-21.

Clause 36. The composition of any of Clauses 26 to 34, wherein the plurality of particles has a combined weight of carbon and hydrogen of 95.0 wt % or more as determined according to ASTM D5373-21, or wherein the plurality of particles has 95.0 wt % or more of carbon as determined according to ASTM D5373-21, or a combination thereof.

Clause 37. The composition of any of Clauses 26 to 36, wherein the core portion of the core-and-shell structure has an initial average apparent density of 1.0 g/cm³ to 2.26 g/cm³ as measured according to ASTM D2638-21, or wherein the core portion of the core-and-shell structure has an initial BET surface area of greater than 100 m²/g as measured according to ASTM D6556-21, or a combination thereof.

Clause 38. The composition of any of Clauses 26 to 37, wherein the core portion of the core-and-shell structure has an initial carbon content of 85 wt % or more as measured according to ASTM D5373-21 and an initial sulfur content of 1.0 wt % to 10 wt % as measured according to ASTM D1552-23.

Clause 39. The composition of any of Clauses 26 to 38, wherein the plurality of particles has 1.0 wt % or less of sulfur as measured according to ASTM D1552-23, 0.6 wt % or less of nitrogen as measured according to ASTM D5373-21, and 4000 wppm or less of combined iron, nickel, and vanadium as measured according to ASTM D5600-22.

Clause 40. The composition of any of Clauses 26 to 39, wherein the plurality of particles comprise 0.1 wt % or more of sulfur as measured according to ASTM D1552-23.

Clause 41. The composition of any of Clauses 26 to 40, wherein the plurality of particles has an average apparent density of 1.0 g/cm³ to 1.7 g/cm³, as measured according to ASTM D2638-21.

Clause 42. The composition of any of Clauses 26 to 41, wherein the plurality of particles have an average BET surface area of 0.01 m²/g to 10.0 m²/g as measured according to ASTM D6556-21.

Clause 43. The composition of any of Clauses 26 to 42, wherein the plurality of particles has a L_{c} value of 1.0 nm to 10 nm, or wherein the plurality of particles has a d₀₀₂ value of 0.335 nm to 0.385 nm, or a combination thereof.

Clause 44. The composition of any of Clauses 26 to 43, wherein the plurality of particles comprise a D10 value of 20 μm to 100 μm, a D50 value of 40 μm to 200 μm, and a D90 value of 150 μm to 350 μm, and an average apparent density of 1.0 g/cm³ to 1.9 g/cm³ as measured according to ASTM D2638-21; or wherein the plurality of particles comprise a D10 value of 70 μm to 250 μm, a D50 value of 100 μm to 400 μm, and a D90 value of 250 μm to 500 μm, and an average apparent density of 1.0 g/cm³ to 1.9 g/cm³ as measured according to ASTM D2638-21; or wherein the plurality of particles comprise a D10 value of 100 μm to 350 μm, a D50 value of 150 μm to 500 μm, and a D90 value of 350 μm to 700 μm, and an average apparent density of 1.0 g/cm³ to 1.9 g/cm³ as measured according to ASTM D2638-21.

Clause 45. The composition of any of the above Clauses, wherein the product portion of particles has an average crush strength of 20 MPa-a to 200 MPa-a, as determined according to API RP-19C.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A composition comprising:
a plurality of particles comprising pyrolysis coke, the plurality of particles having a BET surface area of 0.01 m²/g to 10.0 m²/g as measured according to ASTM D6556-21, a carbon content of 90.0 wt % or more as measured according to ASTM D5373-21, a sulfur content of 1.0 wt % or less as measured according to ASTM D1552-23, and an average apparent density of 1.85 g/cm³ to 2.26 g/cm³, as measured according to ASTM D2638-21.

2. The composition of claim 1, wherein the plurality of particles has an average apparent density of 1.92 g/cm³ to 2.26 g/cm³ as measured according to ASTM D2638-21.

3. The composition of claim 1, wherein the plurality of particles has a L_{c} value of 1.0 nm to 10 nm, or wherein the plurality of particles has a d₀₀₂ value of 0.335 nm to 0.385 nm, or a combination thereof.

4. The composition of claim 1, wherein the plurality of particles has a BET surface area of 0.01 m²/g to 2.0 m²/g as measured according to ASTM D6556-21.

5. The composition of claim 1, wherein the plurality of particles have a BET surface area of 0.01 m²/g to 1.0 m²/g as measured according to ASTM D6556-21, and an average apparent density of 1.95 g/cm³ to 2.26 g/cm³ as measured according to ASTM D2638-21.

6. The composition of claim 1, wherein the plurality of particles has a BET surface area of 0.01 m²/g to 2.0 m²/g as measured according to ASTM D6556-21, a carbon content of 95.0 wt % or more as measured according to ASTM D5373-21, a sulfur content of 0.2 wt % or less as measured according to ASTM D1552-23, and an average apparent density of 1.92 g/cm³ to 2.26 g/cm³, as measured according to ASTM D2638-21.

7. The composition of claim 1, wherein the plurality of particles has 1.0 wt % or less of sulfur as measured according to ASTM D1552-23, 0.6 wt % or less of nitrogen as measured according to ASTM D5373-21, and 4000 wppm or less of combined iron, nickel, and vanadium as measured according to ASTM D5600-22.

8. The composition of claim 1, wherein the plurality of particles has 300 wppm or less of sulfur as measured according to ASTM D1552-23.

9. The composition of claim 1, wherein the plurality of particles has 1000 wppm or less of iron as measured according to ASTM D5600-22, or wherein the plurality of particles comprise 1000 wppm or less of nickel as measured according to ASTM D5600-22, or wherein the plurality of particles comprise 1000 wppm or less of vanadium as measured according to ASTM D5600-22, or a combination thereof.

10. The composition of claim 1, wherein the plurality of particles has 1000 wppm or less of combined iron, nickel, and vanadium as measured according to ASTM D5600-22.

11. The composition of claim 1, wherein the plurality of particles has a combined weight of carbon and hydrogen of 95.0 wt % or more as measured according to ASTM D5373-21.

12. The composition of claim 1, wherein the plurality of particles comprise a difference between a D10 value and a D90 value of 40 μm to 200 μm.

13. The composition of claim 12, wherein a) the plurality of particles comprise a difference between a D10 value and a D90 value of 40 μm to 100 μm, or b) the plurality of particles comprise a difference between a D10 value and a D90 value of 100 μm to 200 μm, or c) the plurality of particles comprise a difference between a D10 value and a D90 value of 70 μm to 140 μm.

14. The composition of claim 1, wherein the plurality of particles comprise a difference between a D10 value and the D50 value of 10 μm to 120 μm.

15. The composition of claim 1, wherein the plurality of particles has a D10 value of 40 μm or higher.

16. The composition of claim 1, wherein the plurality of particles comprises less than 5 wt % of particles having a particle size of less than 50 μm.

17. The composition of claim 1, wherein the plurality of particles has a D90 value of 500 μm or less.

18. The composition of claim 1, wherein the plurality of particles comprise a difference between a D50 value and a D90 value of 40 μm to 200 μm.

19. The composition of claim 1, wherein the plurality of particles comprise a difference between a D50 value and a D90 value of 40 μm to 100 μm, or wherein the plurality of particles comprise a difference between a D50 value and a D90 value of 60 μm to 160 μm.

20. The composition of claim 1, wherein the plurality of particles has a D50 value of 100 μm to 500 μm.

21. The composition of claim 1, wherein the plurality of particles has a D50 value of 40 μm to 400 μm, or wherein the plurality of particles has a D50 value of 150 μm to 400 μm, or wherein the plurality of particles has a D50 value of 100 μm to 300 μm.

22. The composition of claim 1, wherein the plurality of particles has a D10 value of 20 μm to 350 μm, a D50 value of 40 μm to 500 μm, and a D90 value of 150 μm to 700 μm.

23. The composition of claim 22,
wherein the plurality of particles has a D10 value of 20 μm to 100 μm, a D50 value of 40 μm to 200 μm, and a D90 value of 150 μm to 350 μm, or
wherein the plurality of particles has a D10 value of 70 μm to 250 μm, a D50 value of 100 μm to 400 μm, and a D90 value of 250 μm to 500 μm, or
wherein the plurality of particles has a D10 value of 100 μm to 350 μm, a D50 value of 150 μm to 500 μm, and a D90 value of 350 μm to 700 μm.

24. The composition of claim 22,
wherein the plurality of particles has a D10 value of 20 μm to 100 μm, a D50 value of 40 μm to 200 μm, and a D90 value of 150 μm to 350 μm, and an average apparent density of 1.92 g/cm³ to 2.26 g/cm³, or
wherein the plurality of particles has a D10 value of 70 μm to 250 μm, a D50 value of 100 μm to 400 μm, and a D90 value of 250 μm to 500 μm, and an average apparent density of 1.92 g/cm³ to 2.26 g/cm³, or
wherein the plurality of particles has a D10 value of 100 μm to 350 μm, a D50 value of 150 μm to 500 μm, and a D90 value of 350 μm to 700 μm, and an average apparent density of 1.92 g/cm³ to 2.26 g/cm³.

25. The composition of claim 1, wherein the plurality of particles comprise an ash content of 1.0 wt % or less, a moisture content of 0.5 wt % or less, or a combination thereof.

26. The composition of claim 1, wherein the product portion of particles has an average crush strength of 20 MPa-a to 200 MPa-a, as determined according to API RP-19C.

27. A composition comprising:
a plurality of particles, 90 wt % or more of the plurality of particles having a core-and-shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 1.9 g/cm³ as measured according to ASTM D2638-21, the average apparent density being lower than an average apparent density of the core portion of the core-and-shell structure.

28. The composition of claim 27, wherein an average thickness of the shell portion of the core-and-shell structure is less than an average diameter of the core portion of the core-and-shell structure.

29. The composition of claim 27, wherein an average thickness of the shell portion of the core-and-shell structure is less than half of an average diameter of the core portion of the core-and-shell structure.

30. The composition of claim 27, wherein an average thickness of the shell portion of the core-and-shell structure for the plurality of particles is 50 μm or less, as measured by sampling of particles using scanning electron microscopy.

31. The composition of claim 27, wherein the core portion of the core-and-shell structure comprises activated carbon.

32. The composition of claim 27, wherein the core portion of the core-and-shell structure has an initial average apparent density of 1.0 g/cm³ to 1.7 g/cm³ as measured according to ASTM D2638-21.

33. A composition comprising:
a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having a BET surface area of 0.01 m²/g to 10.0 m²/g as measured according to ASTM D6556-21, the plurality of particles having an average apparent density of 1.0 g/cm³ to 2.26 g/cm³ as measured according to ASTM D2638-21.

34. The composition of claim 33, wherein the plurality of particles has combined weight of carbon and hydrogen of 85.0 wt % to 95.0 wt % relative to a weight of the plurality of particles as determined according to ASTM D5373-21.

35. The composition of claim 33, wherein the plurality of particles has a combined weight of carbon and hydrogen of 95.0 wt % or more as determined according to ASTM D5373-21, or wherein the plurality of particles has 95.0 wt % or more of carbon as determined according to ASTM D5373-21, or a combination thereof.

36. The composition of claim 33, wherein the core portion of the core-and-shell structure has an initial average apparent density of 1.0 g/cm³ to 2.26 g/cm³ as measured according to ASTM D2638-21.

37. The composition of claim 33, wherein the core portion of the core-and-shell structure has an initial BET surface area of greater than 100 m²/g as measured according to ASTM D6556-21.

38. The composition of claim 33, wherein the core portion of the core-and-shell structure has an initial carbon content of 85 wt % or more as measured according to ASTM D5373-21 and an initial sulfur content of 1.0 wt % to 10 wt % as measured according to ASTM D1552-23.

39. The composition of claim 33, wherein the plurality of particles has 1.0 wt % or less of sulfur as measured according to ASTM D1552-23, 0.6 wt % or less of nitrogen as measured according to ASTM D5373-21, and 4000 wppm or less of combined iron, nickel, and vanadium as measured according to ASTM D5600-22.

40. The composition of claim 33, wherein the plurality of particles has 0.2 wt % or less of sulfur as measured according to ASTM D1552-23, 0.1 wt % or less of nitrogen as measured according to ASTM D5373-21, and 2000 wppm or less of combined iron, nickel, and vanadium as measured according to ASTM D5600-22.

41. The composition of claim 33, wherein the shell portion of the core and shell structure comprises 0.2 wt % or less of sulfur as measured according to ASTM D1552-23; or wherein the shell portion of the core and shell structure comprises 2000 wppm or less of combined iron, nickel, and vanadium as measured according to ASTM D5600-22; or a combination thereof.

42. The composition of claim 33, wherein the plurality of particles comprise 0.1 wt % or more of sulfur as measured according to ASTM D1552-23.

43. The composition of claim 33, wherein the plurality of particles has an average apparent density of 1.0 g/cm³ to 1.7 g/cm³ as measured according to ASTM D2638-21.

44. The composition of claim 33, wherein the plurality of particles has an average apparent density of 1.4 g/cm³ to 1.9 g/cm³ as measured according to ASTM D2638-21.

45. The composition of claim 33, wherein the plurality of particles have an average BET surface area of 0.01 m²/g to 2.0 m²/g as measured according to ASTM D6556-21.

46. The composition of claim 33, wherein the plurality of particles have a L_{c} value of 1.0 nm to 10 nm, or wherein the plurality of particles has a d₀₀₂ value of 0.335 nm to 0.385 nm, or a combination thereof.

47. The composition of claim 33, wherein the plurality of particles comprise a D10 value of 20 μm to 100 μm, a D50 value of 40 μm to 200 μm, and a D90 value of 150 μm to 350 μm, and an average apparent density of 1.0 g/cm³ to 1.9 g/cm³ as measured according to ASTM D2638-21.

48. The composition of claim 33, wherein the plurality of particles comprise a D10 value of 70 μm to 250 μm, a D50 value of 100 μm to 400 μm, and a D90 value of 250 μm to 500 μm, and an average apparent density of 1.0 g/cm³ to 1.9 g/cm³ as measured according to ASTM D2638-21.

49. The composition of claim 33, wherein the plurality of particles comprise a D10 value of 100 μm to 350 μm, a D50 value of 150 μm to 500 μm, and a D90 value of 350 μm to 700 μm, and an average apparent density of 1.0 g/cm³ to 1.9 g/cm³ as measured according to ASTM D2638-21.

50. The composition of claim 33, wherein the plurality of particles has an ash content of 1.0 wt % or less, a moisture content of 0.5 wt % or less, or a combination thereof.

51. The composition of claim 33, wherein an average thickness of the shell portion of the core-and-shell structure is less than an average diameter of the core portion of the core-and-shell structure.

52. The composition of claim 33, wherein an average thickness of the shell portion of the core-and-shell structure for the plurality of particles is 50 μm or less, as measured by sampling of particles using scanning electron microscopy.

53. The composition of claim 33, wherein the core portion of the core-and-shell structure comprises activated carbon.

54. The composition of claim 33, wherein the product portion of particles has an average crush strength of 20 MPa-a to 200 MPa-a, as determined according to API RP-19C.

55. A composition comprising:
a plurality of particles comprising pyrolysis coke, the plurality of particles having an average apparent density of 1.0 g/cm³ to 2.26 g/cm³, as measured according to ASTM D2638-21, the plurality of particles having a D50 value between 40 μm and 500 μm and a difference between a D10 value and a D90 value of 30 μm to 250 μm, as measured according to ASTM D4464-15(2020).

56. The composition of claim 55, wherein the plurality of particles has a L_{c} value of 1.0 nm to 10 nm, or wherein the plurality of particles has a d₀₀₂ value of 0.335 nm to 0.385 nm, or a combination thereof.

57. The composition of claim 55, wherein the plurality of particles has a BET surface area of 1.0 m²/g to 2.0 m²/g as measured according to ASTM D6556-21.

58. The composition of claim 55, wherein the plurality of particles have a BET surface area of 0.01 m²/g to 1.0 m²/g as measured according to ASTM D6556-21, and an average apparent density of 1.95 g/cm³ to 2.26 g/cm³ as measured according to ASTM D2638-21.

59. The composition of claim 55, wherein the plurality of particles has a BET surface area of 0.01 m²/g to 2.0 m²/g as measured according to ASTM D6556-21, a carbon content of 95.0 wt % or more as measured according to ASTM D5373-21, a sulfur content of 0.2 wt % or less as measured according to ASTM D1552-23, and an average apparent density of 1.92 g/cm³ to 2.26 g/cm³, as measured according to ASTM D2638-21.

60. The composition of claim 55, wherein the plurality of particles has 1.0 wt % or less of sulfur as measured according to ASTM D1552-23, 0.6 wt % or less of nitrogen as measured according to ASTM D5373-21, and 4000 wppm or less of combined iron, nickel, and vanadium as measured according to ASTM D5600-22.

61. The composition of claim 55, wherein the plurality of particles has 300 wppm or less of sulfur as measured according to ASTM D1552-23.

62. The composition of claim 55, wherein the plurality of particles has 300 wppm or less of iron as measured according to ASTM D5600-22, or wherein the plurality of particles comprise 300 wppm or less of nickel as measured according to ASTM D5600-22, or wherein the plurality of particles comprise 300 wppm or less of vanadium as measured according to ASTM D5600-22, or a combination thereof.

63. The composition of claim 55, wherein the plurality of particles has 300 wppm or less of combined iron, nickel, and vanadium as measured according to ASTM D5600-22.

64. The composition of claim 55, wherein the plurality of particles has a combined weight of carbon and hydrogen of 97.0 wt % or more, as measured according to ASTM D5373-21.

65. The composition of claim 55, wherein the plurality of particles comprise a difference between a D10 value and a D90 value of 40 μm to 200 μm.

66. The composition of claim 55, wherein the plurality of particles comprise a difference between a D10 value and the D50 value of 10 μm to 120 μm.

67. The composition of claim 55, wherein the plurality of particles comprises less than 5 wt % of particles having a particle size of less than 50 μm.

68. The composition of claim 55, wherein the plurality of particles has a D90 value of 500 μm or less.

69. The composition of claim 55, wherein the plurality of particles comprise a difference between a D50 value and a D90 value of 40 μm to 200 μm.

70. The composition of claim 55, wherein the plurality of particles has a D10 value of 20 μm to 100 μm, a D50 value of 40 μm to 200 μm, and a D90 value of 150 μm to 350 μm, and an average apparent density of 1.92 g/cm³ to 2.26 g/cm³.

71. The composition of claim 55, wherein the plurality of particles has a D10 value of 70 μm to 250 μm, a D50 value of 100 μm to 400 μm, and a D90 value of 250 μm to 500 μm, and an average apparent density of 1.92 g/cm³ to 2.26 g/cm³.

72. The composition of claim 55, wherein the plurality of particles has a D10 value of 100 μm to 350 μm, a D50 value of 150 μm to 500 μm, and a D90 value of 350 μm to 700 μm, and an average apparent density of 1.92 g/cm³ to 2.2 g/cm³.

73. A composition comprising:
a plurality of particles, 90 wt % or more of the plurality of particles having a core and shell structure comprising a shell portion and a core portion, the shell portion of the core-and-shell structure comprising pyrolysis coke, the core portion of the core-and-shell structure comprising a carbonaceous material different from pyrolysis coke, the plurality of particles having an average apparent density of 1.0 g/cm³ to 2.26 g/cm³ as measured according to ASTM D2638-21, the plurality of particles having a D50 value between 40 μm and 500 μm and at least one of a) a difference between a D10 value and a D90 value of 40 μm to 250 μm and b) a difference between a D10 value and the D50 value of 50 μm or less.

74. A composition comprising:
a plurality of particles, 90 wt % or more of the plurality of particles having a core and shell structure comprising a shell portion and a core portion, the shell portion of the core-and-shell structure comprising pyrolysis coke, the plurality of particles having an average apparent density of 1.0 g/cm³ to 2.26 g/cm³ as measured according to ASTM D2638-21, the plurality of particles having a D50 value between 40 μm and 500 μm and a difference between a D10 value and a D90 value of 30 μm to 250 μm.

75. The composition of claim 74, wherein the core portion of the core-and-shell structure comprises pyrolysis coke.

76. The composition of claim 74, wherein the core portion of the core-and-shell structure comprises a carbonaceous material different from pyrolysis coke.
